(19) United States
(12) Patent Application Publication
(10) Pub. No.: US 2005/0214701 A1
(43) Pub. Date: Sep. 29, 2005

(54) Manufacturing method of photothermographic material and photothermographic material

(75) Inventor: Takayoshi Oyamada, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/085,008

(22) Filed: Mar. 21, 2005

(30) Foreign Application Priority Data
Mar. 25, 2004 (JP) 2004-90593

(51) Int. Cl. G03C 1/00

(52) U.S. Cl. 430/619; 430/348

(57) ABSTRACT

A method of manufacturing a photothermographic material that has at least on one surface of a support an image-forming layer that includes at least photosensitive silver halide, non-photosensitive organic silver salt, a reducing agent and a binder, wherein 1) the non-photosensitive organic silver salt is dispersed with at least one dispersing agent selected from polyvinyl alcohol having an average polymerization degree of 1,500 or less; a surfactant; and gelatin; and 2) the pH of a coating solution of the image-forming layer is 4 or more and 8.2 or less; and a photothermographic material manufactured according to the manufacturing method thereof.

### CROSS-REFERENCE TO RELATED APPLICATION

This application claims priority under 35 USC 119 from Japanese Patent Application No. 2004-090593, the disclosure of which is incorporated by reference therein.

### BACKGROUND OF THE INVENTION

1. Field of the Invention

The present invention relates to manufacturing methods of photothermographic materials and photothermographic materials. In particular, the invention, in manufacturing methods of photothermographic materials for use in aqueous coating systems, relates to manufacturing methods of photothermographic materials excellent in the coating property, improved in haze and high in the image quality, and to photothermographic materials.

2. Description of the Related Art

In recent years, it has been strongly desired in the field of films for medical imaging to reduce the amount of used processing liquid waste in consideration of environmental protection and space saving. For this reason, technology regarding photothermographic materials as films for medical imaging and for photographic applications, which are capable of efficient exposure with a laser image setter or a laser imager and capable of forming a clear black-toned image with high resolution and high sharpness is desired. Such photothermographic materials can eliminate use of liquid processing chemicals and can provide users with a thermal development system which is simpler and does not contaminate the environment.

Although similar requirements also exist in the field of general image forming materials, an image for medical imaging requires a particularly high image quality excellent in sharpness and granularity because a delicate image representation is necessitated. Also an image of blue-black tone is preferred in consideration of easy diagnosis. Currently various hard copy systems utilizing pigments or dyes, such as ink jet printers and electrophotographic systems, are available as general image forming systems, but they are not satisfactory as output systems for medical images.

Thermal image forming systems that make use of an organic silver salt are described, for example, in U.S. Pat. Nos. 3,152,904 and 3,457,075 and in “Thermally Processed Silver systems” written by B. Shely (in “Imaging Processes and Materials”, Neblette, 8th edition, edited by J. Sturge, V. Warlworth, and A. Shepp, page 279, 1989). In particular, a photothermographic material generally includes a photosensitive layer in which a catalytically active amount of photocatalyst (such as silver halide), a reducing agent, a reducible silver salt (such as organic silver salt) and, if necessary, a color toner for controlling the tone of a developed silver image are dispersed in a matrix of a binder. The photothermographic material, when heated at a high temperature (for example, 80 degrees centigrade or more) after image exposure, undergoes an oxidation/reduction reaction between silver halide or the reducible silver salt (functioning as an oxidizer) and the reducing agent to form a black-toned silver image. The oxidation/reduction reaction is promoted by a catalytic effect of a latent image of silver halide formed by exposure. Accordingly, the black-toned silver image is formed in an exposed area. The technology is disclosed in U.S. Pat. No. 2,910,377 and JP-B No. 43-4924, and Fuji Medical Dry Laser Imager FM-DPL has been marketed as a medical image forming system using a photothermographic material.

As methods of manufacturing photothermographic materials that use organic silver salts, there are a method of manufacturing using solvent coating and a method using an aqueous dispersion of polymer fine particles as a primary binder or an aqueous solution of water-soluble polymer are known. The latter method, making steps of recovering the solvent unnecessary, is simple in manufacturing equipment, small in the environmental load and advantageous in mass production.

However, in manufacturing methods of photothermographic materials for an aqueous coating system, since an image-forming layer coating solution in particular contains many components necessary for image formation, there is a large problem in uniformly coating and drying. Particularly when, in order to improve the productivity, the coating is carried out at high speeds and rapid drying is applied to manufacture the photothermographic materials, there are problems in that components partially deviate in a coated layer to increase the haze or the fluctuation of drying air generates irregularities on a surface of the coated layer.

Such haze and irregularities on a surface of the coated layer, when an image is formed thereon, generate image irregularities. Accordingly, as medical image formation materials in particular, these are serious problems that can adversely affect the diagnostic capability; accordingly, there is a strong demand for improvement.

As one improvement attempt, it is known that with a setting polymer like gelatin as a non-photosensitive binder of a top layer of an image-forming layer, the non-photosensitive layer is simultaneously coated with an image-forming layer in a multi-layer (JP-A No. 10-186571). Furthermore, it is also known that in a configuration in which between an image-forming layer and a protective layer, an intermediate layer containing a water-soluble polymer and a polymer latex is disposed, simultaneous multi-layer coating is applied (JP-A No. 11-288058). However, as mentioned above, an image-forming layer, namely, an image-forming layer coating solution contains many components necessary for image formation; accordingly, whatever devices are applied to layers other than the image-forming layer, there is a limit as means for improving the uniformity in the coating and drying; as a result, this is not yet sufficient. For instance, a method in which in a layer like a protective layer is formed, chemicals such as an acid and a cross-linking agent are added. (JP-A No. 2002-162712).

There is also known a method in which without using a setting polymer and so on, high temperature drying is used to coat; however, the method does not generate a material with sufficient quality to use as a medical image formation material (JP-A No. 2000-19678).

Thus there is a need in the art for a method of manufacturing a photothermographic material having an excellent coating property with less haze and a photothermographic material according thereto.

### SUMMARY OF THE INVENTION

A first aspect of the present invention is to provide a method of manufacturing a photothermographic material that has on at least one surface of a support an image-forming layer that includes at least a photosensitive silver halide, a non-photosensitive organic silver salt, a reducing agent and a binder, wherein: the non-photosensitive organic silver salt is dispersed with at least one dispersing agent selected from polyvinyl alcohol having an average polymerization degree of 1,500 or less, a surfactant, and gelatin; and the pH of a coating solution of the image-forming layer is 4 or more and 8.2 or less.

A second aspect of the invention is to provide a photothermographic material manufactured according to a manufacturing method of a photothermographic material, that has on at least one surface of a support an image-forming layer that includes at least a photosensitive silver halide, a non-photosensitive organic silver salt, a reducing agent and a binder, wherein: the non-photosensitive organic silver salt is dispersed with at least one dispersing agent selected from polyvinyl alcohol having an average polymerization degree of 1500 or less, a surfactant, and gelatin, and the pH of a coating solution of the image-forming layer is 4 or more and 8.2 or less.

### BRIEF DESCRIPTION OF THE DRAWINGS

FIG. 1 is a diagram for explaining a high-pressure crushing portion of a disperser that has a high-pressure crushing portion that is used in the present invention.

FIG. 2 is a diagram showing one example where by switching a switching valve, preliminary dispersion and dispersion are carried out in a single disperser.

FIG. 3 is a diagram showing one example where preliminary dispersion and dispersion, respectively, are carried out in separately disposed dispersers.

### DETAILED DESCRIPTION OF THE INVENTION

It was found that in a method of manufacturing an aqueous coating system photothermographic material, a slight fluctuation in the physical properties of a coating solution largely affects the coating properties. In the present application, it was for the first time found that a dispersing agent that is used when a non-photosensitive organic silver salt of a coating solution of an image-forming layer is prepared not only affects the dispersion of the organic silver salt but also greatly affects the coating properties of the image-forming layer to which the dispersing agent is added. In addition, it was also found that when at least one dispersing agent selected from polyvinyl alcohol having an average polymerization degree of 1,500 or less, a surfactant, and gelatin is used to disperse and an image-forming layer coating solution is adjusted to a pH of 4 or more and 8.2 or less, an improvement beyond expectation can be obtained. Thereby, the invention was achieved. In the past, an aqueous image formation layer coating solution was, from a viewpoint of the coating solution stability, used to coat at a rather high alkalinity. By use of an organic silver salt dispersion according to the present application, in a pH region such as 4 or more and 8.2 or less that is lower from a conventionally accepted notion, a stable coating solution could be prepared, and improved coating properties could be obtained. Furthermore, the invention of photothermographic materials due to these manufacturing methods is also achieved.

1. Photothermographic Material and Manufacturing Method thereof

A photothermographic material has at least on one surface of a support an image-forming layer that includes photosensitive silver halide, non-photosensitive organic silver salt, a reducing agent and a binder. A photothermographic material according to the invention preferably has also a surface protective layer on an image-forming layer or may have, on an opposite layer thereto, a back layer or a back protective layer. A photothermographic material according to the invention may be a double-sided photothermographic material having an image-forming layer on each of both surfaces of a substrate or may be a single-sided photothermographic material having an image-forming layer only on one surface.

Configurations of the respective layers and preferable components thereof will be detailed.

(Organic Silver Salt)

1) Composition

An organic silver salt that can be used in the invention is a silver salt that is relatively stable to light but, in the presence of exposed photosensitive silver halide and a reducing agent, when heated at 105 degrees centigrade or more, functions as a silver ion supplier and thereby forms a silver image.

A non-photosensitive organic silver salt in the invention preferably has a content of silver behenate in the range of 85 mole percent or more and 99 mole percent or less. Preferably, the content of silver behenate is 90 mole percent or more and 99 mol percent or less, and more preferably 93 mol percent or more and 99 mol percent or less. The rest of the organic silver salt is, though not particularly restricted, preferable to be an aliphatic silver salt. Preferable examples thereof include silver lignocerate, silver behenate, silver arachidate, silver stearate, silver oleate, silver laurate, silver caprate, silver myristate, silver palmitate, silver erucate and mixtures thereof.

2) Shape

A shape of organic silver salt that can be used in the invention, without restricting to particular one, may be any one of needle-shaped one, bar-shaped one, tabular-shaped one and flake-shaped one.

The organic silver salt in the invention is preferably a needle crystal.

A grain of needle organic silver salt in the invention can be characterized by approximating to a rectangle. When in an approximated rectangle, side lengths are taken a, b and c from the shortest side and a≦b<c, a value of b/c is preferably 10 or more and 500 or less, and more preferably 10 or more and 200 or less.

As the particle size distribution of the organic silver salt, mono-dispersion is preferred. In the mono-dispersion, the percentage for the value obtained by dividing the standard deviation for the length of minor axis and major axis by the minor axis and the major axis respectively is, preferably, 100% or less, more preferably, 80% or less and, further preferably, 50% or less. The shape of the organic silver salt can be measured by determining dispersion of an organic silver salt as transmission type electron microscopic images. Another method of measuring the mono-dispersion is a method of determining of the standard deviation of the volume weighted mean diameter of the organic silver salt in which the percentage for the value defined by the volume weight mean diameter (variation coefficient), is preferably, 100% or less, more preferably, 80% or less and, further preferably, 50% or less. The mono-dispersion can be determined from particle size (volume weighted mean diameter) obtained, for example, by a measuring method of irradiating a laser beam to an organic silver salt dispersed in a liquid, and determining a self correlation function of the scattering of scattered light to the change of time.

3) Preparation

An exemplary method of preparing organic silver salt according to the invention is detailed in the steps below.

a. Generation of organic silver salt due to a reaction between organic acid or alkali metal salt thereof and water-soluble silver salt

b. Removal of a byproduct salt by means of filtration

c. Drying, and

d. Dispersion (organic silver salt is dispersed in desired particulates with water as a dispersing medium).

A drying step in c is not indispensable, and, in a wet cake state that contains moisture to some extent, the dispersion step d can be followed.

4) Addition Amount

The organic silver salt according to the invention can be used at a desired amount; however, a total amount of coated silver including silver halide as well is preferably 0.5 g/m² or more and 1.6 g/m² or less, more preferably 0.6 g/m² or more and 1.4 g/m² or less, and more preferably 1.0 g/m² or more and 1.4 g/m² or less.

(Dispersing Agent)

In one embodiment according to the invention, organic silver salt is dispersed in polyvinyl alcohol having an average polymerization degree of 1,500 or less. In the invention, a molecular weight means a mass average molecular weight.

Polyvinyl alcohol as the dispersing agent preferably has an average polymerization degree of 1000 or less, more preferably 700 or less, and a saponification degree thereof is preferably in the range of 80 to 92 percent.

The polyvinyl alcohols that satisfy the above conditions are available from Kuraray Co., Ltd., DENKI KAGAKU KOGYO KK, and The Nippon Synthetic Chemical Industry Co., Ltd. In accordance with the object, polyvinyl alcohols different in the polymerization degree and the saponification degree can be used.

<Exemplification of Specific Examples>

PVA-203 (trade name, manufactured by Kuraray Co., Ltd.) (polymerization degree 300 and saponification degree 88 percent)

PVA-204 (trade name, manufactured by Kuraray Co., Ltd.) (polymerization degree 400 and saponification degree 88 percent)

PVA-205 (trade name, manufactured by Kuraray Co., Ltd.) (polymerization degree 500 and saponification degree 88 percent)

PVA-210 (trade name, manufactured by Kuraray Co., Ltd.) (polymerization degree 1,000 and saponification degree 88 percent), and

MP-203 (trade name, manufactured by Kuraray Co., Ltd.) (polymerization degree 300 and saponification degree 88 percent)

In another embodiment according to the invention, organic silver salt is dispersed by use of a surfactant.

As the surfactant, a nonionic surfactant, an anionic surfactant, a cationic surfactant or an amphoteric surfactant can be used.

<Nonionic Surfactant>

As the nonionic surfactant, any one of ester type, ether type, ether-ester type, alkyl alkanolamide, and amine alkylene oxide may be used.

<Exemplification of Specific Examples>

Glyceryl stearate

Polyoxyethylene alkylether

Glyceryl isostearate, and

Diethanolamide laurate

<Anionic Surfactant>

As the anionic surfactant, any one of carboxylate, sulfonate, sulfuric acid ester salt, phosphoric acid ester salt, acyl-N-methyl taurate and sulfated oil may be used.

<Exemplification of Specific Examples>

Rosin soap

Dialkyl sulfosuccinate

Polyoxyethylene alkyl ether sulfuric acid ester salt, and

Lecithin

<Cation Surfactant>

As the cationic surfactant, any one of salts of quaternary-ammonium salt type, acetate, amine salts and other salts and guanidine group-containing compounds may be used.

<Exemplification of Specific Examples>

Monoalkyl ammonium chloride

Alkylamine acetate, and

Tallow diamine dioleate

<Amphoteric Surfactant>

As the amphoteric surfactant, any one of alkyldimethyl aminoacetic acid betaine, alkyldimethyl amine oxide, alkylcarboxymethylhydroxyethyl imidazolinium betaine, alkylamidopropyl betaine, alkylhydroxysulfobetaine and alanine system may be used.

<Exemplification of Specific Examples>

Lauryldimethyl aminoacetic acid betaine

Lauryl dimethylamine oxide

2-alkyl-N-carboxymethyl-N-hydroxyethyl imidazolinium betaine

Lauryl amidopropyl betaine, and

Lauryl hydroxysulfobetaine

In still another embodiment according to the invention, organic silver salt is dispersed by use of gelatin.

As the gelatin, any one of alkali-processed gelatin and acid-processed gelatin can be used.

The acid-processed gelatin can be more preferably used.

Among the dispersing agents according to the above various embodiments, more preferable ones are polyvinyl alcohol having the polymerization degree of 1,500 or less and anionic surfactants, and particularly preferable one is polyvinyl alcohol having the polymerization degree of 1,500 or less.

(Dispersion Method)

As a method of manufacturing a solid dispersion of organic silver salt, various dispersion methods so far industrially generally known can be applied.

As so far generally known media dispersion methods, a method in which powder of organic silver salt or a wet cake wetted with water or an organic solvent is rendered aqueous slurry, and the aqueous slurry is, by use of a known pulverizer, in the presence of dispersion media, owing to mechanical force, pulverized to disperse can be cited. The pulverizer that is used for media dispersion includes a ball mill, a colloid mill, a vibrating ball mill, a vertical sand mill, a roller mill, a pin mill, a coball mill, a caddy mill, a horizontal sand mill and an attriter. Furthermore, as the dispersion media, steel balls, ceramic balls, glass beads, alumina beads, zirconia silicate beads, zirconia beads, Ottawa sand and so on can be cited. An average diameter of the dispersion media (beads) is preferably in the range of 0.3 to 5 mm, more preferably in the range of 0.3 to 3 mm, still more preferably in the range of 0.3 to 1 mm, and most preferably in the range of 0.3 or 0.5 mm.

It is preferable to use a high-pressure homogenizer for preparing the dispersion of the silver salt of the organic acid. The high-pressure homogenizer is an apparatus in which high-pressure, high-speed dispersion is executed in a high-pressure crushing part provided in a midway of a dispersion flow path, or an apparatus in which dispersing, emulsifying, and crushing are executed by passing the dispersion at high-speed with high-pressure through the narrowed part of the flow path of the dispersion.

For instance, Nanomizer LA (trade name, manufactured by Nanomizer Co., Ltd.) in which dispersion solutions collide each other in a dispersion passage thereof, Microfluidizer (trade name, manufactured by Microfluidex International Corp.) or Golline homogenizer (trade name, manufactured by APV) in which a high pressure pulverizing portion is disposed in a passage of a dispersion liquid, or Genus PY (trade name, manufactured by Genus Co., Ltd.) in which a narrow pipe-like passage called an orifice is disposed in a passage of a dispersion liquid can be used.

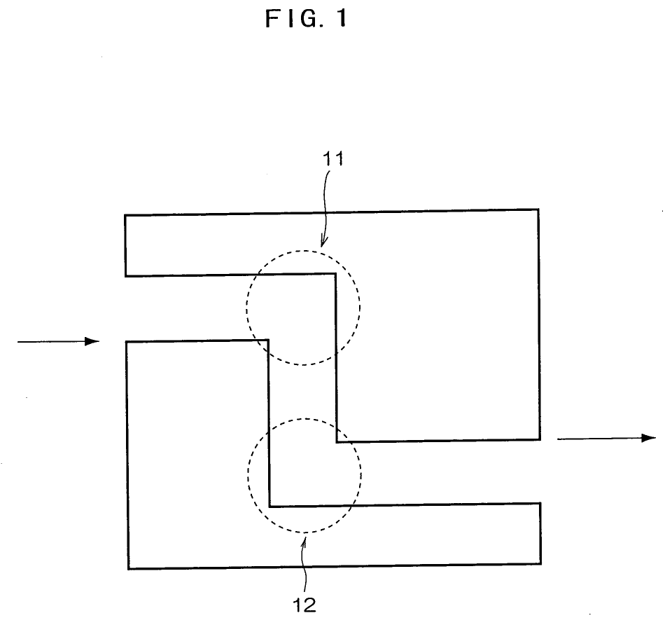

The high-pressure crushing part provided in the high-pressure homogenizer according to the invention denotes regions 11 and 12 shown in FIG. 1 in which a flow path of a raw material solution passing through the dispersion apparatus is bent at an approximately right angle to obtain an organic silver salt dispersion in which the organic silver salt is crushed and dispersed when a high speed flow of the raw material solution passes through the high-pressure crushing part.

In the invention, a substantial right angle means a case where, when a passage of a raw material solution proceeds toward a passage different in direction, an angle of a comer formed from the respective passages is in the range of 70 to 110 degrees.

As a narrow pipe-like passage (orifice) that is disposed to a high-pressure homogenizer that is used in the invention, in order to inhibit a dispersoid from causing clogging in the dispersion passage, in the preliminary dispersion, a passage diameter of 0.1 mm or more is preferably used, and more preferably a passage diameter of 0.2 mm or more is used. As a pressure applied on a dispersion solution, during the preliminary dispersion, 5 kgf/cm² or more is preferably applied, and 10 kgf/cm² or more is more preferably applied. Furthermore, during dispersion, a passage diameter of 0.5 mm or less is preferably used and that of 0.2 mm or less is more preferably used. Still furthermore, as a pressure applied to a dispersion solution, 100 kgf/cm² or more, and 280 kgf/cm² or more is more preferably applied.

In the invention, after a raw material solution including at least organic silver salt, a solvent and a dispersing agent is preliminarily dispersed at least once, dispersion is performed. In the preliminary dispersion, a passage diameter larger than a dispersion passage diameter that is used in the dispersion is used to disperse. Thereby, without causing blockage due to the clogging of the dispersoid in a dispersion passage during the dispersion, a dispersion of organic silver salt excellent in the dispersing properties can be obtained.

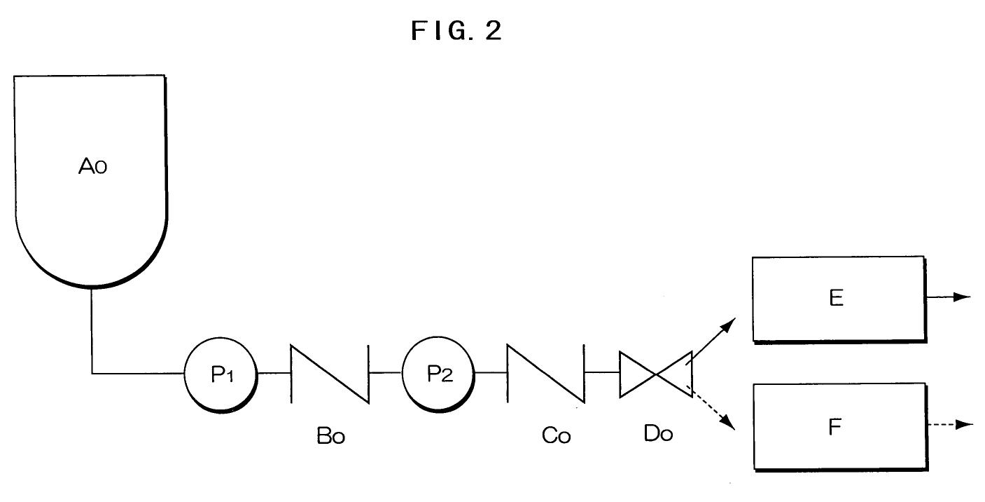

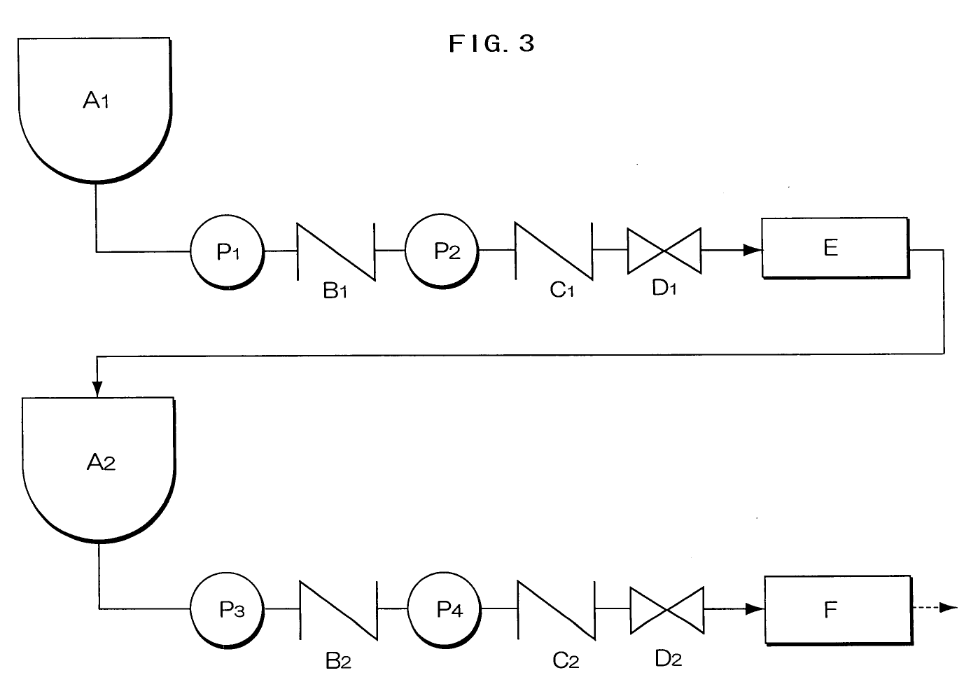

The preliminary dispersion and the main dispersion to be performed in the production method according to the invention are specifically performed by using apparatuses as shown in FIGS. 2 and 3.

In the apparatus shown in FIG. 2, the raw material solution is supplied from a supply pot A to an auxiliary pump P1 and, then, through a check valve B, a high-pressure pump P2 and a check valve C, introduced into an orifice E for the preliminary dispersion by a selector valve D, thereby performing the preliminary dispersion. After the preliminary dispersion, the thus-obtained preliminary dispersion is returned into the supply pot A and, then, after taking the same route, introduced into an orifice F for the main dispersion by a selector valve D, thereby performing the main dispersion.

In a device shown in FIG. 3, a raw material solution, after going from a supply pot A1 through an auxiliary pump P1, a check valve B, a high pressure pump P2, a check valve C, and a switching valve D, is introduced in a preliminary dispersion orifice to apply preliminary dispersion. An obtained preliminary dispersion liquid is supplied to a supply pot A2 separately disposed and therefrom introduced through an auxiliary pump P3, a check valve B1, a high pressure pump P4, a check valve C1, and a switching valve D1 to a dispersion orifice to disperse.

In a manufacturing method according to the invention, as needs arise temperature control may be applied to the dispersion liquid. A temperature of the raw material solution before the dispersion may be controlled in a tank where the raw material solution is stored or in the middle from the tank to a dispersing portion of a high-pressure homogenizer. In particular, when the dispersion solution is cooled to a dew point or less, since the tank cooling has a problem of dew condensation, the cooling is preferably applied in a closed passage from the tank to the dispersion actuating portion.

Furthermore, in the high pressure homogenizer that is used in the invention, as means for heightening pressure applied on the dispersion liquid, a method in which an exit of a single passage is blocked with a collision plate or a method in which the middle of the passage is formed into a slender pipe-like passage (orifice) may be used.

When a photosensitive silver salt is present together during dispersion of the organic silver salt, fog increases and sensitivity becomes remarkably lower, so that it is more preferred that the photosensitive silver salt is not substantially contained during dispersion. In the invention, the amount of the photosensitive silver salt to be disposed in the aqueous dispersion, is preferably, 1 mol % or less, more preferably, 0.1 mol % or less per one mol of the organic acid silver salt in the solution and, further preferably, positive addition of the photosensitive silver salt is not conducted.

(Reducing Agent)

The photothermographic material of the invention contains a reducing agent for the organic silver salt. The reducing agent may be any substance (preferably, organic substance) capable of reducing silver ions into metallic silver. Examples of the reducing agent are described in JP-A No. 11-65021 (column Nos. 0043 to 0045) and EP-A 0803764 A1 (page 7, line 34 to page 18, line 12).

In the invention, a so-called hindered phenolic reducing agent or a bisphenol agent having a substituent at the ortho-position to the phenolic hydroxyl group is preferred and the compound represented by the following formula (R) is more preferred.

In the invention, as the reducing agent, a so-called hindered phenolic reducing agent having a substituent group at an ortho position of a phenolic hydroxyl group or a bisphenolic reducing agent is preferred and compounds represented by the following formula (R) is more preferred.

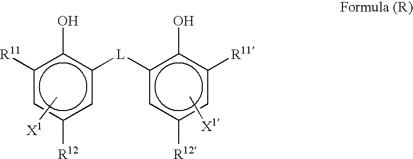

(In the formula (R), R¹¹ and R^{11′} each independently denote an alkyl group having 1 to 20 carbon atoms. R¹² and R^{12′} each independently denote a substituent group substitutable for a hydrogen atom or a benzene ring. L denotes a —S— group or a —CHR¹³— group. R¹³ denotes a hydrogen atom or an alkyl group having 1 to 20 carbon atoms. X¹ and X^{1′} each independently denote a group substitutable for a hydrogen atom or a benzene ring.)

The formula (R) will be detailed.

1) R¹¹ and R^{11′}

R¹¹ and R^{11′} each are independently a substituted or unsubstituted alkyl group having 1 to 20 carbon atoms, and a substituent of the alkyl group is preferable, though not particularly restricted, to be an aryl group, a hydroxy group, an alkoxy group, an aryloxy group, an alkylthio group, an arylthio group, an acylamino group, a sulfoneamido group, a sulfonyl group, a phosphoryl group, an acyl group, a carbamoyl group, an ester group, an ureido group, an urethane group or a halogen atom.

2) R¹² and R^{12′}, X¹ and X^{1′}

R12 and R12′ each independently represent a hydrogen atom or a group capable of substituting for a hydrogen atom on a benzene ring. X1 and X1′ each independently represent a hydrogen atom or a group capable of substituting for a hydrogen atom on a benzene ring. Each of the groups capable of substituting for a hydrogen atom on the benzene ring can include, preferably, alkyl group, aryl group, halogen atom, alkoxy group, and acylamino group.

3) L

L denotes a —S— group or a —CHR¹³— group. R¹³ denotes a hydrogen atom or an alkyl group having 1 to 20 carbon atoms, and the alkyl group may have a substituent group. Specific examples of an unsubstituted alkyl group of the R¹³ include a methyl group, an ethyl group, a propyl group, a butyl group, a heptyl group, an undecyl group, an isopropyl group, a 1-ethylpentyl group and a 2,4,4-trimethylpentyl group. Examples of substituent groups of the alkyl group are similar to those of the R¹¹ and include a halogen atom, an alkoxy group, an alkylthio group, an aryloxy group, an arylthio group, an acylamino group, a sulfoneamido group, a sulfonyl group, a phosphoryl group, an oxycarbonyl group, a carbamoyl group, and a sulfamoyl group.

4) Preferable Substituent

R¹¹ and R^{11′} are preferably a secondary or tertiary alkyl group having 3 to 15 carbon atoms. Specific examples thereof include an isopropyl group, an isobutyl group, a t-butyl group, a t-amyl group, a t-octyl group, a cyclohexyl group, a cyclopentyl group, a 1-methylcyclohexyl group, and a 1-methylcyclopropyl group. More preferable one as the R¹¹ and R^{11′} is a tertiary alkyl group having 4 to 13 carbon atoms, among these a t-butyl group, a t-amyl group, and a 1-methylcyclohexyl group being more preferable, the t-butyl group being most preferable.

R12 and R12′ are, preferably, an alkyl group having 1 to 20 carbon atoms and can include, specifically, methyl group, ethyl group, propyl group, butyl group, isopropyl group, t-butyl group, t-amyl group, cyclohexyl group, 1-methylcyclohexyl group, benzyl group, methoxymethyl group and methoxyethyl group. More preferred are methyl group, ethyl group, propyl group, isopropyl group, and t-butyl group.

X¹ and X^{1′} are preferably a hydrogen atom, a halogen atom or an alkyl group, a hydrogen atom being more preferable.

L is preferably a —CHR¹³— group.

Preferably, R¹³ is a hydrogen atom or an alkyl group having 1 to 15 carbon atoms, and as the alkyl group a methyl group, an ethyl group, a propyl group, an isopropyl group or a 2,4,4-trimethylpentyl group is preferable. Particularly preferably, the R¹³ is a hydrogen atom, a methyl group, an ethyl group, a propyl group or an isopropyl group.

In the case of the R¹³ being a hydrogen atom, R¹² and R^{12′} are preferably an alkyl group having 2 to 5 carbon atoms, an ethyl group and a propyl group being preferable, the ethyl group being most preferable.

In the case of the R¹³ being a primary or secondary alkyl group having 1 to 8 carbon atoms, R¹² and R^{12′} are preferably a methyl group. As the primary or secondary alkyl group having 1 to 8 carbon atoms of the R¹³, a methyl group, an ethyl group, a propyl group and an isopropyl group is preferable, a methyl group, an ethyl group or a propyl group being more preferable.

When all of the R¹¹, R^{11′}, R¹² and R^{12′} are a methyl group, the R¹³ is preferably a secondary alkyl group. In this case, as the secondary alkyl group of the R¹³, an isopropyl group, an isobutyl group and a 1-ethylpentyl group are preferable, the isopropyl group being more preferable.

The reducing agents, depending on combinations of the R¹¹, R^{11′}, R¹², R^{12′} and R¹³, are different in the heat developability, developed silver tones and so on. When two or more kinds of the reducing agents are combined, these can be controlled; accordingly, in accordance with the object, two or more kinds thereof can be preferably combined and used.

Specific examples of the reducing agents of the invention including the compounds represented by formula (R) according to the invention are shown below, but the invention is not restricted to them.

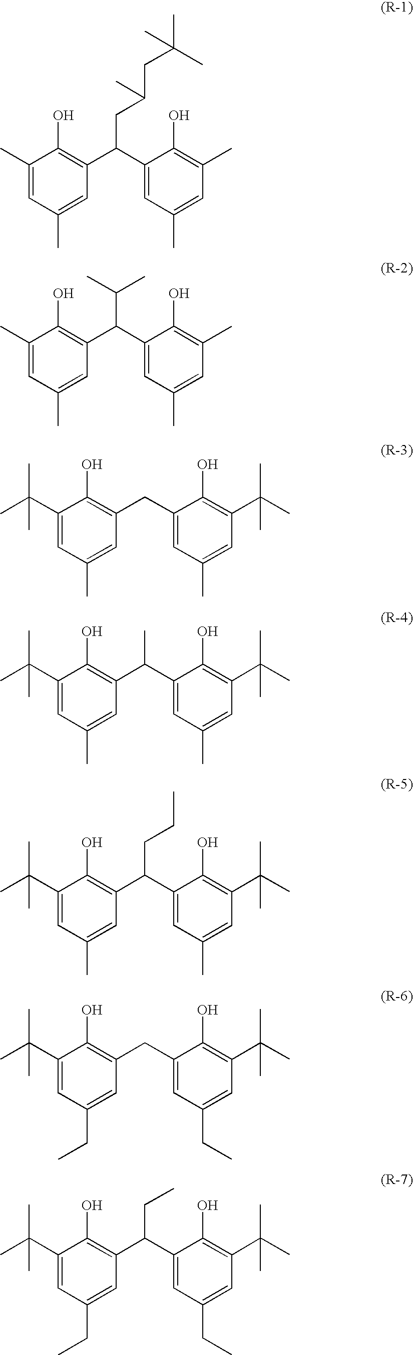

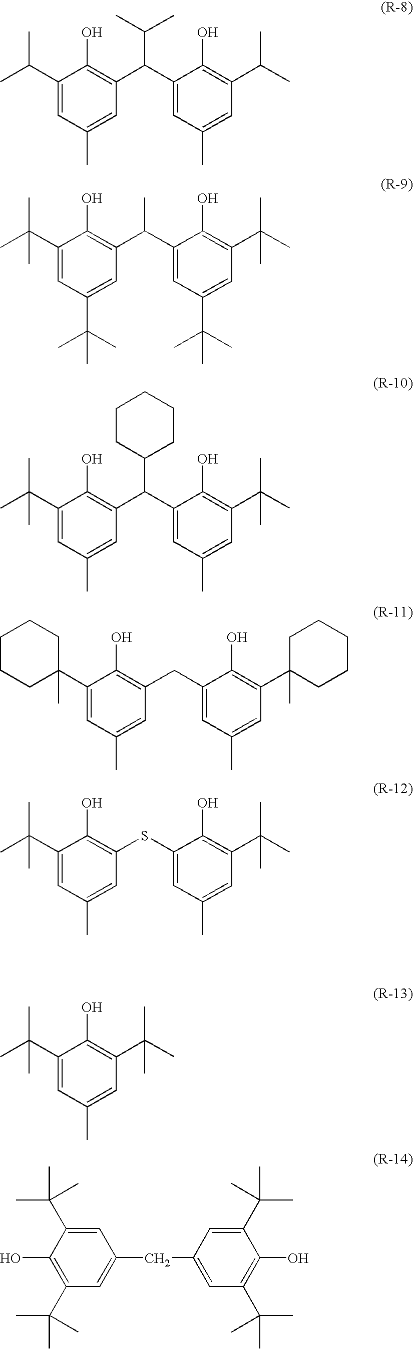

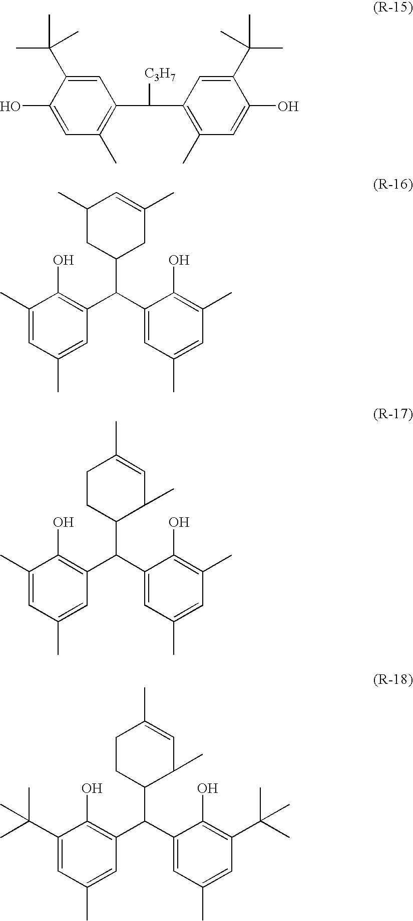

As preferred reducing agents of the invention other than those above, there can be mentioned compounds disclosed in JP-A Nos. 2001-188314, 2001-209145, 2001-350235, and 2002-156727.

In the invention, an amount of added reducing agent is preferably in the range of 0.1 to 3.0 g/m², more preferably in the range of 0.2 to 1.5 g/m², and still more preferably in the range of 0.3 to 1.0 g/m². It is preferably contained by 5 to 50 mol percent to one mole of silver in a surface that has an image-forming layer, more preferably by 8 to 30 mol percent, and still more preferably by 10 to 20 mol percent. The reducing agent is preferably contained in the image-forming layer.

In the invention, the reducing agent may be incorporated into photothermographic material by being added into the coating solution, such as in the form of a solution, an emulsion dispersion, a solid fine particle dispersion, and the like.

As a well-known emulsifying dispersion method, a method in which an auxiliary solvent such as oil such as dibutyl phthalate, tricresyl phosphate, glyceryl triacetate or diethyl phthalate, ethyl acetate or cyclohexanone is used to dissolve, and thereby an emulsion dispersion is mechanically prepared can be cited.

As solid fine particle dispersion method, there can be mentioned a method comprising dispersing the powder of the reducing agent in a proper medium such as water, by means of ball mill, colloid mill, vibrating ball mill, sand mill, jet mill, roller mill, or ultrasonics, thereby obtaining solid dispersion. In this case, there can also be used a protective colloid (such as polyvinyl alcohol), or a surfactant (for instance, an anionic surfactant such as sodium triisopropylnaphthalenesulfonate (a mixture of compounds having the isopropyl groups in different substitution sites)). In the mills enumerated above, generally used as the dispersion media are beads made of zirconia and the like, and Zr and the like eluting from the beads may be incorporated in the dispersion. Although depending on the dispersing conditions, the amount of Zr and the like generally incorporated in the dispersion is in the range from 1 ppm to 1,000 ppm. It is practically acceptable so long as Zr is incorporated in an amount of 0.5 mg or less per 1 g of silver.

An anti-septic (such as sodium benzoisothiazolinone salt) is preferably contained in an aqueous dispersion.

Particularly preferable one is a solid particle dispersion method of a reducing agent, wherein the reducing agent is added as fine particles having an average particle size in the range of 0.01 to 10 μm, preferably in the range of 0.05 to 5 μm and more preferably in the range of 0.1 to 2 μm. In the application, other solid dispersoids are also preferably dispersed in the particle size in this range and used.

(Development Accelerator)

In the photothermographic material of the invention, sulfoneamide phenolic compounds described in the specification of JP-A No. 2000-267222, and represented by formula (A) described in the specification of JP-A No. 2000-330234; hindered phenolic compounds represented by formula (II) described in JP-A No. 2001-92075; hydrazine compounds described in the specification of JP-A No. 10-62895, represented by formula (I) described in the specification of JP-A No. 11-15116, represented by formula (D) described in the specification of JP-A No. 2002-156727, and represented by formula (1) described in the specification of JP-A No. 2002-278017; and phenolic or naphthalic compounds represented by formula (2) described in the specification of JP-A No. 2001-264929 are used preferably as a development accelerator. The development accelerator described above is used in the range from 0.1 mol % to 20 mol %, preferably, in the range from 0.5 mol % to 10 mol % and, more preferably, in the range from 1 mol % to 5 mol % with respect to the reducing agent. The introduction methods to the photothermographic material can include, the same methods as those for the reducing agent and, it is particularly preferred to add as a solid dispersion or an emulsion dispersion. In a case of adding as an emulsion dispersion, it is preferred to add as an emulsion dispersion dispersed by using a high boiling solvent which is solid at a normal temperature and an auxiliary solvent at a low boiling point, or to add as a so-called oilless emulsion dispersion not using the high boiling solvent.

In the invention, among the development accelerators, hydrazine system compounds expressed by a general formula (D) described in JP-A No. 2002-156727 and phenolic or naphtholic compounds expressed by a general formula (2) described in JP-A No. 2001-264929 are more preferably used.

Particularly preferred development accelerators of the invention are compounds represented by the following formulae (A-1) and (A-2).
Q1-NHNH-Q2 Formula (A-1)

(In the formula, Q1 represents an aromatic group or a heterocyclic group coupling at a carbon atom to —NHNH-Q2 and Q2 represents a carbamoyl group, an acyl group, an alkoxycarbonyl group, an aryloxycarbonyl group, a sulfonyl group or a sulfamoyl group.)

In formula (A-1), the aromatic group or the heterocyclic group represented by Q1 is, preferably, 5 to 7 membered unsaturated ring. Preferred examples are benzene ring, pyridine ring, pyrazine ring, pyrimidine ring, pyridazine ring, 1,2,4-triazine ring, 1,3,5-triazine ring, pyrrole ring, imidazole ring, pyrazole ring, 1,2,3-triazole ring, 1,2,4-triazole ring, tetrazole ring, 1,3,4-thiadiazole ring, 1,2,4-thiadiazole ring, 1,2,5-thiadiazole ring, 1,3,4-oxadiazole ring, 1,2,4-oxadiazole ring, 1,2,5-oxadiazole ring, thiazole ring, oxazole ring, isothiazole ring, isooxazole ring, and thiophene ring. Condensed rings in which the rings described above are condensed to each other are also preferred.

The rings described above may have substituent groups and in the case where they have two or more substituent groups, the substituent groups may be identical or different from each other. Examples of the substituent group include a halogen atom, an alkyl group, an aryl group, a carbon amide group, an alkylsulfoneamide group, an arylsulfonamide group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and acyl group. In a case where the substituent groups are groups capable of substituting, they may have further substituent groups and examples of preferred substituents include a halogen atom, an alkyl group, an aryl group, a carbon amide group, an alkylsulfoneamide group, an arylsulfonamide group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group and an acyloxy group.

The carbamoyl group represented by Q2 is a carbamoyl group preferably having 1 to 50 carbon atoms and, more preferably, having 6 to 40 carbon atoms, and examples can include not-substituted carbamoyl, methyl carbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbaoyl, N-3-pyridylcarbamoyl and N-benzylcarbamoyl.

The acyl group represented by Q2 is an acyl group, preferably, having 1 to 50 carbon atoms and, more preferably, 6 to 40 carbon atoms and can include, for example, formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl. Alkoxycarbonyl group represented by Q2 is an alkoxycarbonyl group, preferably, of 2 to 50 carbon atom and, more preferably, of 6 to 40 carbon atoms and can include, for example, methoxycarbonyl, ethoxycarbonyl, isobutyloxycarbonyl, cyclehexyloxycarbonyl, dodecyloxycarbonyl and benzyloxycarbonyl.

The aryloxycarbonyl group represented by Q2 is an aryloxycarbonyl group, preferably, having 7 to 50 carbon atoms and, more preferably, having 7 to 40 carbon atoms and can include such as phenoxycarbonyl, 4-octyloxyphenoxycarbonyl, 2-hydroxymethylphenoxycarbonyl, and 4-dodecyloxyphenoxycarbonyl. The sulfonyl group represented by Q2 is a sulfonyl group, preferably having 1 to 50 carbon atoms and, more preferably, having 6 to 40 carbon atoms and can include, for example, methylsulfonyl, butylsulfonyl, octylsulfonyl, 2-hexadecylsulfonyl, 3-dodecyloxypropylsulfonyl, 2-octyloxy-5-tert-octylphenylsulfonyl, and 4-dodecyloxyphenylsulfonyl.

The sulfamoyl group represented by Q2 is a sulfamoyl group, preferably having 0 to 50 carbon atoms, more preferably, 6 to 40 carbon atoms and can include, for example, unsubstituted sulfamoyl, an N-ethylsulfamoyl group, N-(2-ethylhexyl)sulfamoyl, N-decylsulfamoyl, N-hexadecylsulfamoyl, N-[3-(2-ethylhexyloxy)propyl]sulfamoyl, N-(2-chloro-5-dodecyloxycarbonylphenyl)sulfamoyl, and N-(2-tetradecyloxyphenyl)sulfamoyl. The groups represented by Q2 may further have a group mentioned as the example of the substituent of 5 to 7-membered unsaturated ring represented by Q1 at the position capable of substituting. In a case where the group has two or more substituents, such substituents may be identical or different from each other.

Then, preferred range for the compounds represented by formula (A-1) is to be described. 5 to 6 membered unsaturated ring is preferred for Q1, and benzene ring, pyrimidine ring, 1,2,3-triazole ring, 1,2,4-triazole ring, tetrazole ring, 1,3,4-thiadiazole ring, 1,2,4-thiadiazole ring, 1,3,4-oxadiazole ring, 1,2,4-oxadiazole ring, thioazole ring, oxazole ring, isothiazole ring, isooxazole ring and a ring in which the ring described above is condensed with a benzene ring or unsaturated hetero ring are further preferred. Further, Q2 is preferably a carbamoyl group and, particularly, a carbamoyl group having hydrogen atom on the nitrogen atom is particularly preferred.

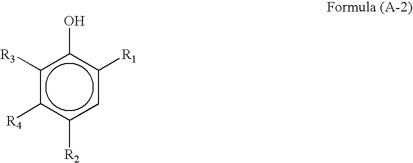

In the formula (A-2), R₁ represents an alkyl group, an acyl group, an acylamino group, a sulfoneamide group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group or a carbonic ester group. R₃ and R₄ each represent a group capable of being substituted in a benzene ring that is mentioned as the example of the substituent for the formula (A-1). R₃ and R₄ may bond together to form a condensed ring.

R₁ is, preferably, an alkyl group having 1 to 20 carbon atoms (such as a methyl group, an ethyl group, an isopropyl group, a butyl group, a tert-octyl group, or a cyclohexyl group), an acylamino group (such as an acetylamino group, a benzoylamino group, a methylureido group, or a 4-cyanophenylureido group), or a carbamoyl group (such as a n-butylcarbamoyl group, a N,N-diethylcarbamoyl group, a phenylcarbamoyl group, a 2-chlorophenylcarbamoyl group, or a 2,4-dichlorophenylcarbamoyl group), an acylamino group (including an ureido group or a urethane group) being more preferred.

R₂ is, preferably, a halogen atom (more preferably, a chlorine atom or a bromine atom), an alkoxy group (such as a methoxy group, a butoxy group, a n-hexyloxy group, a n-decyloxy group, a cyclohexyloxy group or a benzyloxy group), or an aryloxy group (such as a phenoxy group or a naphthoxy group).

R₃ is, preferably, a hydrogen atom, a halogen atom or an alkyl group having 1 to 20 carbon atoms, and most preferably a halogen atom. R₄ is preferably a hydrogen atom, an alkyl group or an acylamino group, and more preferably an alkyl group or an acylamino group. Examples of the preferred substituent thereof are identical with those for R₁. In a case where the R₄ is an acylamino group, the R₄ may preferably bond with the R₃ to form a carbostyryl ring.

In a case where the R₃ and R₄ in the formula (A-2) bond together to form a condensed ring, a naphthalene ring is particularly preferred as the condensed ring. The substituent same as the example of the substituent referred to in the formula (A-1) may bond to the naphthalene ring. In a case where the formula (A-2) is a naphtholic compound, the R₁, is, preferably, a carbamoyl group. Among these, a benzoyl group is particularly preferred. The R₂ is, preferably, an alkoxy group or an aryloxy group and an alkoxy group is particularly preferable.

In what follows, preferred specific examples of the development accelerator according to the invention will be described. The invention is not restricted thereto. 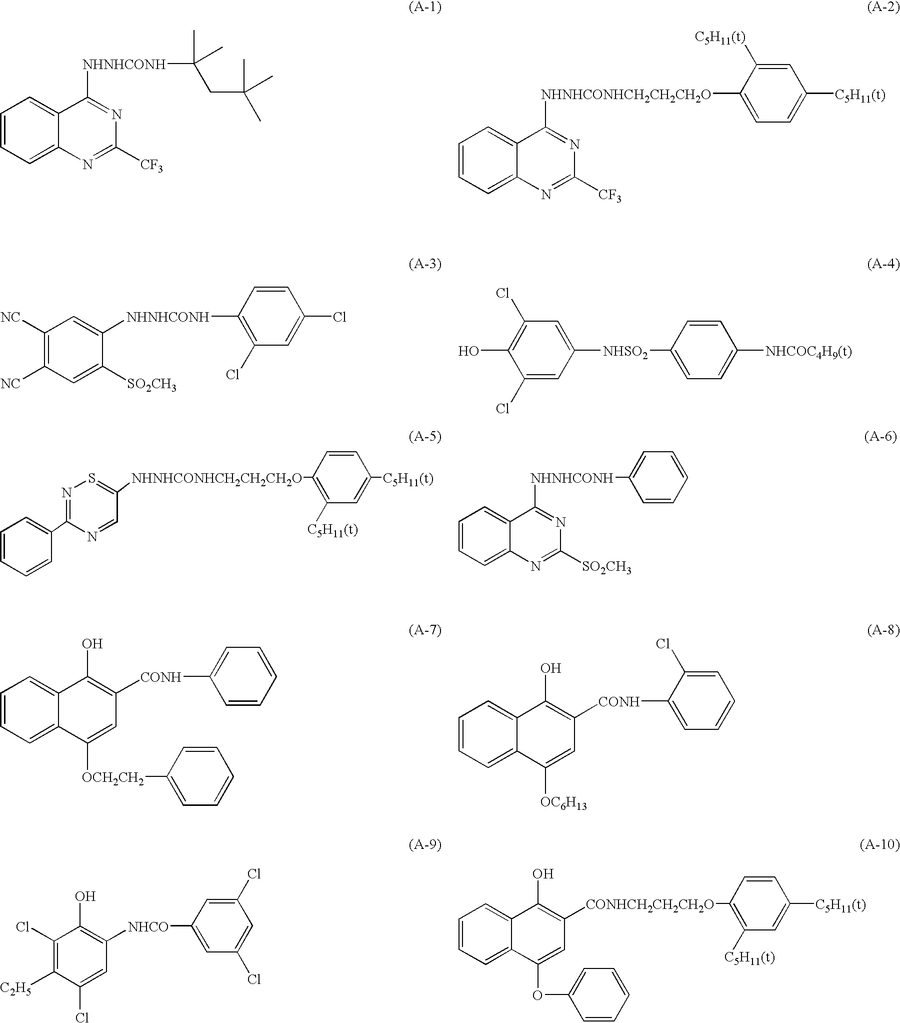
(Explanation of Hydrogen Bonding Compound)

In the invention, in the case where the reducing agent has an aromatic hydroxyl group (—OH) or an amino group (—NHR, R represents each one of hydrogen atom and alkyl group), particularly in the case where the reducing agent is a bisphenol described above, it is preferred to use in combination, a non-reducing compound having a group capable of reacting with these groups of the reducing agent, and that is also capable of forming a hydrogen bond therewith.

As a group forming a hydrogen bond with a hydroxyl group or an amino group, a phosphoryl group, a sulfoxido group, a sulfonyl group, a carbonyl group, an amido group, an ester group, an urethane group, an ureido group, a tertiary amino group, a nitrogen-containing aromatic group, and the like can be cited. Particularly preferred ones among these are compounds having a phosphoryl group, a sulfoxido group, an amido group (without having a >N—H group but being blocked in the form of >N—Ra (where, Ra represents a substituent other than H)), an urethane group (without having a >N—H group but being blocked in the form of >N—Ra (where, Ra represents a substituent other than H)), or an ureido group (without having a >N—H group but being blocked in the form of >N—Ra (where, Ra represents a substituent other than H))).

In the invention, particularly preferable hydrogen bonding compounds are compounds expressed by a formula (D) below.

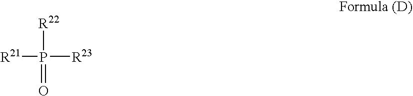

In the formula (D), R²¹ to R²³ each independently represent an alkyl group, an aryl group, an alkoxy group, an aryloxy group, an amino group, or a heterocyclic group, and these groups may be substituted or unsubstituted one.

In the case where the R²¹ to R²³ contain a substituent, examples of the substituents include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, a phosphoryl group, and the like, and among these preferred ones as the substituent are an alkyl group or an aryl group such as a methyl group, an ethyl group, an isopropyl group, a t-butyl group, a t-octyl group, a phenyl group, a 4-alkoxyphenyl group and a 4-acyloxyphenyl group.

Specific examples of the alkyl group expressed by the R²¹ to R²³ include such as a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenetyl group, and a 2-phenoxypropyl group.

As the aryl group, a phenyl group, a cresyl group, a xylyl group, a naphthyl group, a 4-t-butylphenyl group, a 4-t-octylphenyl group, a 4-anisidyl group, a 3,5-dichlorophenyl group, and the like can be cited.

As the alkoxyl group, a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group, and the like can be cited.

As the aryloxy group, a phenoxy group, a cresyloxy group, an isopropylphenoxy group, a 4-t-butylphenoxy group, a naphthoxy group, a biphenyloxy group, and the like can be cited.

As the amino group, a dimethylamino group, a diethylamino group, a dibutylamino group, a dioctylamino group, a N-methyl-N-hexylamino group, a dicyclohexylamino group, a diphenylamino group, a N-methyl-N-phenylamino, and the like can be cited.

Preferred ones as the R²¹ to R²³ are an alkyl group, an aryl group, an alkoxy group, and an aryloxy group. As to the effects of the invention, it is preferred that at least one of the R²¹ to R²³ is an alkyl group or an aryl group, and more preferably, at least two thereof are an alkyl group or an aryl group. From the viewpoint of the availability at low cost, it is preferred that the R²¹ to R²³ are of the same group.

Specific examples of the hydrogen bonding compounds including compounds represented by the formula (D) in the invention are shown below; however it should be understood that the invention is not restricted thereto.

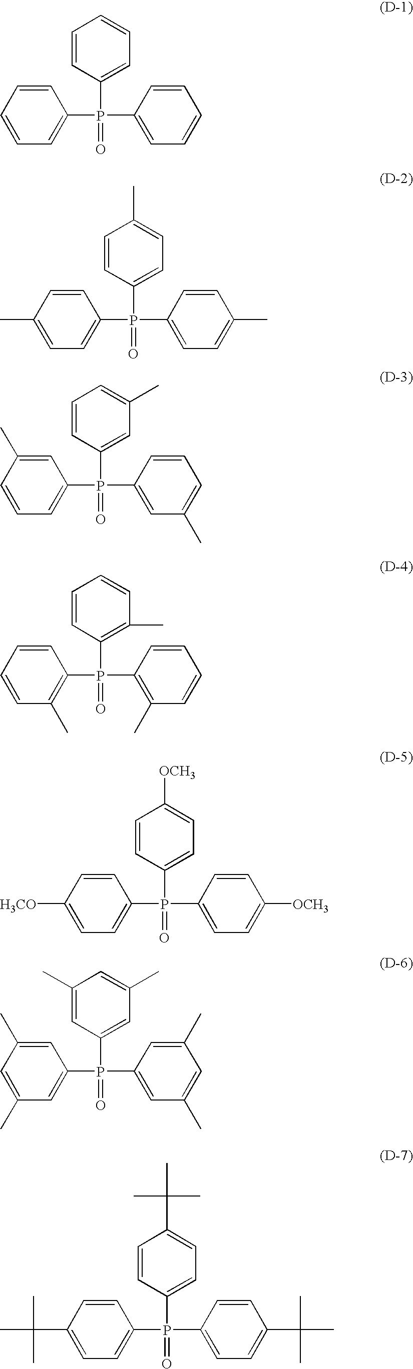

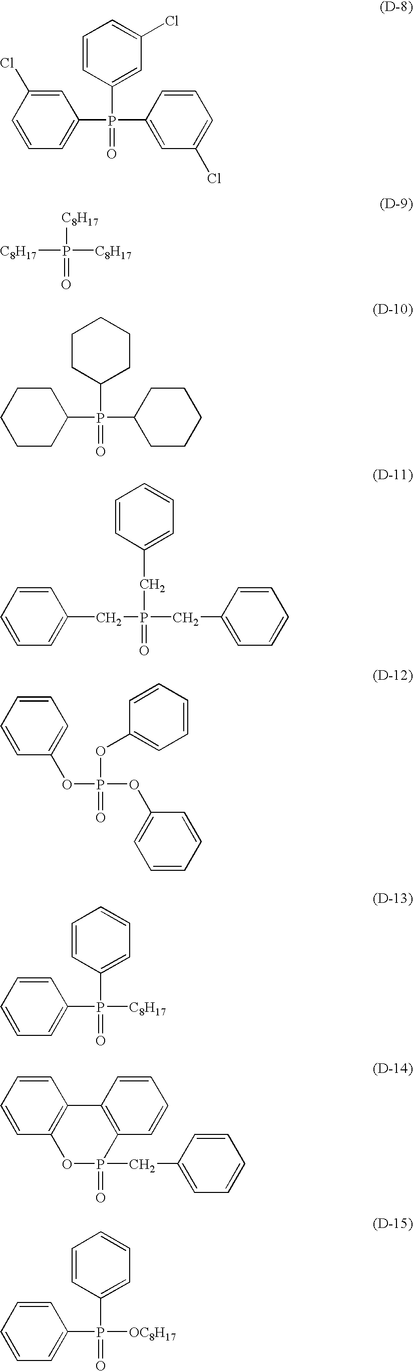

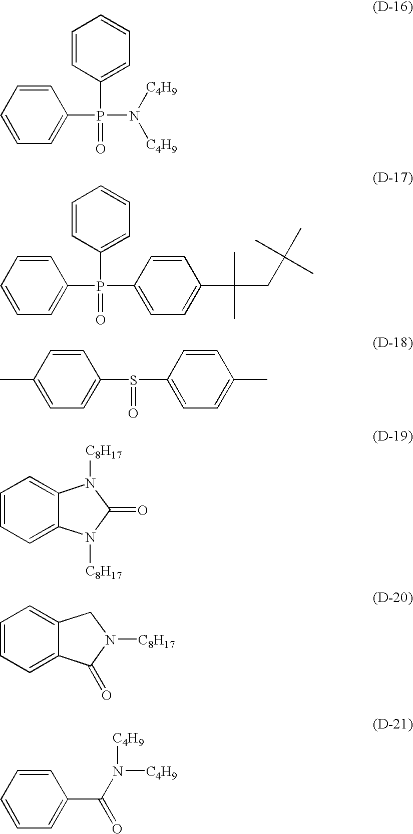

As specific examples of hydrogen bonding compounds other than those mentioned above, ones described in EP-A No. 1096310, JP-A No. 2002-156727 and Japanese Patent Application No. 2001-124796 can be cited.

The compounds expressed by the formula (D) according to the invention can be incorporated in a coating solution in the form of a solution, an emulsion dispersion, or a solid-dispersed fine particle dispersion similarly to the reducing agents and used in the photosensitive material; however, it is preferably used in the form of solid-dispersed fine particle dispersion. In the solution, the compound according to the invention forms a hydrogen bonding complex with a compound having a phenolic hydroxyl group or an amino group, and, depending on the combination of the reducing agent and the compound expressed by the formula (D), the complex can be isolated in a crystalline state.

It is particularly preferable to use the crystal powder thus isolated in the form of solid-dispersed fine particle dispersion, because it provides stable performance. Furthermore, a method in which the reducing agent and the compound expressed by the formula (D) according to the invention are mixed in the form of powders, followed by, by use of a proper dispersing agent and a sand grind mill, dispersing to form the complex during the dispersion can be used preferably as well.

The compound expressed by the formula (D) according to the invention is preferably used, with respect to the reducing agent, in the range of from 1 to 200 mol percent, more preferably from 10 to 150 mol percent, and further preferably from 20 to 100 mol percent.

(Photosensitive Silver Halide)

1) Halogen Composition

For the photosensitive silver halide used in the invention, there is no particular restriction on the halogen composition and silver chloride, silver bromochloride, silver bromide, silver iodobromide, silver iodochlorobromide and silver iodide can be used. Among them, silver bromide, silver iodobromide and silver iodide are preferred. The distribution of the halogen composition in a grain may be uniform or the halogen composition may be changed stepwise, or it may be changed continuously. Further, a silver halide grain having a core/shell structure can be used preferably. Preferred structure is a twofold to fivefold structure and, more preferably, core/shell grain having a twofold to fourfold structure can be used. Further, a technique of localizing silver bromide or silver iodide to the surface of a silver chloride, silver bromide or silver chlorobromide grains can also be used preferably.

2) Method of Forming Particles

The method of forming photosensitive silver halide is well-known in the relevant art and, for example, methods described in Research Disclosure No. 10729, June 1978 and U.S. Pat. No. 3,700,458 can be used. Specifically, a method of preparing a photosensitive silver halide by adding a silver-supplying compound and a halogen-supplying compound in a gelatin or other polymer solution and then mixing them with an organic silver salt is used. Further, a method described in JP-A No. 11-119374 (paragraph Nos. 0217 to 0224) and methods described in JP-A Nos. 11-352627 and 2000-347335 are also preferred.

3) Grain Size

The grain size of the photosensitive silver halide is preferably small with an aim of suppressing clouding after image formation and, specifically, it is 0.20 μm or less, more preferably, 0.01 μm to 0.15 μm and, further preferably, 0.02 μm to 0.12 μm. The grain size as used herein means an average diameter of a circle converted such that it has a same area as a projection area of the silver halide grain (projection area of a main plane in a case of a tabular grain).

4) Grain Shape

The shape of the silver halide grain can include, for example, cubic, octahedral, tabular, spherical, rod-like or potato-like shape. The cubic grain is particularly preferred in the invention. A silver halide grain rounded at comers can also be used preferably. While there is no particular restriction on the index of plane (Mirror's index) of an crystal surface of the photosensitive silver halide grain, it is preferred that the ratio of [100] face is higher, in which the spectral sensitizing efficiency is higher in a case of adsorption of a spectral sensitizing dye. The ratio is preferably 50% or more, more preferably, 65% or more and, further preferably, 80% or more. The ratio of the Mirror's index [100] face can be determined by the method of utilizing the adsorption dependency of [111] face and [100] face upon adsorption of a sensitizing dye described by T. Tani; in J. Imaging Sci., vol. 29, page 165 (1985).

5) Heavy Metal

The photosensitive silver halide grain of the invention can contain metals or complexes of metals belonging to groups 8 to 14, preferably groups 8 to 10, of the periodic table. The metal or the center metal of the metal complex from groups 8 to 10 of the periodic table is preferably rhodium, ruthenium or iridium. The metal complex may be used alone, or two or more kinds of complexes comprising identical or different species of metals may be used together. A preferred content is in the range from 1×10⁻⁹ mol to 1×10⁻³ mol per one mol of silver. The heavy metals, metal complexes and the addition method thereof are described in JP-A No. 7-225449, in paragraph Nos. 0018 to 0024 of JP-A No.11-65021 and in paragraph Nos. 0227 to 0240 of JP-A No. 11-119374.

In the present invention, a silver halide grain having a hexacyano metal complex is present on the outermost surface of the grain is preferred. The hexacyano metal complex includes, for example, [Fe(CN)6]⁴⁻, [Fe(CN)6]³⁻, [Ru(CN)6]⁴⁻, [Os(CN)6]⁴⁻, [Co(CN)6]³⁻, [Rh(CN)6]³⁻, [Ir(CN)6]³⁻, [Cr(CN)6]³⁻, and [Re(CN)6]³⁻. In the invention, hexacyano Fe complex is preferred.

Since the hexacyano complex exists in ionic form in an aqueous solution, paired cation is not important and alkali metal ion such as sodium ion, potassium ion, rubidium ion, cesium ion and lithium ion, ammonium ion, alkyl ammonium ion (for example, tetramethyl ammonium ion, tetraethyl ammonium ion, tetrapropyl ammonium ion, and tetra(n-butyl) ammonium ion), which are easily misible with water and suitable to precipitation operation of a silver halide emulsion are preferably used.

The hexacyano metal complex can be added while being mixed with water, as well as a mixed solvent of water and an appropriate organic solvent miscible with water (for example, alcohols, ethers, glycols, ketones, esters and amides) or gelatin.

An addition amount of a hexacyano metal complex is, per one mol of silver, preferably 1×10⁻⁵ mol or more and 1×10⁻² mol or less and, more preferably, 1×10⁻⁴ mol or more and 1×10⁻³ mol or less.

In order to allow the hexacyano metal complex to be present on the outermost surface of a silver halide grain, the hexacyano metal complex is directly added in any stage of: after completion of addition of an aqueous solution of silver nitrate used for grain formation, before completion of emulsion forming step prior to a chemical sensitization step, of conducting chalcogen sensitization such as sulfur sensitization, selenium sensitization and tellurium sensitization or noble metal sensitization such as gold sensitization, during washing step, during dispersion step and before chemical sensitization step. In order not to grow the fine silver halide grain, the hexacyano metal complex is rapidly added preferably after the grain is formed, and it is preferably added before completion of the emulsion forming step.

Addition of the hexacyano complex may be started after addition of 96% by weight of an entire amount of silver nitrate to be added for grain formation, more preferably started after addition of 98% by weight and, particularly preferably, started after addition of 99% by weight.

When any of the hexacyano metal complex is added after addition of an aqueous silver nitrate just before completion of grain formation, it can be adsorbed to the outermost surface of the silver halide grain and most of them form an insoluble salt with silver ions on the surface of the grain. Since the hexacyano iron (II) silver salt is a less soluble salt than AgI, re-dissolution with fine grains can be prevented and fine silver halide grains with smaller grain size can be prepared.

Metal atoms that can be contained in the silver halide grain used in the invention (for example, [Fe(CN)6]⁴⁻), desalting method of a silver halide emulsion and chemical sensitization method are described in paragraph Nos. 0046 to 0050 of JP-A No. 11-84574, in paragraph Nos. 0025 to 0031 of JP-A No. 11-65021, and paragraph Nos. 0242 to 0250 of JP-A No.11-119374.

6) Gelatin

As the gelatin contained the photosensitive silver halide emulsion used in the invention, various kinds of gelatins can be used. It is necessary to maintain an excellent dispersion state of a photosensitive silver halide emulsion in an organic silver salt containing coating solution, and gelatin having a molecular weight of 10,000 to 1,000,000 is preferably used. And phthalated gelatin is also preferably used. These gelatins may be used at grain formation step or at the time of dispersion after desalting treatment and it is preferably used at grain formation step.

7) Sensitizing Dye

As the sensitizing dye applicable in the invention, those capable of spectrally sensitizing silver halide grains in a desired wavelength region upon adsorption to silver halide grains having spectral sensitivity suitable to spectral characteristic of an exposure light source can be selected advantageously. The photothermographic material of the invention is preferably spectrally sensitized to have a spectral sensitivity peak, particularly, in 600 to 900 nm, or 300 to 500 nm. The sensitizing dyes and the addition method are disclosed, for example, JP-A No. 11-65021 (paragraph Nos. 0103 to 0109), as a compound represented by the formula (II) in JP-A No. 10-186572, dyes represented by the formula (I) in JP-A No. 11-119374 (paragraph No. 0106), dyes described in U.S. Pat. Nos. 5,510,236 and 3,871,887 (Example 5), dyes disclosed in JP-A Nos. 2-96131 and 59-48753, as well as in page 19, line 38 to page 20, line 35 of EP-A No. 0803764A1, and in JP-A Nos. 2001-272747, 2001-290238 and 2002-23306. The sensitizing dyes described above may be used alone or two or more of them may be used in combination. In the invention, sensitizing dye can be added preferably after desalting step and before coating step, and more preferably after desalting step and before the completion of chemical ripening.

In the invention, a sensitizing dye may be added at any amount according to performances such as the photosensitivity and fogging; however, it is preferably added from 10⁻⁶ to 1 mol, and more preferably, from 10⁻⁴ to 10⁻¹ mol per one mol of silver halide in the photosensitive layer.

The photothermographic material of the invention may also contain super sensitizers in order to improve spectral sensitizing effect. The super sensitizers usable in the invention can include those compounds described in EP-A No. 587338, U.S. Pat. Nos. 3,877,943 and 4,873,184 and JP-A Nos. 5-341432, 11-109547, and 10-111543.

8) Chemical Sensitization

The photosensitive silver halide grain in the invention is preferably chemically sensitized by sulfur sensitization method, selenium sensitization method or tellurium sensitization method. As the compound used preferably for the sulfur sensitization method, selenium sensitization method and tellurium sensitization method, known compounds, for example, compounds described in JP-A No. 07-128768 can be used. Particularly, the tellurium sensitization is preferred in the invention and compounds described in the literature cited in paragraph No. 0030 in JP-A No. 11-65021 and compounds shown by general formulae (II), (III), and (IV) in JP-A No. 05-313284 are more preferred.

The photosensitive silver halide grain in the invention is preferably chemically sensitized by gold sensitization method alone or in combination with the chalcogen sensitization described above. As the gold sensitizer, those having an oxidation number of gold of either +1 or +3 are preferred and those gold compounds used usually as the gold sensitizer are preferred. As typical examples, chloroauric acid, bromoauric acid, potassium chloroaurate, potassium bromoaurate, auric trichloride, potassium auric thiocyanate, potassium iodoaurate, tetracyanoauric acid, ammonium aurothiocyanate and pyridyl trichloro gold are preferred. Further, gold sensitizers described in U.S. Pat. No. 5,858,637 and JP-A No. 2002-278016 are also used preferably.

In the invention, chemical sensitization can be applied at any time so long as it is after grain formation and before coating and it can be applied, after desalting, (1) before spectral sensitization, (2) simultaneously with spectral sensitization, (3) after spectral sensitization, and (4) just before coating.

An amount of sulfur, selenium or tellurium sensitizer used in the invention may vary depending on the silver halide grain used, the chemical ripening condition and the like; however, it is used by substantially 10⁻⁸ to 10⁻² mol, preferably, substantially 10⁻⁷ to 10⁻³ mol per one mol of the silver halide.

An addition amount of the gold sensitizer may vary depending on various conditions; however, as a guide, it is substantially 10⁻⁷ to 10⁻³ mol and, more preferably, 10⁻⁶ to 5×10⁻⁴ mol per one mol of the silver halide. There is no particular restriction on the condition for the chemical sensitization in the invention; however, the pH is substantially 5 to 8, the pAg is substantially 6 to 11 and a temperature is substantially 40 to 95 degrees centigrade.

In the silver halide emulsion used in the invention, a thiosulfonic acid compound may be added according to the method described in EP-A No. 293917.

A reductive compound is used preferably for the photosensitive silver halide grain in the invention. As the specific compound for the reduction sensitization, ascorbic acid or aminoimino methane sulfonic acid is preferred, as well as use of stannous chloride, hydrazine derivatives, borane compounds, silane compounds and polyamine compounds are preferred. The reduction sensitizer may be added at any stage in the photosensitive emulsion production process from crystal growth to the preparation step just before coating. Further, it is preferred to apply reduction sensitization by ripening while keeping pH to 7 or higher or pAg to 8.3 or lower for the emulsion, and it is also preferred to apply reduction sensitization by introducing a single addition portion of silver ions during grain formation.

9) Compound that Can Be One-Electron-Oxidized to Provide a One-Electron Oxidation Product which Releases One or More Electrons

The photothermographic material of the invention preferably contains a compound that can be one-electron-oxidized to provide a one-electron oxidation product which releases one or more electrons. The said compound can be used in combination with various chemical sensitizers described above to increase the sensitivity of silver halide.

The compound that can be one-electron-oxidized to provide a one-electron oxidation product which can release one or more electrons is a compound selected from the following types 1 and 2.

(Type 1)

A compound that can be one-electron-oxidized to provide a one-electron oxidation product that, with a subsequent bond cleavage reaction, can further release at least one electron.

(Type 2)

A compound that can be one-electron-oxidized to provide a one-electron oxidation product that, after undergoing a subsequent bond formation reaction, can further release at least one electron.

Firstly, compounds according to the type 1 will be explained.

In the compounds according to the type 1, as compounds that can be one-electron-oxidized to provide a one-electron oxidation product that, with a subsequent bond cleavage reaction, can further release at least one electron, compounds referred to as “one photon two electrons sensitizer” or “deprotonating electron-donating sensitizer” described in JP-A No. 09-211769 (specific examples: compounds PMT-1 to S-37 in Tables E and F, pages 28 to 32); JP-A No. 09-211774; JP-A No. 11-95355 (specific examples: compounds INV 1 to 36); JP-W No. 2001-500996 (specific examples: compounds 1 to 74, 80 to 87, and 92 to 122); U.S. Pat. Nos. 5,747,235 and 5,747,236; EP-A No. 786692 (specific examples: compounds INV 1 to 35); EP-A No. 893732; U.S. Pat. Nos. 6,054,260 and 5,994,051; and so on. Preferable ranges of the compounds are same as preferable ranges described in cited patents.

In the compound of Group 1, as for a compound that can be one-electron-oxidized to provide a one-electron oxidation product which further releases one or more electrons, due to being subjected to a subsequent bond cleavage reaction, specific examples include the compounds represented by formula (1) (same as formula (1) described in JP-A No. 2003-114487), formula (2) (same as formula (2) described in JP-A No. 2003-114487), formula (3) (same as formula (1) described in JP-A No. 2003-114488), formula (4) (same as formula (2) described in JP-A No. 2003-114488), formula (5) (same as formula (3) described in JP-A No. 2003-114488), formula (6) (same as formula (1) described in JP-A No. 2003-75950), formula (7) (same as formula (2) described in JP-A No. 2003-75950), and formula (8), and the compound represented by formula (9) among the compounds which can undergo the chemical reaction represented by reaction formula (1). And the preferable range of these compounds is the same as the preferable range described in the quoted specification.

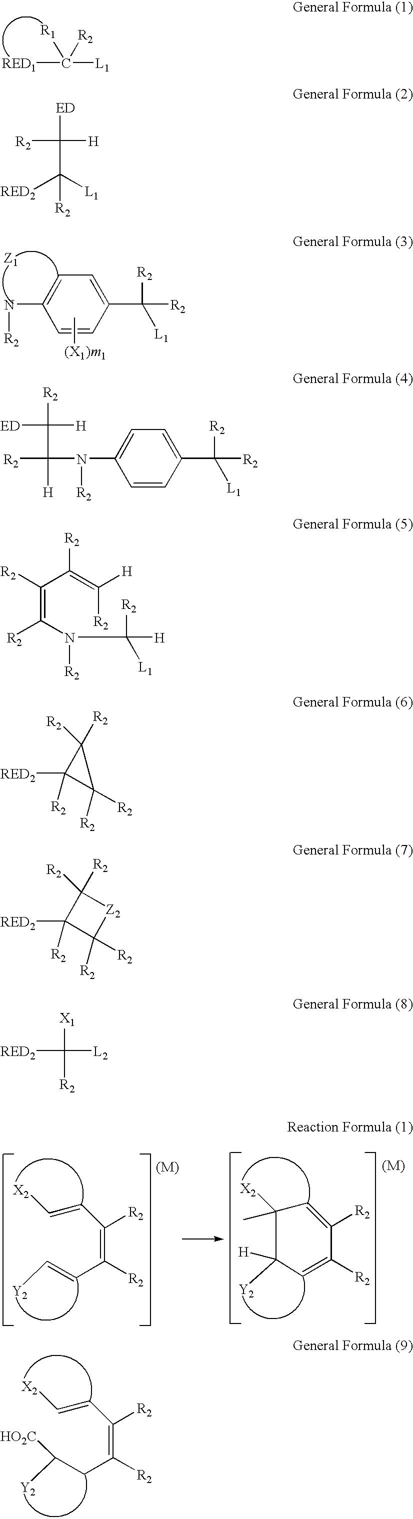

In the formulae, RED1 and RED2 represent a reducible group. R1 represents a nonmetallic atomic group forming a cyclic structure equivalent to a tetrahydro derivative or an octahydro derivative of a 5 or 6 membered aromatic ring (including a hetero aromatic ring) with a carbon atom (C) and RED1. R2 represents a hydrogen atom or a substituent. In the case where plural R2 exist in a same molecule, these may be the same or different. L1 represents a leaving group. ED represents an electron-donating group. Z1 represents an atomic group capable to form a 6 membered ring with a nitrogen atom and two carbon atoms of a benzene ring. X1 represents a substituent, and m1 represents an integral number of 0 to 3. Z2 represents —CR11R12-, —NR13-, or —O—. R11 and R12 each independently represent a hydrogen atom or a substituent. R13 represents a hydrogen atom, an alkyl group, an aryl group or a heterocyclic group. X1 represents an alkoxy group, an aryloxy group, a heterocyclic oxy group, an alkylthio group, an arylthio group, a heterocyclic thio group, an alkylamino group, an arylamino group or a heterocyclic amino group. L2 represents a carboxy group or a salt thereof, or a hydrogen atom. X2 represents a group to form a 5 membered heterocycle with C═C. M represents a radical, a radical cation or a cation.

Subsequently, compounds according to the type 2 will be explained.

In the compounds according to the type 2, as compounds that can be one-electron-oxidized to provide a one-electron oxidation product that, with a subsequent bond formation reaction, can further release at least one electron, compounds that can cause reactions represented by a general formula (10) (synonymous with the general formula (1) described in JP-A No. 2003-140287) or the chemical reaction formula (1) (synonymous with the general formula (1) described in JP-A No. 2003-33446) and can be represented by the general formula (11) (synonymous with the general formula (2) described in JP-A No. 2003-33446) can be cited. Preferable ranges of the compounds are same as the preferable ranges described in cited patents.

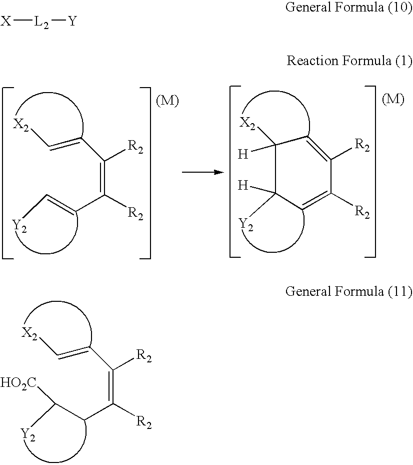

In the formula, X represents a reducing group that can be one electron oxidized. Y represents a reactive group including a carbon-carbon double bond portion, a carbon-carbon triple bond portion, an aromatic group portion or a non-aromatic heterocyclic portion of a benzo-condensed ring that can react with one-electron oxidation product that is formed by one-electron-oxidizing X to form a new bond. L₂ represents a connecting group that connects X and Y. R₂ represents a hydrogen atom or a substituent group. When there is a plurality of R₂s in the same molecule, these may be same or different from each other. X₂ represents a group that forms a 5-membered heterocycle together with C═C. Y₂ represents a group that forms a 5- or 6-membered aryl group or a heterocycle together with C═C. M represents a radical, a radical cation or a cation.

The compounds of Groups 1 and 2 preferably are “the compound having an adsorptive group to silver halide in a molecule” or “the compound having a partial structure of a spectral sensitizing dye in a molecule”. The representative adsorptive group to silver halide is the group described in JP-A No. 2003-156823, page 16 right, line 1 to page 17 right, line 12. A partial structure of a spectral sensitizing dye is the structure described in JP-A No. 2003-156823, page 17 right, line 34 to page 18 left, line 6.

As the compound of Groups 1 and 2, “the compound having at least one adsorptive group to silver halide in a molecule” is more preferred, and “the compound having two or more adsorptive groups to silver halide in a molecule” is further preferred. In the case where two or more adsorptive groups exist in a single molecule, those adsorptive groups may be identical or different with each other.

As preferable adsorptive group, a nitrogen containing heterocyclic group substituted by a mercapto group (e.g., a 2-mercaptothiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzothiazole group, a 1,5-dimethyl-1,2,4-triazolium-3-thiolate group and the like) or a nitrogen containing heterocyclic group having —NH— group as a partial structure of heterocycle capable to form a silver imidate (>NAg) (e.g., a benzotriazole group, a benzimidazole group, an indazole group and the like) are described. A 5-mercaptotetrazole group, a 3-mercapto-1,2,4-triazole group and a benzotriazole group are particularly preferable and a 3-mercapto-1,2,4-triazole group and a 5-mercaptotetrazole group are most preferable.

As an adsorptive group, the group which has two or more mercapto groups as a partial structure in a molecule is also particularly preferable. Herein, a mercapto group (—SH) may become a thione group in the case where it can tautomerize. As preferred examples of adsorptive group having two or more mercapto groups as a partial structure (dimercapto-substituted nitrogen containing heterocyclic group and the like), a 2,4-dimercaptopyrimidine group, a 2,4-dimercaptotriazine group and a 3,5-dimercapto1,2,4-triazole group are described.

Further, a quaternary salt structure of nitrogen or phosphor is also preferably used as an adsorptive group. As typical quaternary salt structure of nitrogen, an ammonio group (a trialkylammonio group, a dialkylarylammonio group, a dialkylheteroarylammonio group, an alkyldiarylammonio group, an alkyldiheteroarylammonio group and the like) and a nitrogen containing heterocyclic group including quaternary nitrogen atom are described. As a quaternary salt structure of phosphor, a phosphonio group (a trialkylphosphonio group, a dialkylarylphosphonio group, a dialkylheteroarylphosphonio group, an alkyldiarylphosphonio group, an alkyldiheteroarylphosphonio group, a triarylphosphonio group, a triheteroarylphosphonio group and the like) are described. A quaternary salt structure of nitrogen is more preferably used and a 5 or 6 membered aromatic heterocyclic group containing a quaternary nitrogen atom is further preferably used. Particularly preferably, a pyrydinio group, a quinolinio group and an isoquinolinio group are used. These nitrogen containing heterocyclic groups including a quaternary nitrogen atom may have any substituent.

As examples of counter anion of quaternary salt, halogen ion, carboxylate ion, sulfonate ion, sulfate ion, perchlorate ion, carbonate ion, nitrate ion, BF4-, PF6-, Ph4B- and the like are described. In the case where the group having negative charge at carboxylate group and the like exists in a molecule, an inner salt may be formed with it. As a counter ion outside of a molecule, chloro ion, bromo ion and methanesulfonate ion are particularly preferable.

The preferred structure of the compound represented by Group 1 and 2 compound having a quaternary salt of nitrogen or phosphor as an adsorptive group is represented by formula (X).
(P-Q₁-)ᵢ—R(-Q₂-S)ⱼ Formula (X)

In formula (X), P and R each independently represent a quaternary salt structure of nitrogen or phosphor, which is not a partial structure of a spectral sensitizing dye. Q1 and Q2 each independently represent a connecting group and typically represent a single bond, an alkylene group, an arylene group, a heterocyclic group, —O—, —S—, —NRN, —C(═O)—, —SO2-, —SO—, —P(═O)— and the group which consists of combination of these groups. Herein, RN represents a hydrogen atom, an alkyl group, an aryl group or a heterocyclic group. S represents a residue which is obtained by removing one atom from the compound represented by Group 1 or 2. i and j are an integral number of one or more, and are selected in a range of i+j=2 to 6. It is preferred that i is 1, 2 or 3 and j is 1 or 2. It is more preferred that i is 1 or 2 and j is 1. And, it is particularly preferred that i is 1 and j is 1. The compound represented by formula (X) preferably has 10 to 100 carbon atoms in total, more preferably 10 to 70 carbon atoms, further preferably 11 to 60 carbon atoms, and particularly preferably 12 to 50 carbon atoms.

The compounds of Groups 1 and 2 may be used at any time during preparation of the photosensitive silver halide emulsion and production of the photothermographic material. For example, the compound may be used in a photosensitive silver halide grain formation step, in a desalting step, in a chemical sensitization step, and before coating, etc. The compound may be added in several times, during these steps. The compound is preferably added, after the photosensitive silver halide grain formation step and before the desalting step; in the chemical sensitization step just before the chemical sensitization to immediately after the chemical sensitization); or before coating. The compound is more preferably added, just before the chemical sensitization step to before mixing with the non-photosensitive organic silver salt.

It is preferred that the compound of Groups 1 and 2 used in the invention is dissolved in water, a water-soluble solvent such as methanol and ethanol, or a mixed solvent thereof, to be added. In the case where the compound is dissolved in water and solubility of the compound is increased by increasing or decreasing a pH value of the solvent, the pH value may be increased or decreased to dissolve and add the compound.

The compound of type 1 or type 2 in the present invention is preferably used in an image-forming layer that contains a photosensitive silver halide and a non-photosensitive organic silver salt. However, they may be added to a protective layer or an interlayer in addition to the image-forming layer that contains a photosensitive silver halide and a non-photosensitive organic silver salt, followed by diffusing during the coating. Irrespective of whether the timing of adding the compound may be before or after a sensitizing dye is added, an amount of the compound contained in a silver halide emulsion layer (image-forming layer) is preferably from 1×10⁻⁹ to 5×10⁻¹ mol, and more preferably from 1×10⁻⁸ to 5×10⁻² mol, per mol of silver halide.

10) Compound Having Adsorptive Group and Reducible Group

The photothermographic material of the present invention preferably comprises a compound having an adsorptive group and a reducible group in a molecule. It is preferred that the compound having an adsorptive group and a reducible group used in the invention is represented by the following formula (I).
A-(W)n-B Formula (I)

In formula (I), A represents a group capable of adsorption to a silver halide (hereafter, it is called an adsorptive group), W represents a divalent connecting group, n represents 0 or 1, and B represents a reducible group.

In formula (I), the adsorptive group represented by A is a group to adsorb directly to a silver halide or a group to promote adsorption to a silver halide. As typical examples, a mercapto group (or a salt thereof), a thione group (—C(═S)—), a nitrogen atom, a heterocyclic group containing at least one atom selected from a nitrogen atom, a sulfur atom, a selenium atom and a tellurium atom, a sulfide group, a disulfide group, a cationic group, an ethynyl group and the like are described.

As an adsorbent group, a mercapto group (or salt thereof) means a mercapto group as that and at the same time more preferably represents a heterocyclic group or an aryl group or an alkyl group substituted by at least one mercapto group (or salt thereof). Here, the heterocyclic group is a at least 5- to 7-membered, monocyclic or condensed, aromatic or nonaromatic heterocyclic group, and includes, as examples, an imidazole ring group, a thiazole ring group, an oxazole ring group, a benzimidazole ring group, a benzthiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group, and so on. The heterocyclic group that contains a quaternary nitrogen atom may be cited, and in this case, the substituted mercapto group may be dissociated into a mesoion. When the mercapto group forms a salt, a counter ion of the salt may be a cation such as an alkaline metal, an alkaline earth metal, a heavy metal and so on (Li⁺, Na⁺, K⁺, Mg²⁺, Ag⁺ and Zn²⁺); an ammonium ion; a heterocyclic group containing a quaternary nitrogen atom; a phosphonium ion; and so on.

Furthermore, the mercapto group used as the adsorbent group may be tautomerized into a thione group.

Specific examples of the thione group include a linear or cyclic thioamide group, a thiouredide group, a thiourethane group or a dithiocarbamic acid ester group.

The heterocyclic group that contains as the adsorbent group at least one atom selected from a nitrogen atom, a sulfur atom, a selenium atom and tellurium atom is a nitrogen-containing heterocyclic group having an —NH— group that can form a silver imide (>NAg) as a moiety of the heterocycle; or a heterocyclic group having an —S— group, an —Se— group, a —Te— group or an ═N— group, which can form a coordinate bond with a silver ion, as a moiety of the heterocycle. Examples of the former include a benzotriazole group, a triazole group, an indazole group, a pyrazole group, a tetrazole group, a benzimidazole group, an imidazole group, a purine group, and so on. Examples of the latter include a thiophene group, a thiazole group, an oxazole group, a benzothiophene group, a benzothiazole group, a benzoxazole group, a thiadiazole group, an oxadiazole group, a triazine group, a selenazole group, a benzselenazole group, a tellurazole group, a benztellurazole group and so on.

The sulfide group or disulfide group used as the adsorbent group may be any group with an —S— or —S—S— moiety.

The cationic group used as the adsorbent group is a quaternary nitrogen-containing group, specifically an ammonio group or a group containing a nitrogen-containing heterocyclic group containing a quaternary nitrogen. Examples of the quaternary nitrogen-containing heterocyclic group include a pyridinio group, a quinolinio group, an isoquinolinio group, an imidazolio group, and so on.

An ethynyl group used as the adsorbent group means a —C≡CH group, in which the hydrogen atom may be substituted.

The above-mentioned adsorbent groups may have an optional substituent.

Further, as typical examples of an adsorptive group, the compounds described in pages 4 to 7 in the specification of JP-A No. 11-95355 are described.

As an adsorptive group represented by A in formula (I), a heterocyclic group substituted by a mercapto group (e.g., a 2-mercaptothiadiazole group, a 2-mercapto-5-aminothiadiazole group, a 3-mercapto-1,2,4-triazole group, a 5-mercaptotetrazole group, a 2-mercapto-1,3,4-oxadiazole group, a 2-mercaptobenzimidazole group, a 1,5-dimethyl-1,2,4-triazorium-3-thiolate group, a 2,4-dimercaptopyrimidine group, a 2,4-dimercaptotriazine group, a 3,5-dimercapto-1,2,4-triazole group, a 2,5-dimercapto-1,3-thiazole group and the like) or a nitrogen atom containing heterocyclic group having a —NH— group capable to form an imino-silver (>NAg) as a partial structure of heterocycle (e.g., a benzotriazole group, a benzimidazole group, an indazole group and the like) is preferable, and more preferable as an adsorptive group is a 2-mercaptobenzimidazole group or a 3,5-dimercapto-1,2,4-triazole group.

In the formula (I), W represents a divalent connecting group. The connecting group is not particularly restricted as long as it does not adversely affect on the photographic characteristics. A divalent connecting group constituted of, for instance, a carbon atom, a hydrogen atom, an oxygen atom, a nitrogen atom, or a sulfur atom can be used. More specifically, an alkylene group with 1 to 20 carbon atoms (such as a methylene group, an ethylene group, a trimethylene group, a tetramethylene group or a hexamethylene group), an alkenylene group with 2 to 20 carbon atoms, an alkynylene group with 2 to 20 carbon atoms, an arylene group with 6 to 20 carbon atoms (such as a phenylene group or a naphthylene group), —CO—, —SO₂—, —O—, —S—, —NR₁— or combinations of these connecting groups can be cited. In the above, R₁ represents a hydrogen atom, an alkyl group, a heterocyclic group or an aryl group.

A connecting group represented with W may have an arbitrary substituent.

In formula (I), a reducible group represented by B represents the group capable to reduce a silver ion. As the examples, a formyl group, an amino group, a triple bond group such as an acetylene group, a propargyl group and the like, a mercapto group, hydroxylamines, hydroxamic acids, hydroxyureas, hydroxyurethanes, hydroxysemicarbazides, reductones (reductone derivatives are contained), anilines, phenols (chroman-6-ols, 2,3-dihydrobenzofuran-5-ols, aminophenols, sulfonamidophenols and polyphenols such as hydroquinones, catechols, resorcinols, benzenetriols, bisphenols are contained), aclhydrazines, carbamoylhydrazides and a residue which is obtained by removing one hydrogen atom from 3-pyrazolidones and the like can be described. They may have any substituent.

The oxidation potential of a reducible group represented by B in formula (I), can be measured by using the measuring method described in Akira Fujishima, “DENKIKAGAKU SOKUTEIHO”, pages 150 to 208, GIHODO SHUPPAN and NIHON KAGAKUKAI, “ZIKKEN KAGAKUKOUZA”, 4th ed., vol. 9, pages 282 to 344, MARUZEN. For example, the method of rotating disc voltammetry can be used; namely the sample is dissolved in the solution (methanol:pH 6.5 Britton-Britton-Robinson buffer=10%:90% (% by volume)) and after bubbling with nitrogen gas during 10 minutes the voltamograph can be measured under the condition of 1000 rotations/minute, the sweep rate 20 mV/second, at 25° C. by using a rotating disc electrode (RDE) made by glassy carbon as a working electrode, a platinum electrode as a counter electrode and a saturated calomel electrode as a reference electrode. The half wave potential (E1/2) can be calculated by that obtained voltamogram.

A reducing group represented with B in the invention, when measured according to the above-mentioned measurement method, preferably has an oxidation potential thereof in the range of substantially −0.3 to substantially 1.0 V, more preferably in the range of substantially −0.1 to substantially 0.8 V, and particularly preferably in the range of substantially 0 to substantially 0.7 V.

In formula (I), a reducible group represented by B preferably is hydroxylamines, hydroxamic acids, hydroxyureas, hydroxysemicarbazides, reductones, phenols, acylhydrazines, carbamoylhydrazides, or a residue which is obtained by removing one hydrogen atom from 3-pyrazolidones and the like.

The compound of formula (I) in the present invention may have the ballasted group or polymer chain in it generally used in the non-moving photographic additives as a coupler. And as a polymer, for example, the polymer described in JP-A No. 1-100530 can be described.

The compound of formula (I) in the present invention may be bis or tris type of compound. The molecular weight of the compound represented by formula (I) in the present invention is preferably 100 to 10,000 and more preferably 120 to 1,000 and particularly preferably 150 to 500.

The examples of the compound represented by formula (I) in the present invention are shown below, but the present invention is not limited in these.

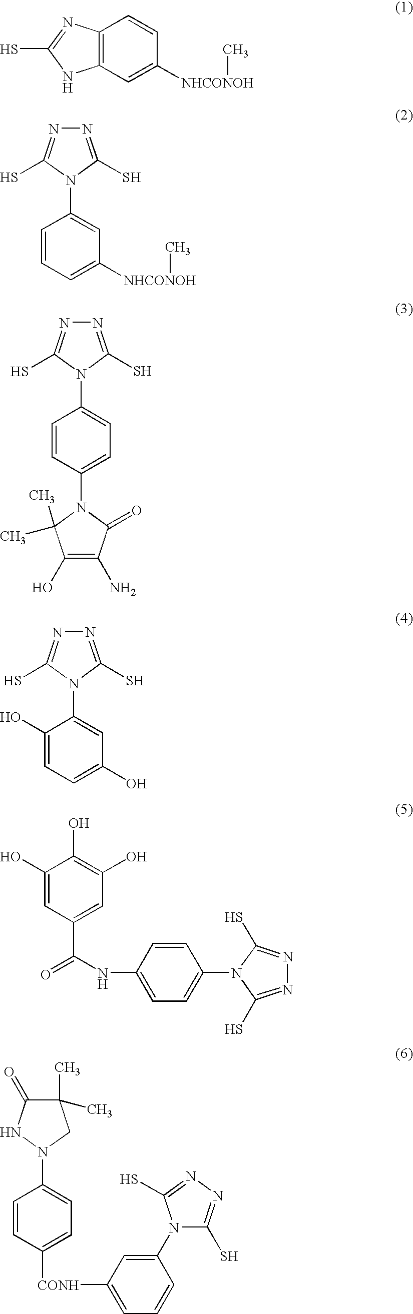

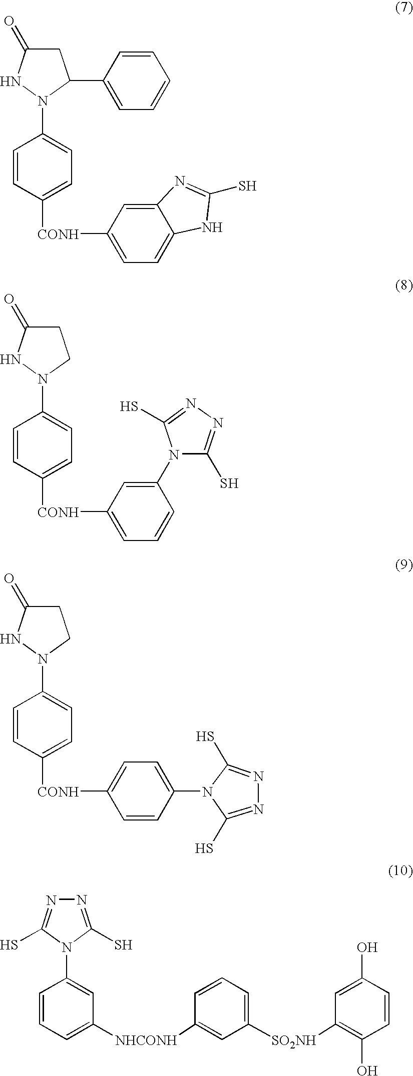

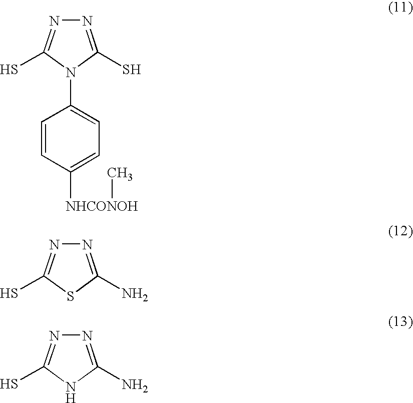

Furthermore, specific compounds 1 to 30 and 1″-1 to 1″-77 described in EP-A2 No. 1308776A2, 73 to 87 page as well can be preferably cited as compounds having an adsorbent group and a reducing group in the invention.

These compounds can be easily synthesized by the known method. The compound of formula (I) in the present invention can be used independently as only one compound, but it is preferred to use two compounds or more in combination. When two or more kinds of compounds are used in combination, those may be added to the same layer or the different layers, whereby adding methods may be different from each other.

The compound according to the formula (I) in the invention may be preferably added to a silver halide emulsion layer, and more preferably added during the preparation of the silver halide emulsion. When the compound is added during the preparation of the silver halide emulsion, the compound may be added in any stage thereof, for example in a step of forming silver halide grains, before the start of a desalting step, in a desalting step, before the start of a chemical ripening, in a step of chemical ripening, or a step before preparation of a completed emulsion. The compound may also be added divided into a plurality of times during such processes. The compound is preferably added to the image forming layer, however it may be added, in addition to the image forming layer, to a protective layer or an intermediate layer adjacent thereto, then allowed to diffuse during the coating.

A preferred amount of addition depends significantly on a manner of addition explained above and a kind of the compound that is added; however, with respect to 1 mol of photosensitive silver halide, it is generally 1×10⁻⁶ or more and 1 mol or less, preferably 1×10⁻⁵ or more and 5×10⁻¹ or less mol, and more preferably 1×10⁻⁴ or more and 1×10⁻¹ or less mol.

The compound represented by formula (I) in the present invention can be added by dissolving in water or water-soluble solvent such as methanol, ethanol and the like or a mixed solution thereof. At this time, pH may be arranged suitably by an acid or an alkaline and a surfactant can be coexisted. Further, these compounds may be added as an emulsified dispersion by dissolving them in an organic solvent having a high boiling point and also may be added as a solid dispersion.

11) Combined Use of Silver Halides

The photosensitive silver halide emulsion in the photothermographic material used in the invention may be used alone, or two or more kinds of them (for example, those of different average grain sizes, different halogen compositions, of different crystal habits and of different conditions for chemical sensitization) may be used together. Gradation can be controlled by using plural kinds of photosensitive silver halide of different sensitivity. The relevant techniques can include those described, for example, in JP-A Nos. 57-119341, 53-106125, 47-3929, 48-55730, 46-5187, 50-73627, and 57-150841. It is preferred to provide a sensitivity difference of 0.2 or more in terms of log E between each of the emulsions.

12) Mixing of Silver Halide and Organic Silver Salt

The photosensitive silver halide in the invention is particularly preferably formed under the absence of the non-photosensitive organic silver salt and chemically sensitized. This is because a sufficient sensitivity can not sometimes be attained by the method of forming the silver halide by adding a halogenating agent to the organic silver salt.

As a method of mixing the silver halide and the organic silver salt, a method in which separately prepared photosensitive silver halide and organic silver salt are mixed by means of a high-speed stirrer, a ball mill, a sand mill, a colloid mill, a vibration mill or a homogenizer or a method in which at any timing during the preparation of the organic silver salt already prepared photosensitive silver halide is mixed to prepare organic silver salt can be cited. Both of the methods can exhibit preferable effects in the invention.

13) Mixing of Silver Halide into Coating Solution

In the invention, the time of adding silver halide to the coating solution for the image forming layer is preferably in the range from 180 minutes before to just prior to the coating, more preferably, 60 minutes before to 10 seconds before coating. But there is no restriction for mixing method and mixing condition as far as the effect of the invention appears sufficient. As an embodiment of a mixing method, there is a method of mixing in the tank controlling the average residence time to be desired. The average residence time herein is calculated from addition flux and the amount of solution transferred to the coater. And another embodiment of mixing method is a method using a static mixer, which is described in 8th edition of “Ekitai kongou gijutsu” by N. Hamby and M. F. Edwards, translated by Kouji Takahashi (Nikkankougyou shinbunsya, 1989).

(Binder)

Any type of polymer may be used as the binder for the layer containing organic silver salt in the photothermographic material of the invention. Suitable as the binder are those that are transparent or translucent, and that are generally colorless, such as natural resin or polymer and their copolymers; synthetic resin or polymer and their copolymer; or media forming a film; for example, included are gelatin, rubber, poly(vinyl alcohol), hydroxyethyl cellulose, cellulose acetate, cellulose acetate butyrate, poly (vinyl pyrrolidone), casein, starch, poly(acrylic acid), poly(methylmethacrylic acid), poly(vinyl chloride), poly(methacrylic acid), styrene-maleic anhydride copolymers, styrene-acrylonitrile copolymers, styrene-butadiene copolymers, poly(vinyl acetal)(e.g., poly(vinyl formal) and poly(vinyl butyral)), poly(ester), poly(urethane), phenoxy resin, poly(vinylidene chloride), poly(epoxide), poly(carbonate), poly(vinyl acetate), poly(olefin), cellulose esters, and poly(amide). A binder may be used with water, an organic solvent or emulsion to form a coating solution.

In the invention, the glass transition temperature (Tg) of a binder used in the image forming layer is preferably −10 degrees centigrade or more and 70 degrees centigrade or less, and more preferably in the range of 5 to 35 degrees centigrade.

In the specification, Tg is calculated according to the following equation.
1/Tg=Σ(Xi/Tgi)

Now, it is assumed that, in a polymer, n monomer components from i=1 to n are copolymerized. Xi denotes a mass fraction of the i-th monomer (ΣXi=1) and Tgi denotes the glass transition temperature (absolute temperature) of a single polymer of the i-th monomer. Here, Σ means an operation of summing up from i=1 to n. A value of the glass transition temperature (Tgi) of a single polymer of each monomer is adopted from values described in Polymer Handbook (3^{rd} Edition) written by J. Brandrup and E. H. Immergut (Wiley-Interscience, 1989).

The polymer used for the binder maybe of two or more kinds of polymers, if necessary. And, the polymer having Tg 20° C. or more and the polymer having Tg less than 20° C. can be used in combination. In a case where two types or more of polymers differing in Tg may be blended for use, it is preferred that the weight-average Tg is in the range mentioned above.

In the invention, it is preferred that the layer containing organic silver salt is formed by first applying a coating solution containing 30% by mass or more of water in the solvent and by then drying.

In the invention, when a layer containing organic silver salt is formed by first applying a coating solution containing 30 mass percent or more of water in a solvent followed by drying, and furthermore, when a binder of the layer containing organic silver salt is soluble or dispersible in an aqueous solvent (water solvent), the performance can be improved particularly in the case where a polymer latex having an equilibrium water content of 2 mass percent or less at 25 degrees centigrade and 60 percent RH is used. Most preferable embodiment is one that is prepared so that the ionic conductivity may be 2.5 mS/cm or lower, and as such a preparation method, a refining treatment using a separation membrane after the polymer is synthesized can be cited.

The term “equilibrium water content under 25° C. and 60% RH” as referred herein can be expressed as follows:

$$Equilibrium water content under 25 ° C . and 60 \% RH = [ ( W1 - W0 ) / W0 ] \times 100 ( \% by mass )$$

wherein, W1 is the weight of the polymer in moisture-controlled equilibrium under the atmosphere of 25° C. and 60% RH, and W0 is the absolutely dried mass at 25° C. of the polymer.

For the definition and the method of measurement of the water content, reference can be made to Polymer Engineering Series 14, “Testing methods for polymeric materials” (The Society of Polymer Science, Japan, published by Chijin Shokan).

The equilibrium water content at 25 degrees centigrade and 60 percent RH is preferably 2 mass percent or less, more preferably, 0.01 mass percent or more and 1.5 mass percent or less, and most preferably, 0.02 mass percent or more and 1 mass percent or less.

The binders used in the invention are, particularly preferably, polymers capable of being dispersed in aqueous solvent. Examples of dispersed states may include a latex, in which water-insoluble fine particles of hydrophobic polymer are dispersed, and such in which polymer molecules are dispersed in molecular states or by forming micelles, but preferred are latex-dispersed particles. The average particle size of the dispersed particles is in the range from 1 nm to 50,000 nm, preferably 5 nm to 1,000 nm, more preferably 10 nm to 500 nm, and further preferably 50 nm to 200 nm. There is no particular limitation concerning particle size distribution of the dispersed particles, and may be widely distributed or may exhibit a monodisperse particle size distribution. From the viewpoint of controlling the physical properties of the coating solution, preferred mode of usage includes mixing two or more types of particles each having monodisperse particle distribution.

In the invention, as preferred embodiments of the polymers capable of being dispersed in aqueous solvents, hydrophobic polymers such as acrylic polymers, poly(ester), rubbers (such as SBR resin), poly(urethane), poly(vinyl chloride), poly(vinyl acetate), poly(vinylidene chloride), and poly(olefin) can be preferably used. As the polymers above, straight chain polymers, branched polymers, or crosslinked polymers may be used; and the so-called homopolymers in which single monomers are polymerized, or copolymers in which two or more types of monomers are polymerized may be used. In the case of the copolymer, it may be a random copolymer or a block copolymer. The molecular weight of these polymers is, in terms of the number average molecular weight, in the range from 5,000 to 1,000,000, preferably from 10,000 to 200,000. Those having too small molecular weight exhibit insufficient mechanical strength of an image formation layer, and those having too large molecular weight are not preferred because the filming properties result poor. Furthermore, crosslinking polymer latexes can be particularly preferably used.

Fifty mass percent or more of the binder of the image forming layer in the invention is preferably a polymer latex that has, as a monomer component, 10 mass percent or more and 70 mass percent or less of butadiene.

More preferably, it is a polymer latex that has 1 mass percent or more and 20 mass percent or less of a monomer component having an acid group.

<Specific Examples of Latex>

Specific examples of preferred polymer latex are given below, which are expressed by the starting monomers with % by weight given in parenthesis. The molecular weight is given in number average molecular weight. In the case polyfunctional monomer is used, the concept of molecular weight is not applicable because they build a crosslinked structure. Hence, they are denoted as “crosslinking”, and the molecular weight is omitted.
P-1; Latex of -MMA(70)-EA(27)-MAA(3)-(molecular weight 37,000, Tg 61 degrees centigrade)
P-2; Latex of -MMA(70)-2EHA(20)-St(5)-AA(5)-(molecular weight 40,000, Tg 59 degrees centigrade)
P-3; Latex of -St(50)-Bu(47)-MAA(3)-(crosslinkable, Tg −17 degrees centigrade)
P-4; Latex of -St(68)-Bu(29)-AA(3)-(crosslinkable, Tg 17 degrees centigrade)
P-5; Latex of -St(71)-Bu(26)-AA(3)-(crosslinkable, Tg 24 degrees centigrade)
P-6; Latex of -St(70)-Bu(27)-IA(3)-(crosslinkable)
P-7; Latex of -St(75)-Bu(24)-AA(1)-(crosslinkable, Tg 29 degrees centigrade)
P-8; Latex of -St(60)-Bu(35)-DVB(3)-MAA(2)-(crosslinkable)
P-9; Latex of -St(70)-Bu(25)-DVB(2)-AA(3)-(crosslinkable)
P-10; Latex of -VC(50)-MMA(20)-EA(20)-AN(5)-AA(5)-(molecular weight 80,000)
P-11; Latex of -VDC(85)-MMA(5)-EA(5)-MAA(5)-(molecular weight 67,000)
P-12; Latex of -Et(90)-MAA(10)-(molecular weight 12000)
P-13; Latex of -St(70)-2EHA(27)-AA(3)-(molecular weight 130,000, Tg 43 degrees centigrade)
P-14; Latex of -MMA(63)-EA(35)-AA(2)-(molecular weight 33,000, Tg 47 degrees centigrade)
P-15; Latex of -St(70.5)-Bu(26.5)-AA(3)-(crosslinkable, Tg 23 degrees centigrade)
P-16; Latex of-St(69.5)-Bu(27.5)-AA(3)-(crosslinkable, Tg 20.5 degrees centigrade)

In the structures above, abbreviations represent monomers as follows. MMA: methyl metacrylate, EA: ethyl acrylate, MAA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, IA: itaconic acid.

The polymer latexes above are commercially available, and polymers below are usable. As examples of acrylic polymers, there can be mentioned Cevian A-4635, 4718, and 4601 (all manufactured by Daicel Chemical Industries, Ltd.), Nipol Lx811, 814, 821, 820, and 857 (all manufactured by Nippon Zeon Co., Ltd.), and the like; as examples of poly(ester), there can be mentioned FINETEX ES650, 611, 675, and 850 (all manufactured by Dainippon Ink and Chemicals, Inc.), WD-size and WMS (all manufactured by Eastman Chemical Co.), and the like; as examples of poly(urethane), there can be mentioned HYDRAN AP10, 20, 30, and 40 (all manufactured by Dainippon Ink and Chemicals, Inc.), and the like; as examples of rubber, there can be mentioned LACSTAR 7310K, 3307B, 4700H, and 7132C (all manufactured by Dainippon Ink and Chemicals, Inc.), Nipol Lx416, 410, 438C, and 2507 (all manufactured by Nippon Zeon Co., Ltd.), and the like; as examples of poly(vinyl chloride), there can be mentioned G351 and G576 (all manufactured by Nippon Zeon Co., Ltd.), and the like; as examples of poly(vinylidene chloride), there can be mentioned L502 and L513 (all manufactured by Asahi Chemical Industry Co., Ltd.), and the like; as examples of poly(olefin), there can be mentioned Chemipearl S120 and SA100 (all manufactured by Mitsui Petrochemical Industries, Ltd.), and the like.

The polymer latexes above may be used alone, or may be used by blending two types or more depending on needs.

<Preferable Latex>

Particularly preferable as the polymer latex for use in the invention is that of styrene-butadiene copolymer. The mass ratio of monomer unit for styrene to that of butadiene constituting the styrene-butadiene copolymer is preferably in the range from 40:60 to 95:5. Further, the monomer unit of styrene and that of butadiene preferably account for 60% by mass to 99% by mass with respect to the copolymer. Moreover, the polymer latex of the invention contains acrylic acid or methacrylic acid, preferably, in the range from 1% by mass to 6% by mass, and more preferably, from 2% by mass to 5% by mass, with respect to the total mass of the monomer unit of styrene and that of butadiene. The preferred range of the molecular weight is similar to that described above.

Furthermore, the polymer latex according to the invention preferably contains acrylic acid or methacrylic acid, with respect to the total weight of styrene and butadiene, in the range from 1 to 6 mass percent, and more preferably, from 2 to 5 mass percent. The polymer latex according to the invention preferably contains acrylic acid.

As the latex of styrene-butadiene copolymer preferably used in the invention, P-3 to P-8 and P-15 mentioned above, or commercially available LACSTAR-3307B, 7132C, Nipol Lx416, and the like can be cited.

In the layer containing organic silver salt of the photothermographic material according to the invention, if necessary, there can be added hydrophilic polymers such as gelatin, polyvinyl alcohol, methyl cellulose, hydroxypropyl cellulose, carboxymethyl cellulose, and the like. The hydrophilic polymers above are added at an amount of 30% by mass or less, preferably 20% by mass or less, with respect to the total weight of the binder incorporated in the layer containing organic silver salt.

According to the invention, the layer containing organic silver salt (image forming layer) is preferably formed by using polymer latex for the binder. According to the amount of the binder for the layer containing organic silver salt, the mass ratio for total binder to organic silver salt (total binder/organic silver salt) is preferably in the range of 1/10 to 10/1, more preferably 1/3 to 5/1, and further preferably 1/1 to 3/1.

The layer containing organic silver salt is, in general, a photosensitive layer (image forming layer) containing a photosensitive silver halide, i.e., the photosensitive silver salt; in such a case, the mass ratio for total binder to silver halide (total binder/silver halide) is in the range from 400 to 5, more preferably, from 200 to 10.

The total amount of binder in the image forming layer of the invention is preferably in the range from 0.2 g/m² to 30 g/m², more preferably from 1 g/m² to 15 g/m², and further preferably from 2 g/m² to 10 g/m². As for the image forming layer of the invention, there may be added a crosslinking agent for crosslinking, or a surfactant and the like to improve coating properties.

<Preferable Solvent for Coating Solution>

In the invention, a solvent of a coating solution for a layer containing organic silver salt (wherein a solvent and water are collectively described as a solvent for simplicity) is preferably an aqueous solvent containing water at 30% by mass or more. Examples of solvents other than water may include any of water-miscible organic solvents such as methyl alcohol, ethyl alcohol, isopropyl alcohol, methyl cellosolve, ethyl cellosolve, dimethylformamide and ethyl acetate. A water content in a solvent is more preferably 50% by mass or more and still more preferably 70% by mass or more. Concrete examples of a preferable solvent composition, in addition to water=100, are compositions in which methyl alcohol is contained at ratios of water/methyl alcohol=90/10 and 70/30, in which dimethylformamide is further contained at a ratio of water/methyl alcohol/dimethylformamide=80/15/5, in which ethyl cellosolve is further contained at a ratio of water/methyl alcohol/ethyl cellosolve=85/10/5, and in which isopropyl alcohol is further contained at a ratio of water/methyl alcohol/isopropyl alcohol=85/10/5 (wherein the numerals presented above are values in % by mass).

(Antifogging Agent)

As anti-fogging agents, stabilizers, and stabilizer precursors that can be used in the invention, ones described in paragraph No. 0070 of JP-A NO. 10-62899, and from page 20, line 57 to page 21, line 7 of EP-A No. 0803764, the compounds described in JP-A Nos. 09-281637 and 09-329864, and the compounds described in U.S. Pat. Nos. 6,083,681 and EP No. 1048975 can be cited. The anti-fogging agents preferably used in the invention are organic halides. As to these, ones disclosed in paragraph Nos. 0111 to 0112 of JP-A No. 11-65021 can be cited. Organic halogen compounds represented by formula (P) in JP-A No. 2000-284399, organic polyhalogen compounds represented by formula (II) in JP-A No. 10-339934, and organic polyhalogen compounds described in JP-A Nos. 2001-31644 and 2001-33911 are particularly preferable.

1) Organic Polyhalogen Compound

Organic polyhalogen compounds preferably used in the invention are specifically described below. In the invention, preferred polyhalogen compounds are the compounds expressed by formula (H) below:
Q-(Y)n-C(Z₁)(Z₂)X Formula (H)

In the formula (H), Q represents an alkyl group, an aryl group, or a heterocyclic group; Y represents a bivalent connecting group; n denotes 0 or 1; Z₁ and Z₂ represent a halogen atom; and X represents a hydrogen atom or an electron attracting group.

In the formula (H), Q is preferably an aryl group or a heterocyclic group.

In the formula (H), when the Q is a heterocyclic group, a nitrogen-containing heterocyclic group having one or two nitrogen atoms is preferred, and a 2-pyridyl group or a 2-quinolyl group are particularly preferable.

In the formula (H), when the Q is an aryl group, the Q represents a phenyl group that is substituted by an electron-attracting group of which Hammet's substituent constant σp takes a positive value. With regard to the Hammett's substituent constant, Journal of Medicinal Chemistry, 1973, Vol. 16, No. 11, pp. 1207 to 1216, or the like can serve as a reference. Examples of such an electron attracting group include: a halogen atom (a fluorine atom (σp value: 0.06), a chlorine atom (σp value: 0.23), a bromine atom (σp value: 0.23), and an iodine atom (σp value: 0.18)); a trihalomethyl group (tribromomethyl (σp value: 0.29), trichloromethyl (σp value: 0.33), and trifluoromethyl (σp value: 0.54)); a cyano group (σp value: 0.66); a nitro group (σp value: 0.78); an aliphatic-aryl or heterocyclic sulfonyl group (such as methanesulfonyl (σp value: 0.72)), an aliphatic-aryl or heterocyclic acyl group (such as acetyl (σp value: 0.50), benzoyl (σp value: 0.43), an alkynyl group (such as C≡CH (σp value: 0.23)); an aliphatic-aryl or heterocyclic oxycarbonyl group (such as methoxycarbonyl (σp value: 0.45) and phenoxycarbonyl (σp value: 0.44)); a carbamoyl group (σup value: 0.36); a sulfamoyl group (σp value: 0.57); a sulfoxide group; a heterocyclic group; and a phosphoryl group. The σp value is preferably in the range from 0.2 to 2.0, and more preferably in the range from 0.4 to 1.0. Particularly preferred electron attracting groups are a carbamoyl group, an alkoxycarbonyl group, an alkylsulfonyl group, and an alkylphosphoryl group. Among these, a carbamoyl group is most preferred.

X is preferably an electron attracting group, more preferably a halogen atom, an aliphatic-aryl or heterocyclic sulfonyl group, an aliphatic-aryl or heterocyclic acyl group, an aliphatic-aryl or heterocyclic oxycarbonyl group, a carbamoyl group, or a sulfamoyl group, and most preferably a halogen atom. Among the halogen atoms, a chlorine atom, a bromine atom, and an iodine atom are preferred, a chlorine atom and a bromine atom are more preferred, and a bromine atom is particularly preferred.

Y preferably represents —C(═O)—, —SO—, or —SO₂—, more preferably —C(═O)— or —SO₂—, and in particular preferably —SO₂—. n denotes 0 or 1, and preferably 1.

Specific examples of the compound expressed by formula (H) of the invention are shown below.

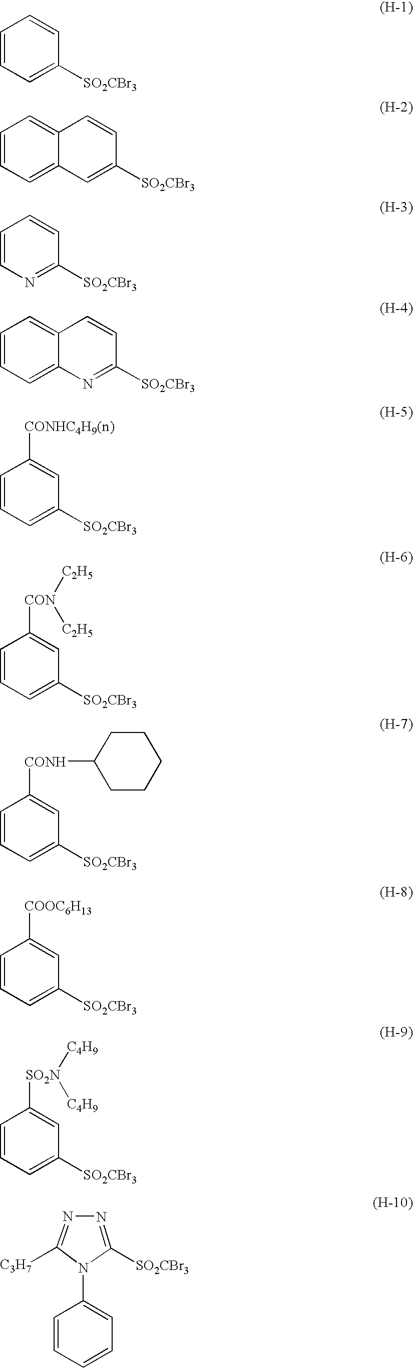

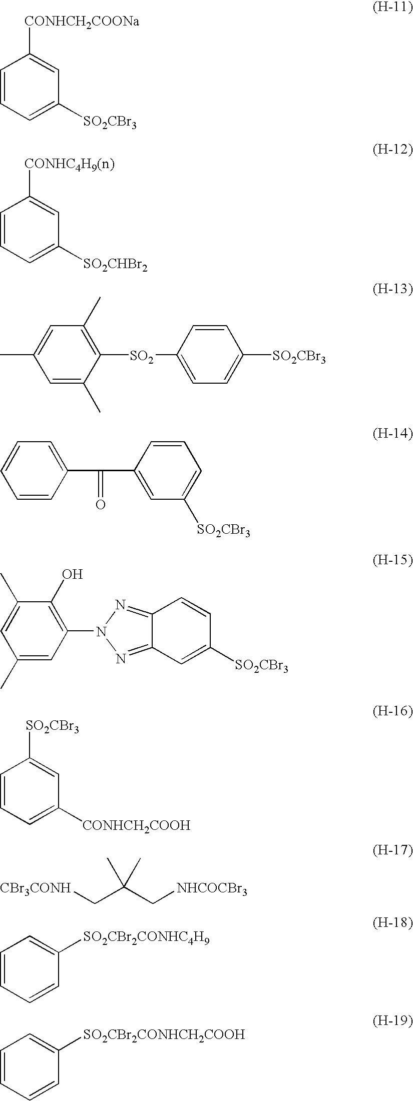

As the preferred polyhalogen compounds of the invention other than the above-described ones, compounds described in JP-A Nos. 2001-31644, 2001-56526, and 2001-209145 can be cited.

The compound represented by the general formula (H) in the invention is preferably used, with respect to one mole of the non-photosensitive silver salt in the image-forming layer, in the range of 10⁻⁴ to 1 mol, more preferably in the range of 10⁻³ to 0.5 mol, and furthermore preferably in the range of 1×10⁻² mol to 0.2 mol.

In the invention, as a method for incorporating an anti-fogging agent into a photosensitive material, the methods described in connection with the incorporation method of the reducing agent can be cited. Also for the organic polyhalogen compound, it is preferably added in the form of a solid fine particle dispersion.

2) Other Anti-Fogging Agents

As other antifoggants, there can be mentioned a mercury (II) salt described in paragraph number 0113 of JP-A No. 11-65021, benzoic acids described in paragraph number 0114 of the same literature, a salicylic acid derivative described in JP-A No. 2000-206642, a formaline scavenger compound expressed by formula (S) in JP-A No. 2000-221634, a triazine compound related to Claim 9 of JP-A No. 11-352624, a compound expressed by general formula (III), 4-hydroxy-6-methyl-1,3,3a, 7-tetrazaindene and the like, as described in JP-A No. 6-11791.

The photothermographic material in the invention may contain an azolium salt with the intention of inhibiting fogging from occurring. As the azolium salts, compounds represented by a general formula (XI) described in JP-A No. 59-193447, compounds described in JP-B No. 55-12581, and compounds represented by a general formula (II) described in JP-A No. 60-153039 can be cited. The azolium salt may be added to the photosensitive material at any site. As a layer to which the salt is added, the azolium salt is preferably added to a layer on a surface that has a photosensitive layer, and more preferably added to an organic silver salt-containing layer. The timing of adding the azolium salt may be any one during steps of the preparation of a coating solution. When the azolium salt is added to the organic silver salt-containing layer, the timing may be any one during steps between preparation of the organic silver salt and preparation of the coating solution, and it is preferably from after the preparation of the organic silver salt up to immediately before coating. The azolium salt may be added by any process in which it is added in the form of powder, a solution, a fine particle dispersion, or the like. Alternatively, it may also be added as a solution mixed with other additives such as a sensitizing dye, a reducing agent, and a color-toning agent. An amount of the azolium salt added in the invention may be any amount; however, it is preferably 1×10⁻⁶ mol or more and 2 mol or less, and more preferably 1×10⁻³ mol or more and 0.5 mol or less per mol of silver.

(Other Additives)

1) Mercapto, Disulfide, and Thiones

The photothermographic material of the invention may contain a mercapto compound, a disulfide compound, or a thione compound in order to decelerate or accelerate development to control the development, to enhance the spectral sensitization efficiency, to improve the storage stability before and after development, or for other purposes. Examples thereof include compounds disclosed in paragraph Nos. 0067 to 0069 of JP-A No. 10-62899; compounds represented by formula (I), and specific examples thereof described in paragraph Nos. 0033 to 0052 of JP-A No. 10-186572; and those described on page 20, lines 36 to 56 of EP-A No. 0803764A1. Among these, mercapto-substituted heterocyclic aromatic compounds described in JP-A Nos. 09-297363, 09-304875, 2001-100358, and Japanese Patent Application Nos. 2001-104213 and 2001-104214 are preferable.

2) Color Toning Agent

In the photothermographic material according to the invention, it is preferable to add a color-toning agent. The color toning agent is described in paragraph Nos. 0054 to 0055 of JP-A No. 10-62899, on page 21, lines 23 to 48 of EP-A No. 0803764A1, JP-A Nos. 2000-356317 and 2000-187298. In particular, phthalazinones (phthalazinone, phthalazinone derivatives or metal salts thereof; such as 4-(1-naphthyl)phthalazinone, 6-chlorophthalazinone, 5,7-dimethoxyphthalazinone, and 2,3-dihydro-1,4-phthalazinedione); combinations of phthalazinones and phthalic acids (such as phthalic acid, 4-methylphthalic acid, 4-nitrophthalic acid, diammonium phthalate, sodium phthalate, potassium phthalate, and tetrachlorophthalic anhydride); phthalazines (phthalazine, phthalazine derivatives, or metal salts thereof, such as 4-(1-naphthyl) phthalazine, 6-isopropyl phthalazine, 6-t-butyl phthalazine, 6-chlorophthalazine, 5,7-dimethoxy phthalazine, and 2,3-dihydrophthalazine); and combinations of phthalazines and phthalic acids are preferable. Particularly, combinations of phthalazines and phthalic acids are preferred. Among these, a particularly preferred combination is a combination of 6-isopropyl phthalazine and phthalic acid or 4-methylphthalic acid.

3) Plasticizer and Lubricant

Plasticizers and lubricants usable in the photothermographic material of the invention are described in paragraph No. 0117 of JP-A No. 11-65021. Lubricants are described in paragraph Nos. 0061 to 0064 of JP-A No. 11-84573.

4) Dyes and Pigments

From the viewpoint of improving image tone, preventing the generation of interference fringes and preventing irradiation on laser exposure, various types of dyes and pigments (for instance, C.I. Pigment Blue 60, C.I. Pigment Blue 64, and C.I. Pigment Blue 15:6) may be used in the image forming layer of the invention. Detailed description can be found in WO No. 98/36322, JP-A Nos. 10-268465 and 11-338098, and the like.

5) Nucleating Agent

For the photothermographic material in the invention, a nucleating agent is preferably added to the image-forming layer. The nucleating agent, the addition method and the addition amount thereof are described as compounds of formula (H), formulae (1) to (3), and formulae (A) and (B) in the specifications of JP-A No. 11-65021, column No. 0118, JP-A No. 11-223898, in column Nos. 0136 to 0193, JP-A No. 2000-284399, as compounds of formula (III) to (V) described in the specification of JP-A 2000-347345, and as nucleation promoting agents in JP-A No. 11-65021, in column No. 0102, and JP-A No. 11-223898, in column Nos. 0194 to 0195.

In the case of using formic acid or formates as a strong fogging agent, it is preferably incorporated into the side having thereon the image forming layer containing photosensitive silver halide, at an amount of 5 mmol or less, preferably, 1 mmol or less per one mol of silver.

When a nucleating agent is used in the photothermographic material of the invention, an acid formed by hydration of diphosphorus pentoxide or a salt thereof is preferably used in combination. Examples of the acid formed by hydration of diphosphorus pentoxide or a salt thereof may include metaphosphoric acid (salt), pyrophosphoric acid (salt), orthophosphoric acid (salt), triphosphoric acid (salt), tetraphosphoric acid (salt), and hexametaphosphoric acid (salt). Examples of acids that are formed by hydration of diphosphorus pentoxide or salts thereof and can be particularly preferably used may include orthophosphoric acid (salt) and hexametaphosphoric acid (salt). Specific examples of the salt include sodium orthophosphate, sodium dihydrogen orthophosphate, sodium hexametaphosphate, and ammonium hexametaphosphate.

An amount of the acid formed by hydration of diphosphorus pentoxide or a salt thereof added (a coating amount per square meter of the photosensitive material) may be a desired amount according to the performances including sensitivity, fog, and the like. However, it is preferably in the range of 0.1 to 500 mg/m², and more preferably 0.5 to 100 mg/m².

(Preparation of Coating Solution and Coating)

The temperature for preparing the coating solution for the image forming layer of the invention is preferably from 30° C. to 65° C., more preferably, from 35° C. or more to less than 60° C., and further preferably, from 35° C. to 55° C. Furthermore, the temperature of the coating solution for the image forming layer immediately after adding the polymer latex is preferably maintained in the temperature range from 30° C. to 65° C.

(Layer Structure and Components)

In the invention, one or more image-forming layers are provided on the support. If one image-forming layer is provided on the support, the image-forming layer comprises the organic silver salt, the photosensitive silver halide, the reducing agent, and the binder, and optionally comprises additives such as the toning agent, the coating auxiliary, and another auxiliary agent. If two image-forming layers are provided on the support, the first image-forming layer, which is generally adjacent to the support, includes the organic silver salt and the photosensitive silver halide, and the other components are each independently included in the second image-forming layer or the both image-forming layers. In the case of using the photothermographic material of the invention as a multicolor photothermographic material, it may comprise the two layers for each color or comprise a single layer containing all the components as described in U.S. Pat. No. 4,708,928. In the multicolor photothermographic material, the emulsion layers are generally separated from one another by providing functional or non-functional barrier layers between the photosensitive layers as described in U.S. Pat. No. 4,460,681.

The photothermographic materials according to the invention may have non-photosensitive layers in addition to the image forming layer. The non-photosensitive layers can be classified according to their positions into (a) a surface protective layer formed on an image forming layer (most distant from a support); (b) an intermediate layer disposed between a plurality of image forming layers or between an image forming layer and a protective layer; (c) an undercoat layer disposed between the image forming layer and a support; and (d) a back layer disposed on a side opposite to the image forming layer.

Further, a filter layer, which acts as an optical filter, may be formed as the layer of (a) or (b). An antihalation layer may be provided as the layer of (c) or (d) in the photosensitive material.

1) Surface Protective Layer

The photothermographic material of the invention may further comprise a surface protective layer with an object to prevent adhesion of the image forming layer. The surface protective layer may be a single layer, or plural layers.

A surface protective layer is described in paragraph Nos. 0119 to 0120 of JP-A No. 11-65021 and in JP-A No. 2000-171936.

As a binder of the surface protective layer of the invention, gelatin is preferred; however, polyvinyl alcohol (PVA) or a combination thereof with gelatin can be also preferably used. As the gelatin that can be used, inert gelatin (such as Nitta gelatin 750), phthalated gelatin (such as Nitta gelatin 801), or the like can be used. As the PVA, ones described in paragraph Nos. 0009 to 0020 of JP-A No. 2000-171936 can be cited. Preferably, PVA-105 of a completely saponified product, PVA-205 and PVA-335 of partially saponified products, and MP-203 of modified polyvinyl alcohol (all are trade names from Kuraray Co., Ltd.), and the like can be cited. A coating amount (per square meter of the support) of polyvinyl alcohol of the protective layer (per one layer) is preferably 0.3 to 4.0 g/m², and more preferably 0.3 to 2.0 g/m².

A coating amount (per square meter of the support) of the whole binder (including a water-soluble polymer and a latex polymer) of the surface protective layer (per one layer) is preferably 0.3 to 5.0 g/m², and more preferably 0.3 to 2.0 g/m².

2) Antihalation Layer

The photothermographic material of the present invention may comprise an antihalation layer provided to the side farther from the light source with respect to the image forming layer.

Descriptions on the antihalation layer can be found in paragraph Nos. 0123 to 0124 of JP-A No. 11-65021, in JP-A Nos. 11-223898, 9-230531, 10-36695, 10-104779, 11-231457, 11-352625, 11-352626, and the like.

The antihalation layer contains an antihalation dye having the absorption in an exposure wavelength. When the exposure wavelength falls into an infrared region, an infrared-absorbing dye is desirably used. In such a case, the dye having no absorption in the visible region is preferred.

When the antihalation is achieved by use of a dye having the absorption in a visible region, it is preferably configured so that the color of the dye will not substantially remain after an image is formed; means for performing decolorizing with the heat from heat development are preferably used; and in particular, a heat decolorizable dye and a base precursor are preferably added to a non-photosensitive layer so that the layer may function as an antihalation layer. These techniques are described in JP-A No. 11-231457, and the like.

An amount of the decolorizable dye added is determined according to the intended purpose of the dye. In general, the dye is used in an amount such that the optical density (absorbance) measured at an intended wavelength is more than 0.1. The optical density is preferably 0.15 to 2, and more preferably 0.2 to 1. The amount of the dye used for obtaining such an optical density is generally substantially 0.001 to 1 g/m².

By decoloring the dye in such a manner, the optical density after thermal development can be lowered to 0.1 or lower. Two types or more of thermal bleaching dyes may be used in combination in a photothermographic material. Similarly, two types or more of base precursors may be used in combination.

In the heat decolorization by use of such a decolorizable dye and the base precursor, it is preferable to use a substance (such as diphenylsulfone, or 4-chlorophenyl (phenyl) sulfone) that can lower the melting point by 3 degrees centigrade or more when mixed with the base precursor such as described in JP-A No. 11-352626, 2-naphtyl benzoate, or the like, in combination, from the viewpoint of the heat decolorization property, and the like.

3) Back Layer

The back layer applicable to the invention is described in paragraph Nos. 0128 to 0130ofJP-A No. 11-65021.

In the invention, coloring matters having maximum absorption in the wavelength range from 300 nm to 450 nm may be added in order to improve color tone of developed silver images and a deterioration of the images during aging. Such coloring matters are described in, for example, JP-A Nos. 62-210458, 63-104046, 63-103235, 63-208846, 63-306436, 63-314535, 01-61745, 2001-100363, and the like.

Such a coloring agent is generally added in the range of 0.1 to 1 g/m². As a layer to which it is added, a back layer disposed on a side opposite to the photosensitive layer is preferred.

Dyes each having an absorption peak in the range of 580 to 680 nm is preferably used in order to control the base color tone. The dyes for this purpose are preferably azomethine type oil-soluble dyes described in JP-A Nos. 04-359967 and 04-359968, and phthalocyanine type water-soluble dyes described in JP-A No. 2002-96797, each having a small absorption intensity on a shorter wavelength side. The dyes for this purpose may be added to any of the layers. However, they are preferably added to the non-photosensitive layer on the emulsion surface side or on the back surface side.

The photothermographic material in the invention is preferably a so-called one-sided photosensitive material having at least one layer of a photosensitive layer containing a silver halide emulsion on one side of the support and having a back layer on the other side.

4) Matting Agent

In the invention, it is preferable to add a matting agent to improve the transportability. The matting agents are described in paragraph Nos. 0126 to 0127 of JP-A No. 11-65021. The matting agent is coated, in terms of a coating amount per square meter of the photosensitive material, in an amount of preferably 1 to 400 mg/m², and more preferably 5 to 300 mg/m².

In the invention, the matting agent may be shaped either into a definite form or in an indefinite form. However, it is preferably shaped in a definite form, and a spherical form is preferably employed. An average particle diameter thereof is preferably in the range of 0.5 to 10 μm, more preferably 1.0 to 8.0 μm, and furthermore preferably 2.0 to 6.0 μm. The variation coefficient of the size distribution is preferably 50 percent or less, more preferably 40 percent or less, and furthermore preferably 30 percent or less. Here, the variation coefficient denotes a value expressed as: [(standard deviation of particle diameter)/(average value of particle diameter)]×100. Furthermore, it is also preferable to use in combination two kinds of matting agents that have a small variation coefficient and a ratio of average particle diameters of more than 3.

Furthermore, any matting degree of the emulsion surface is acceptable so long as stardust defects are not caused. However, the Beck smoothness is preferably 30 sec or more and 2,000 sec or less, and particularly preferably 40 sec or more and 1,500 sec or less. The Beck smoothness can be determined with ease according to Japanese Industrial Standard (JIS) P8119: “Testing Method for Smoothness of Paper and Paperboard by Beck Tester” and TAPP1 Standard Method T479.

The matt degree of the back layer in the invention is preferably in the range of 1,200 seconds or less and 10 seconds or more; more preferably, 800 seconds or less and 20 seconds or more; and further preferably, 500 seconds or less and 40 seconds or more, as expressed by Beck smoothness.

In the invention, the matting agent is incorporated preferably in the outermost surface layer of the photothermographic material, a layer functioning as the outermost surface layer, or a layer near to the outer surface. And, the matting agent is preferably incorporated in a layer that functions as the so-called protective layer.

5) Polymer Latex

In the photothermographic material of the invention, it is preferred to incorporate polymer latex in the surface protective layer or in the back layer. As such polymer latexes, descriptions can be found in “Gousei Jushi Emulsion (Synthetic resin emulsion)” (Taira Okuda and Hiroshi Inagaki, Eds., published by Koubunshi Kankoukai (1978)), “Gousei Latex no Ouyou (Application of synthetic latex)” (Takaaki Sugimura, Yasuo Kataoka, Souichi Suzuki, and Keiji Kasahara, Eds., published by Koubunshi Kankoukai (1993)), and “Gousei Latex no Kagaku (Chemistry of synthetic latex)” (Souichi Muroi, published by Koubunshi Kankoukai (1970)). More specifically, there can be mentioned a latex of methyl methacrylate (33.5% by weight)/ethyl acrylate (50% by weight)/methacrylic acid (16.5% by weight) copolymer, a latex of methyl methacrylate (47.5% by weight)Ibutadiene (47.5% by weight)/itaconic acid (5% by weight) copolymer, a latex of ethyl acrylate/methacrylic acid copolymer, a latex of methyl methacrylate (58.9% by weight)/2-ethylhexyl methacrylate (25.4% by weight)/styrene (8.6% by weight)/2-hydroethyl methacrylate (5.1% by weight)/acrylic acid copolymer, a latex of methyl methacrylate (64.0% by weight)/styrene(9.0% by weight)/butyl acrylate (20.0% by weight)/2-hydroxyethyl methacrylate(5.0% by weight)/acrylic acid copolymer, and the like. Furthermore, as the binder for the surface protective layer, there can be applied the technology described in paragraph Nos. 0021 to 0025 of the specification of JP-A No. 2000-267226, and the technology described in paragraph Nos. 0023 to 0041 of the specification of JP-A No. 2000-19678. The polymer latex in the surface protective layer preferably is contained in an amount of 10% by weight to 90% by weight, particularly preferably, of 20% by weight to 80% by weight of the total weight of binder.

6) Film Surface pH

The surface pH of the photothermographic material according to the invention preferably yields a pH of 7.0 or lower, more preferably, 6.6 or lower, before thermal developing process. Although there is no particular restriction concerning the lower limit, the pH value is about 3, and the most preferred surface pH range is from 4 to 6.2. From the viewpoint of reducing the surface pH, it is preferred to use an organic acid such as phthalic acid derivative or a non-volatile acid such as sulfuric acid, or a volatile base such as ammonia for the adjustment of the surface pH. In particular, ammonia can be used favorably for the achievement of low surface pH, because it can easily vaporize to remove it before the coating step or before applying thermal development.

It is also preferred to use a non-volatile base such as sodium hydroxide, potassium hydroxide, lithium hydroxide, and the like, in combination with ammonia. The method of measuring surface pH value is described in paragraph No. 0123 of the specification of JP-A No. 2000-284399.

The process in which a nonvolatile base such as sodium hydroxide, potassium hydroxide, or lithium hydroxide and ammonia are used in combination is also preferably employed. Incidentally, a method for measuring the film surface pH is described in paragraph No. 0123 of JP-A No. 2000-284399.

7) Hardening Agent

A hardener can be used in each of the image forming layer, the protective layer, the back layer, and the like. As examples of the hardener, descriptions of various methods can be found in pages 77 to 87 of T. H. James, “THE THEORY OF THE PHOTOGRAPHIC PROCESS, FOURTH EDITION” (Macmillan Publishing Co., Inc., 1977). Preferably used are, in addition to chromium alum, sodium salt of 2,4-dichloro-6-hydroxy-s-triazine, N,N-ethylene bis(vinylsulfonacetamide), and N,N-propylene bis(vinylsulfonacetamide), polyvalent metal ions described in page 78 of the above literature and the like, polyisocyanates described in U.S. Pat. No. 4,281,060, JP-A No. 6-208193 and the like, epoxy compounds of U.S. Pat. No. 4,791,042 and the like, and vinyl sulfone based compounds of JP-A No. 62-89048.

The hardener is added as a solution, and the solution is added to the coating solution for forming the protective layer 180 minutes before coating to just before coating, preferably 60 minutes before to 10 seconds before coating. However, so long as the effect of the invention is sufficiently exhibited, there is no particular restriction concerning the mixing method and the conditions of mixing. As specific mixing methods, there can be mentioned a method of mixing in the tank, in which the average stay time calculated from the flow rate of addition and the feed rate to the coater is controlled to yield a desired time, or a method using static mixer as described in Chapter 8 of N. Hamby, M.F. Edwards, A.W. Nienow (translated by Koji Takahashi) “Liquid Mixing Technology” (Nikkan Kogyo Shinbun, 1989), and the like.

8) Surfactant

As the surfactant for use in the invention, the solvent, the support, antistatic agent or the electrically conductive layer, and the method for obtaining color images applicable in the invention, there can be mentioned those disclosed in paragraph Nos. 0132, 0133, 0134, 0135, and 0136, respectively, of JP-A No. 11-65021. The lubricant is described in paragraph Nos. 0061 to 0064 of JP-A No. 11-84573 and paragraph Nos. 0049 to 0062 of Japanese Patent Application No. 11-106881.

In the invention, a fluorinated surfactant is preferably used. As specific examples of the fluorinated surfactant, compounds described in JP-A Nos. 10-197985, 2000-19680, and 2000-214554 can be cited. Furthermore, polymer fluorinated surfactants described in JP-A No. 09-281636 can be also preferably used. In the photothermographic material of the invention, the fluorinated surfactants described in JP-A No. 2002-82411 and Japanese Patent Application Nos. 2001-242357 and 2001-264110 can be preferably used. In particular, fluorinated surfactants described in Japanese Patent Application Nos. 2001-242357 and 2001-264110 are most preferred in terms of the charging control ability, the stability of the coated surface conditions, and the slipping property when an aqueous coating solution is applied to produce. The fluorinated surfactants described in Japanese patent Application No. 2001-264110 are most preferred in terms of its high charging control ability and a smaller required amount.

In the invention, the fluorinated surfactant can be used on either of the emulsion surface and the back surface, and preferably used on both the surfaces. Furthermore, it is in particular preferably used in combination with the above-described conductive layer containing the metal oxide. In this case, even when an amount of the fluorinated surfactant used on a surface having the conductive layer is reduced or eliminated, it is possible to obtain satisfactory performances.

The fluorinated surfactant is preferably used in the range of 0.1 to 100 mg/m², more preferably in the range of 0.3 to 30 mg/m², and furthermore preferably in the range of 1 to 10 mg/m² for both the emulsion surface and the back surface. In particular, the fluorinated surfactants described in Japanese Patent Application No. 2001-264110 are large in effect, so that each of them is preferably used in the range of 0.01 to 10 mg/m², and more preferably in the range of 0.1 to 5 mg/m².

9) Antistatic Agent

The photothermographic material of the invention preferably contains an electrically conductive layer including metal oxides or electrically conductive polymers. The antistatic layer may serve as an undercoat layer, or a back surface protective layer, and the like, but can also be placed specially. As an electrically conductive material of the antistatic layer, metal oxides having enhanced electric conductivity by the method of introducing oxygen defects or different types of metallic atoms into the metal oxides are preferably for use. Examples of metal oxides are preferably selected from ZnO, TiO2 and SnO2. As the combination of different types of atoms, preferred are ZnO combined with Al, In; SnO2 with Sb, Nb, P, halogen atoms, and the like; TiO2 with Nb, Ta, and the like; Particularly preferred for use is SnO2 combined with Sb. The addition amount of different types of atoms is preferably in the range from 0.01 mol % to 30 mol %, and particularly preferably, in the range from 0.1 mol % to 10 mol %. The shape of the metal oxides can include, for example, spherical, needle-like, or tabular shape. The needle-like particles, with the rate of (the major axis)/(the minor axis) is 2.0 or more, and more preferably, 3.0 to 50, is preferred viewed from the standpoint of the electric conductivity effect. The metal oxides is used preferably in the range from 1 mg/m2 to 1000 mg/m², more preferably from 10 mg/m² to 500 mg/m², and further preferably from 20 mg/m² to 200 mg/m². The antistatic layer can be laid on either side of the image forming layer side or the back layer side, it is preferred to set between the support and the back layer. Examples of the antistatic layer in the invention include described in JP-A Nos. 11-65021, 56-143430, 56-143431, 58-62646, and 56-120519, and in paragraph Nos. 0040 to 0051 of JP-A No. 11-84573, U.S. Pat. No. 5,575,957, and in paragraph Nos. 0078 to 0084 of JP-A No. 11-223898.

10) Support

For a transparent support, in order to relax the internal stress remaining in a film during the biaxial stretching to eliminate the thermal shrinkage occurring during the heat development, polyester, in particular, polyethylene terephthalate, subjected to a heat treatment at a temperature in the range of 130 to 185 degrees centigrade is preferably used. As for the photothermographic material for medical use, the transparent support may be colored with a blue dye (such as Dye-1 described in Example of JP-A No. 08-240877), or may be colorless. To the support, undercoating techniques of water-soluble polyester described in JP-A No. 11-84574, a styrene-butadiene copolymer described in JP-A No. 10-186565, a vinylidene chloride copolymer described in JP-A No. 2000-39684 and paragraph Nos. 0063 to 0080 of Japanese Patent Application No. 11-106881, and the like can be preferably applied. The water content of the support is preferably 0.5 mass percent or less when the emulsion layer or the back layer is coated onto the support.

11) Other Additives

To the photothermographic material, an antioxidant, a stabilizer, a plasticizer, a UV absorber, or a coating aid may be further added. Various additives are added to either of the photosensitive layer or the non-photosensitive layer. With regard to these, WO 98/36322, EP-A No. 803764, and JP-A Nos. 10-186567 and 10-18568 can be referred.

12) Coating Method

The photothermographic material in the invention may be coated by use of any method. Specifically, various coating operations including extrusion coating, slide coating, curtain coating, dip coating, knife coating, flow coating, or extrusion coating that uses a hopper of the type described in U.S. Pat. No. 2,681,294 can be applied. Extrusion coating or slide coating described in LIQUID FILM COATING, written by Stephen F. Kistler, and Petert M. Schweizer, (published by CHAPMAN & HALL Co., Ltd., 1997), pp. 399 to 536 can be preferably used. In particular, the slide coating is preferably used. An example of the shape of a slide coater for use in the slide coating is shown in FIG. 11b.1 on page 427 of the same reference. If desired, two or more layers may be simultaneously formed by use of the method described in from page 399 to page 536 of the same reference, and the methods described in U.S. Pat. No. 2,761,791 and UKP No. 837,095. In the invention, particularly preferred coating methods are the methods described in JP-A Nos. 2001-194748, 2002-153808, 2002-153803, and 2002-182333.

The organic silver salt-containing layer coating solution in the invention is preferably a so-called thixotropic fluid. With regard to the technique, JP-A No. 11-52509 can be referred. The organic silver salt-containing layer coating solution in the invention preferably has the viscosity at the shear rate of 0.1 S⁻¹ of 400 or more and 100,000 mPa·s or less, and more preferably 500 or more and 20,000 mPa·s or less. Furthermore, at the shear rate of 1000 S⁻¹, the viscosity is preferably 1 or more and 200 mPa·s or less, and more preferably 5 or more and 80 mPa·s or less.

When two types of solutions are mixed to prepare a coating solution of the invention, a known inline mixer or in-plant mixer can be preferably used. The preferred inline mixers and in-plant mixers in the invention are described in JP-A No. 2002-85948 and JP-A No. 2002-90940, respectively.

The coating solution in the invention is preferably subjected to a defoaming treatment for keeping the resulting coated surface conditions favorable. The preferred defoaming treatment method according to the invention is a method described in JP-A No. 2002-66431.

When the coating solution of the invention is coated, in order to inhibit dust, dirt, or the like due to the charging of the support from depositing, destaticizing is preferably applied. In the invention, preferred examples of the destaticizing method are described in JP-A No. 2002-143747.

In the invention, it is important to precisely control a drying air and a drying temperature in order to dry a non-setting image forming layer coating solution. The preferred drying methods in the invention are described in details in JP-A Nos. 2001-194749 and 2002-139814.

In order to improve the film-forming property, the photothermographic material of the invention is preferably heat treated immediately after coating and drying. A temperature at the heat treatment is preferably in the range of 60 to 100 degrees centigrade in terms of the film surface temperature, and a heating time is preferably within 1 to 60 sec. The more preferred range is 70 to 90 degrees centigrade for the film surface temperature, and 2 to 10 sec for the heating time. The preferred heat treatment methods of the invention are described in JP-A No. 2002-107872.

Furthermore, in order to continuously manufacture the photothermographic materials of the invention with stability, the manufacturing methods described in JP-A Nos. 2002-156728 and 2002-182333 are preferably used.

The photothermographic material is preferably of mono-sheet type (i.e., a type which can form image on the photothermographic material without using other sheets such as an image-receiving material).

13) Packaging Material

The photosensitive material according to the invention, in order to suppress photographic performances from fluctuating during unprocessed stock storage, or in order to make curling or rolling habit less, is preferably packaged in a packaging material with low oxygen permeability and/or moisture permeability. The oxygen permeability is preferably 50 or less ml/atm·m²·day, more preferably 10 or less ml/atm·m²·day, and furthermore preferably 1.0 or less ml/atm·m²·day, at 25 degrees centigrade. The moisture permeability is preferably 10 or less g/atm·m²·day, more preferably 5 or less g/ml/atm·m²·day, and furthermore preferably 1 or less g/atm·m²·day.

Specific examples of the packaging material with low oxygen permeability and/or moisture permeability are the packaging materials described in, for example, JP-A Nos. 08-254793 and 2000-206653.

14) Other Applicable Techniques

As the techniques that can be used in the photothermographic materials according to the invention, the techniques described in EP-A Nos. 803764 and 883022, WO98/36322, JP-A Nos. 56-62648, 58-62644, 09-43766, 09-281637, 09-297367, 09-304869, 09-311405, 09-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2000-187298, 2000-10229, 2000-47345, 2000-206642, 2000-98530, 2000-98531, 2000-112059, 2000-112060, 2000-112104, 2000-112064, and 2000-171936 can be cited.

(Image Forming Method)

The photothermographic material of the present invention may be either “single-sided type” having an image forming layer on one side of the support, or “double-sided type” having image forming layers on both sides of the support.

<Double-Sided-Type Photothermographic Material>

A photothermographic material according to the invention can be preferably used in an image-forming method in which an X-ray image is recorded by use of an X-ray intensifying screen.

The image-forming method that uses the photothermographic material includes the following steps of:

(a) placing the photothermographic material between a pair of X-ray intensifying screens to obtain an image-forming combined system;

(b) placing a subject between the combined system and an X-ray source;

(c) irradiating an X-ray having energy in the range of 25 to 125 kVp to the subject;

(d) taking out the photothermographic material from the combined system; and

(e) heating the taken-out photothermographic material at a temperature in the range of 90 to 180 degrees centigrade.

The photothermographic material that is used in the combined system according to the invention is preferably prepared such that an image that is obtained by exposing the photosensitive material stepwise to an X-ray followed by thermally developing has, in the characteristic curve based on a rectangular coordinate system having same unit lengths of coordinate axes denoting optical density (D) and exposure quantity (logE), an average gamma (γ) that is obtained by connecting a point of a minimum density (Dmin) plus density 0.25 and a point of a minimum density (Dmin) plus density 2.0 in the range of 1.8 or more and 4.3 or less, and more preferably in the range of 2.0 or more and 4.0 or less. The Dₘₐₓ is preferably 3.0 or more, and, in particular, as a mammography photothermographic material, it is preferably 3.4 or more, and more preferably 3.6 or more. When the photothermographic material having such the characteristic curve is used in an X-ray photographing system, an X-ray image having excellent photographic characteristics in which a toe region of the characteristic curve is much extended and also a gamma value in an intermediate density part is high can be obtained. Owing to these photographic characteristics, there is a merit in that depiction of a low density area such as a mediastinum area, or cardiac shadow which is low in X-ray transmission quantity becomes enhanced and, furthermore, an image of a lung field which is subjected to a large X-ray exposure quantity comes to have a density which allows the lung field to be easily recognized and, also, has a favorable contrast.

The photothermographic material having such favorable characteristic curve as described above can be easily produced by, for example, a method in which an image-forming layer on each side is constituted of two or more silver halide emulsion layers that are different in the sensitivity from each other. Particularly, it is preferable to form the image-forming layer with a high-speed emulsion in an upper layer and an emulsion having photographic characteristics of low speed and hard tone in a lower layer. When the image-forming layer including such two layers as described above is used, difference in speeds between silver halide emulsions of the two layers is in the range from 1.5 time or more to 20 times or less, and preferably from 2 times or more to 15 times or less. Furthermore, a ratio of quantities of emulsions that are used to form respective layers differs depending on differences in speeds and covering powers of the emulsions that are used. In general, as the difference in speeds of the emulsions that are used becomes larger, the ratio of the emulsion on a higher speed side is lowered. For example, when the difference in speeds is two times, a preferable ratio of emulsions that are used, in the case of the covering powers of respective emulsions being substantially same with each other, in terms of silver amounts, as a ratio of a high-speed emulsion to a low-speed emulsion, is controlled so as to be in the range from 1:20 or more to 1:50 or less.

As the techniques for crossover cut (in the case of double-sided coated photosensitive material) and anti-halation (in the case of single-sided coated photosensitive material), dyes or combined use of dye and mordant described in JP-A. No. 2-68539, (from page 13, left lower column, line 1 to page 14, left lower column, line 9) can be employed.

Next the fluorescent intensifying screen (radiographic intensifying screen) employed in the practice of the present invention is explained below. The radiographic intensifying screen essentially comprises a support and a fluorescent substance layer coated on one side of the support as the fundamental structure. The fluorescent substance layer is a layer where the fluorescent substance is dispersed in binders. On the surface of a fluorescent substance layer opposite to the support side (the surface of the side that does not face on the support), a transparent protective layer is generally disposed to protect the fluorescent substance layer from chemical degradation and physical shock.

Preferred fluorescent substances of the present invention are described below. Tungstate type fluorescent substances (CaWO₄, MgWO₄, CaWO₄:Pb and the like), terbium activated rare earth sulfoxide type fluorescent substances [Y₂O₂S:Tb, Gd₂O₂S:Tb, La₂O₂S:Tb, (Y,Gd)₂O₂S:Tb, (Y,Gd)O₂S:Tb, Tm and the like], terbium activated rare earth phosphate type fluorescent substances (YPO₄:Tb, GdPO₄:Tb, LaPO₄:Tb and the like), terbium activated rare earth oxyhalogen type fluorescent substances (LaOBr:Tb, LaOBr:Tb, Tm, LaOCl:Tb, LaOCl:Tb, Tm, LaOBr:Tb, GdOBr:Tb, GdOCl:Tb and the like), thulium activated rare earth oxyhalogen type fluorescent substances (LaOBr:Tm, LaOCl:Tm and the like), barium sulfate type fluorescent substances [BaSO₄:Pb, BaSO₄:Eu²⁺, (Ba,Sr)SO4:Eu²⁺ and the like], divalent europium activated alkali earth metal phosphate type fluorescent substances [(Ba₂PO₄)₂:Eu²⁺, (Ba₂PO₄)₂:Eu²⁺, and the like], divalent europium activated alkali earth metal fluorinated halogenide type fluorescent substances [BaFCl:Eu²⁺, BaFBr:Eu²⁺, BaFCl:Eu²⁺, Tb, BaFBr:Eu²⁺, Tb, BaF₂.BaCl.KCl:Eu²⁺, (Ba,Mg)F₂.BaCl.KCl:Eu²⁺, and the like], iodide type fluorescent substances (CsI:Na, CsI:Tl, NaI, KI:Tl and the like), sulfide type fluorescent substances [ZnS:Ag(Zn,Cd)S:Ag, (Zn,Cd)S:Cu, (Zn,Cd)S:Cu, Al and the like], hafnium phosphate type fluorescent substances (HfP₂O₇:Cu and the like). However, the fluorescent substance used in the present invention is not particularly limited to these specific examples, so long as to emit light in visible and near ultraviolet region by exposure to a radioactive ray.

In the fluorescent intensifying screen used in the present invention, the fluorescent substances are preferably packed in the grain size graded structure. Especially, fluorescent substance particles having a large particle size is preferably coated at the side of the surface protective layer and fluorescent substance particles having a small particle size is preferably coated at the side of the support. Hereto, the small particle size of fluorescent substance is preferably in the range from 0.5 μm to 2.0 μm and the large size is preferably in the range from 10 μm to 30 μm.

<Single-Sided Type Photothermographic Material>

The single-sided type photothermographic material of the present invention is favorably applied for an X-ray photosensitive material used for mammography.

It is important that the single-sided-type photothermographic material used in the present object is designed such that the contrast of the image to be obtained falls in an appropriate range.

As to preferable constituents as a mammography X-ray photosensitive material, JP-A05-45807, 10-62881, 10-54900 and 11-109564 can be referred to.

<Combination with Ultraviolet Fluorescent Screen>

As an image-forming method that uses the photothermographic materials according to the invention, a method in which a combination with a phosphor having a main peak at preferably 400 nm or less is used to form images can be used. Furthermore preferably, a combination with a phosphor having a primary peak at 380 nm or less can be used to form images. Both the double-sided-type photosensitive material and the single-sided-type photosensitive material can be used in the combined system. As such screens each having a main peak at 400 nm or less, screens described in, for example, JP-A No. 06-11804, and WO 93/01521 can be used; however, the present invention is by no means restricted thereto. As techniques of crossover-cut of the ultraviolet ray (for double-sided-type photosensitive material) and antihalation (for single-sided-type photosensitive material), those described in JP-A No. 08-76307 can be used. As such ultraviolet ray-absorbing dyes, dyes described in JP-A No. 2000-320809 are particularly preferred.

<Laser Exposure>

As an image forming method that uses the photothermographic materials according to the invention, a digital image forming method where digitalized image information is outputted by use of laser light can be preferably used as well.

As the laser, a red to infrared He—Ne laser, a red semiconductor laser, a blue to green Ar⁺, He—Ne, or He—Cd laser, or a blue semiconductor laser can be used. Preferably, the red to infrared semiconductor laser can be used and a peak wavelength of laser light is in the range of 600 to 900 nm, and preferably in the range of 620 to 850 nm. On the other hand, recently, in particular, a module in which an SHG (Second Harmonic Generator) element and a semiconductor laser are integrated or a blue semiconductor laser has been developed, and thereby a laser output device in a shorter wavelength region has been close-upped. Since the blue semiconductor laser is capable of performing ultra-fine image recording, increasing a recording density and obtaining a long-life and consistent output, it is expected that demand for the blue semiconductor laser will increase. A peak wavelength of the blue laser light is in the range from 300 to 500 nm and particularly preferably from 400 to 500 nm.

The laser beam that oscillates in a longitudinal multiple modulation by a method such as high frequency superposition is also preferably employed.

<Thermal Development>

The photothermographic materials according to the invention may be developed by any method. Ordinarily, a photothermographic material that has been imagewise exposed is heated to develop. A preferable development temperature is in the range from 80 to 250 degrees centigrade, and more preferably from 100 to 140 degrees centigrade.

A development time is preferably in the range from 1 to 60 sec, more preferably from 5 to 30 sec, and particularly preferably from 5 to 20 sec.

In the process for the thermal development, either drum type heaters or plate type heaters may be used. However, plate type heater processes are more preferred. Preferable process for the thermal development by a plate type heater may be a process described in JP-A NO. 11-133572, which discloses a thermal developing apparatus in which a visible image is obtained by bringing a photothermographic material with a formed latent image into contact with a heating means at a thermal developing portion, wherein the heating means comprises a plate heater, and plurality of retainer rollers are oppositely provided along one surface of the plate heater, the thermal developing apparatus is characterized in that thermal development is performed by passing the photothermographic material between the retainer rollers and the plate heater. It is preferred that the plate heater is divided into 2 to 6 portions, with the leading end having the lower temperature by 1° C. to 10° C.

Such a process is also described in JP-A NO. 54-30032, which allows for excluding moisture and organic solvents included in the photothermographic material out of the system, and also allows for suppressing the change of shapes of the support of the photothermographic material upon rapid heating of the photothermographic material.

<System>

Examples of a medical laser imager equipped with an exposing portion and a thermal developing portion include Fuji Medical Dry Laser Imager FM-DPL. In connection with FM-DP L, description is found in Fuji Medical Review No. 8, pages 39 to 55. It goes without mentioning that those techniques may be applied as the laser imager for the photothermographic material of the invention. In addition, the present photothermographic material can be also applied as a photothermographic material for the laser imager used in “AD network” which was proposed by Fuji Film Medical Co., Ltd. as a network system accommodated to DICOM standard.

(Application of the Invention)

The photothermographic materials according to the invention form a black-and-white image based on a silver image; hence, it is preferred that the photothermographic materials are used as a photothermographic material for medical diagnosis, as a photothermographic material for industrial photography, as a photothermographic material for printing use, and as a photothermographic material for COM use. Particularly preferably, the photothermographic material according to the invention can be used as one that for medical diagnosis.

### EXAMPLES

The present invention is specifically explained by way of Examples below, which should not be construed as limiting the invention thereto.

### Example 1

(Preparation of PET Support)

1-1. Film Forming

PET having the intrinsic viscosity IV=0.66 (measured at 25 degrees centigrade in phenol/tetrachloroethane=6/4 (by mass ratio)) was obtained in accordance with an ordinary preparation method with terephthalic acid and ethylene glycol. After the thus-obtained PET was pelletized, the resultant pellets are dried at 130 degrees centigrade for 4 hours. Then, the thus-dried pellets were extruded from a T-type die at 300 degrees centigrade, followed by quenching, thereby preparing an unstretched film.

The thus-prepared film was stretched up to 3.3 times in the machine direction with rollers having different peripheral velocities, then up to 4.5 times in the transverse direction by means of a tenter. Temperatures at the time of such stretching are 110 and 130 degrees centigrade, respectively. Thereafter, the thus-stretched film was subjected to thermal fixation at 240 degrees centigrade for 20 sec, followed by relaxing by 4 percent in the transverse direction at the same temperature as at the thermal fixation. Thereafter, chucking parts of the tenter were slit off, and both edges of the film were subjected to knurl processing. The film was rolled at 4 kg/cm² to obtain a roll of film having a thickness of 175 μm.

1-2. Corona Discharge Surface Treatment

Both surfaces of the support were treated at room temperature at 20 m/minute using Solid State Corona Discharge Treatment Machine Model 6KVA manufactured by Piller GmbH. It was proven that treatment of 0.375 kV·A·minute/m2 was executed, judging from the readings of current and voltage on that occasion. The frequency upon this treatment was 9.6 kHz, and the gap clearance between the electrode and dielectric roll was 1.6 mm.

1-3. Undercoat

<Preparation of Undercoat Layer Coating Solution>

Prescription-1 (For Undercoat Layer on Photosensitive Layer Side)

| | | |
|---|---|---|
| Pesresin A-520 (trade name, 30 percent by mass solution, | 46.8 | g |
| manufactured by Takamatsu Oil & Fat, Inc.) | | |
| Byronal MD-1200 (trade name, manufactured by Toyobo | 10.4 | g |
| Co., Ltd.) | | |
| 1 mass percent solution of polyethylene glycol | 11.0 | g |
| monononylphenyl ether (average number of ethylene | | |
| oxide = 8.5) | | |
| MP-1000 (trade name, PMMA polymeric fine grains; average | 0.91 | g |
| grain diameter: 0.4 μm, manufactured by Soken Kagaku | | |
| Co., Ltd.) | | |
| Distilled water | 935 | ml |

Prescription-2 (For First Layer on Back Surface)

| | | |
|---|---|---|
| Styrene/butadiene copolymer latex (solid content: 40 mass | 130.8 | g |
| percent; weight ratio of styrene/butadiene = 68/32) | | |
| Sodium salt of 2,4-dichloro-6-hydroxy-S-triazine (8 mass | 5.2 | g |
| percent aqueous solution) | | |
| 1 mass percent aqueous solution of sodium laurylbenzene | 10 | ml |
| sulfonate | | |
| Dispersion of polystylene particles (average grain | 0.5 | g |
| diameter; 2 μm, 20 mass persent) | | |
| Distilled water | 854 | ml |

Prescription-3 (For Second Layer on Back Surface)

| | | |
|---|---|---|
| SnO₂/SbO (9/1 mass ratio; average grain diameter: | 84 | g |
| 0.5 μm; 17 percent by mass dispersion) | | |
| Gelatin | 7.9 | g |
| Metolose TC-5 (trade name, 2 percent by mass aqueous | 10 | g |
| solution, manufactured by Shin-Etsu Chemical Co., Ltd.) | | |
| Sodium dodecylbenzene sulfonate (1 mass percent | 10 | ml |
| aqueous solution) | | |
| NaOH (1 mass percent) | 7 | g |
| Proxel (trade name, manufactured by Avecia KK) | 0.5 | g |
| Distilled water | 881 | ml |

After the corona discharge treatment was applied on both surfaces of a biaxially stretched polyethylene terephthalate support having a thickness of 175 μm, the undercoating solution of the Prescription (1) was applied on one surface (photosensitive layer surface) thereof by means of a wire-bar so as to be 6.6 ml/m² in a wet coating quantity (per one surface) followed by drying at 180 degrees centigrade for 5 min. Then, the undercoating solution of Prescription (2) was applied on the opposite surface (back surface) thereof by means of a wire-bar so as to be 5.7 ml/m² in a wet coating quantity followed by drying at 180 degrees centigrade for 5 min. Furthermore, the undercoating solution of Prescription (3) was applied on the opposite surface (back surface) by means of a wire-bar so as to be 8.4 ml/m² in a wet coated quantity followed by drying at 180 degrees centigrade for 6 min, and thereby an undercoated support was prepared.

(Back Layer)

1) Preparation of Coating Solution for Back Layer

(Preparation of Solid Fine Grain Dispersion (a) of Base Precursor)

A base precursor-1 in an amount of 2.5 kg, and 300 g of a surfactant (trade name: DEMOL N, manufactured by Kao Corporation), 800 g of diphenyl sulfone, 1.0 g of benzoisothiazolinone sodium salt and distilled water were added to give the total amount of 8.0 kg and mixed. The mixed liquid was subjected to beads dispersion using a horizontal sand mill (UVM-2: manufactured by IMEX Co., Ltd.). Process for dispersion included feeding the mixed liquid to UVM-2 packed with zirconia beads having the mean particle diameter of 0.5 mm with a diaphragm pump, followed by the dispersion at the inner pressure of 50 hPa or higher until desired mean particle diameter could be achieved.

The dispersion was dispersed until, when the spectral absorbance measurement is performed, a ratio of the absorbance thereof at 450 nm to that at 650 nm (D₄₅₀/D₆₅₀) became 3.0. The obtained dispersion was diluted with distilled water so that a concentration of the base precursor might be 25 mass percent, filtered (polypropylene filter having average fine pore diameter: 3 μm) to remove dust, and supplied for practical use.

2) Preparation of Dye Solid Fine Grain Dispersion

A cyanine dye-1 in an amount of 6.0 kg, and 3.0 kg of sodium p-dodecylbenzenesulfonate, 0.6 kg of DEMOL SNB (a surfactant manufactured by Kao Corporation), and 0.15 kg of a defoaming agent (trade name: SURFYNOL 104E, manufactured by Nissin Chemical Industry Co., Ltd.) were mixed with distilled water to give the total liquid amount of 60 kg. The mixed liquid was subjected to dispersion with 0.5 mm zirconia beads using a horizontal sand mill (UVM-2: manufactured by IMEX Co., Ltd.).

The dispersion was dispersed until, when the spectral absorbance measurement is performed, a ratio of the absorbance thereof at 650 nm to that at 750 nm (D₆₅₀/D₇₅₀) became 5.0 or more. The obtained dispersion was diluted with distilled water so that a concentration of cyanine dye might be 6 mass percent, filtered with a filter (average fine pore diameter: 1 μm) to remove dust, and supplied for practical use.

3) Preparation of Coating Solution for Antihalation Layer

A vessel was kept at 40° C., and thereto were added 40 g of gelatin, 20 g of monodispersed polymethyl methacrylate fine particles (mean particle size of 8 μm, standard deviation of particle diameter of 0.4), 0.1 g of benzoisothiazolinone and 490 mL of water to allow gelatin to be dissolved. Additionally, 2.3 mL of a 1 mol/L aqueous sodium hydroxide solution, 40 g of the aforementioned dispersion of the solid fine particle of the dye, 90 g of the aforementioned dispersion of the solid fine particles (a) of the base precursor, 12 mL of a 3% by mass aqueous solution of sodium polystyrenesulfonate, and 180 g of a 10% by mass solution of SBR latex were admixed. Just prior to the coating, 80 mL of a 4% by weight aqueous solution of N,N-ethylenebis(vinylsulfone acetamide) was admixed to give a coating solution for the antihalation layer.

4) Preparation of Coating Solution for Back Surface Protective Layer

A vessel was kept at 40° C., and thereto were added 40 g of gelatin, 35 mg of benzoisothiazolinone and 840 mL of water to allow gelatin to be dissolved. Additionally, 5.8 mL of a 1 mol/L aqueous sodium hydroxide solution, 1.5 g of a 10% by mass emulsion of liquid paraffin, 5 g of a 10% by mass emulsion of trimethylolpropane triisostearate, 10 mL of a 5% by mass aqueous solution of di(2-ethylhexyl) sodium sulfosuccinate, 20 mL of a 3% by mass aqueous solution of sodium polystyrenesulfonate, 2.4 mL of a 2% by mass solution of a fluorocarbon compound (F-1), 2.4 mL of a 2% by weight solution of fluorocarbon compound (F-2), and 32 g of a 19% by mass solution of methyl methacrylate/styrene/butyl acrylate/hydroxyethyl methacrylate/acrylic acid copolymer (weight ratio of the copolymerization of 58/8/27/5/2, Tg: 42° C., I/O value: 0.555) latex (latex 1 for comparision) were admixed. Just prior to the coating, 25 mL of a 4% by mass aqueous solution of N,N-ethylenebis(vinylsulfone acetamide) was admixed to give a coating solution for the back surface protective layer.

5) Coating of Back Layer

On a back surface side of the undercoated support, the coating solution for the antihalation layer and the coating solution for the back surface protective layer were simultaneously coated in a multi-layer so that coat amounts of gelatin therein might be 0.52 g/m² and 1.7 g/m², respectively, followed by drying to prepare a back layer.

(Image-Forming Layer, Intermediate Layer, and Protective Layer)

1. Preparation of Coating Materials

1) Silver Halide Emulsion

<<Preparation of Silver Halide Emulsion 1>>

To 1421 ml of distilled water, added were 3.1 ml of a 1 mass percent potassium bromide aqueous solution, and then 3.5 ml of sulfuric acid having a concentration of 0.5 mol/liter and 31.7 g of phthalated gelatin thereto. The resulting solution was kept stirred at 30 degrees centigrade in a stainless reactor, to which was added a total of a solution A in which 22.22 g of silver nitrate was diluted with distilled water to 95.4 ml and a solution B in which 15.3 g of potassium bromide and 0.8 g of potassium iodide were diluted with distilled water to a volume of 97.4 ml at a constant flow rate over 45 sec. Thereafter, 10 ml of a 3.5 mass percent hydrogen peroxide aqueous solution and then 10.8 ml of a 10 mass percent benzimidazole aqueous solution were added thereto. Next, a solution C in which 51.86 g of silver nitrate was diluted with distilled water to 317.5 ml and a solution D in which 44.2 g of potassium bromide and 2.2 g of potassium iodide were diluted with distilled water to 400 ml were prepared. A total of the solution C was added thereto at a constant flow rate over 20 min and the solution D was added with the pAg keeping at 8.1 according to a controlled double jet method. Ten minutes after the start of the addition of the solutions C and D thereto, a total amount of potassium hexachloroiridate(III) was added thereto so as to be 1×10⁻⁴ mol per mol of silver. Furthermore, 5 sec after the end of the addition of the solution C, a total amount of potassium hexacyano-iron(II) aqueous solution was added so as to be 3×10⁻⁴ mol per mol of silver. The pH of the system was controlled to be 3.8 with sulfuric acid having a concentration of 0.5 mol/liter, followed by stopping stirring, further followed by applying sedimentation, desalting and washing with water. The pH was controlled so as to be 5.9 with sodium hydroxide having a concentration of 1 mol/liter, and thereby a silver halide dispersion having the pAg 8.0 was prepared.

With the silver halide dispersion stirring at 38 degrees centigrade, 5 ml of a 0.34 mass percent 1,2-benzoisothiazolin-3-one methanol solution was added thereto. After 40 minutes, this was heated up to 47 degrees centigrade, 20 minutes after the heating, a sodium benzenethiosulfonate methanol solution was added to be 7.6×10⁻⁵ mol per mol of silver; and after 5 min, a methanol solution of tellurium sensitizer C was added thereto so as to be 2.9×10⁻⁴ mol per mol of silver therein, followed by ripening for 91 min. Thereafter, a methanol solution of spectral-sensitizing dye A and color-sensitizing dye B in a mol ratio of 3/1 was added thereto so that a total amount of the color-sensitizing dyes A and B might be 1.2×10⁻³ mol per mol of silver. After 1 min, 1.3 ml of a 0.8 mass percent N,N′-dihydroxy-N″,N″-diethylmelamine methanol solution was added thereto; and after 4 min, a 5-methyl-2-mercaptobenzimidazole methanol solution was added so as to be 4.8×10⁻³ mol per mol of silver, a 1-phenyl-2-heptyl-5-mercapto-1,3,4-triazole methanol solution was added so as to be 5.4×10⁻³ mol per mol of silver, and an aqueous solution of 1-(3-methylureidophenyl)-5-mercaptotetrazole was added so as to be 8.5×10⁻³ mol per mol of silver, thereby silver halide emulsion 1 was prepared.

The grains in the thus-prepared silver halide emulsion were silver iodobromide grains that have a mean sphere-corresponding diameter of 0.042 μm, a sphere-corresponding diameter variation coefficient of 20 percent and homogeneously contain iodine at 3.5 mol percent. To obtain the grain size, 1000 grains were analyzed with an electronic microscope, and their data were averaged. The {100} plane ratio of the grains was measured according to the Kubelka-Munk method and found to be 80 percent.

<<Preparation of Silver Halide Emulsion 2>>

Preparation of silver halide emulsion-2 was conducted in a similar manner to the process in the preparation of the silver halide emulsion-1 except that: the temperature of the liquid upon the grain formation step was altered from 30° C. to 47° C.; the solution B was changed to that prepared through diluting 15.9 g of potassium bromide with distilled water to give the volume of 97.4 mL; the solution D was changed to that prepared through diluting 45.8 g of potassium bromide with distilled water to give the volume of 400 mL; time period for adding the solution C was changed to 30minutes; and potassium iron (II) hexacyanide was deleted. The precipitation/desalting/water washing/dispersion were carried out similarly to the silver halide emulsion-1. Furthermore, the spectral sensitization, chemical sensitization, and addition of 5-methyl-2-mercaptobenzimidazole and 1-phenyl-2-heptyl-5-mercapto-1,3,4-triazole was executed similarly to the emulsion-1 except that: the amount of the tellurium sensitizer C to be added was changed to 1.1×10-4 mol per one mol of silver; the amount of the methanol solution of the spectral sensitizer A and a spectral sensitizer B with a molar ratio of 3:1 to be added was changed to 7.0×10-4 mol in total of the spectral sensitizer A and the spectral sensitizer B per one mol of silver; the addition of 1-phenyl-2-heptyl-5-mercapto-1,3,4-triazole was changed to give 3.3×10-3 mol per one mol of silver; and the addition of 1-(3-methylureidophenyl)-5-mercaptotetrazole was changed to give 4.7×10-3 mol per one mol of silver to produce a silver halide emulsion-2. The emulsion grains in the silver halide emulsion-2 were pure cubic silver bromide grains having a mean sphere equivalent diameter of 0.080 μm and a variation coefficient of 20%.

<<Preparation of Silver Halide Emulsion 3>>

Preparation of a silver halide emulsion-3 was conducted in a similar manner to the process in the preparation of the silver halide emulsion-1 except that the temperature of the liquid upon the grain formation step was altered from 30° C. to 27° C. In addition, the precipitation/desalting/water washing/dispersion were carried out similarly to the silver halide emulsion-1. Silver halide emulsion-3 was obtained similarly to the emulsion-1 except that: the addition of the methanol solution of the spectral sensitizer A and the spectral sensitizer B was changed to the solid dispersion (aqueous gelatin solution) at a molar ratio of 1:1 with the amount to be added being 6.0×10⁻³ mol in total of the spectral sensitizer A and spectral sensitizer B per one mol of silver; the amount of the tellurium sensitizer C to be added was changed to 5.2×10⁻⁴ mol per one mol of silver; and bromoauric acid at 5×10⁻⁴ mol per one mol of silver and potassium thiocyanate at 2×10⁻³ mol per one mol of silver were added at 3 minutes following the addition of the tellurium sensitizer. The grains in the silver halide emulsion-3 were silver iodobromide grains having a mean sphere equivalent diameter of 0.034 μm and a variation coefficient of 20%, which uniformly include iodine at 3.5 mol%.

<<Preparation of Mixed Emulsion A for Coating Solution>>

Seventy mass percent of the silver halide emulsion 1, 15 mass percent of the silver halide emulsion 2 and 15 mass percent of the silver halide emulsion 3 were dissolved, and to which a 1 mass percent benzothiazolium iodide aqueous solution was added so as to be 7×10⁻³ mol per mol of silver.

Furthermore, as a “compound of which one-electron oxidation product formed through one-electron oxidation can release one or more electrons”, compounds 1, 20 and 26 each were added to the emulsion so as to be a quantity of 2×10⁻³ mol per mol of silver of the silver halide.

Next, water was added thereto so that a content of the silver halide might be 38.2 g in terms of silver per kg of the coating solution mixture emulsion. Then, 1-(3-methylureidophenyl)-5-mercaptotetrazole was added to the emulsion so as to be 0.34 g per kg of the coating solution mixture emulsion.

2) Preparation of Fatty Acid Silver Salt Dispersion

<<Preparation of Fatty Acid Silver Salt Dispersion A>>

88 kg of recrystallized behenic acid (content of behenic acid: 99% by mole), 422 L of distilled water, 49.2 L of an aqueous sodium hydroxide solution at the concentration of 5 mol/L, 120 L of t-butyl alcohol were admixed, and subjected to a reaction with stirring at 75° C. for one hour to give a solution of a sodium behenate A. Separately, 206.2 L of an aqueous solution of 40.4 kg of silver nitrate (pH 4.0) was provided, and kept at a temperature of 10° C. A reaction vessel charged with 635 L of distilled water and 30 L of t-butyl alcohol was kept at 30° C., and thereto were added the total amount of the solution of a sodium behenate A and the total amount of the aqueous silver nitrate solution with sufficient stirring at a constant flow rate over 93 minutes and 15 seconds, and 90 minutes, respectively. Upon this operation, during first 11 minutes following the initiation of adding the aqueous silver nitrate solution, the added material was restricted to the aqueous silver nitrate solution alone. The addition of the solution of a sodium behenate A was thereafter started, and during 14 minutes and 15 seconds following the completion of adding the aqueous silver nitrate solution, the added material was restricted to the solution of a sodium behenate A alone. The temperature inside of the reaction vessel was then set to be 30° C., and the temperature outside was controlled so that the liquid temperature could be kept constant. In addition, the temperature of a pipeline for the addition system of the solution of a sodium behenate A was kept constant by circulation of warm water outside of a double wall pipe, so that the temperature of the liquid at an outlet in the leading edge of the nozzle for addition was adjusted to be 75° C. Further, the temperature of a pipeline for the addition system of the aqueous silver nitrate solution was kept constant by circulation of cool water outside of a double wall pipe. Position at which the solution of a sodium behenate A was added and the position, at which the aqueous silver nitrate solution was added, was arranged symmetrically with a shaft for stirring located at a center. Moreover, both of the positions were adjusted to avoid contact with the reaction liquid.

After completing the addition of the solution of a sodium behenate A, the mixture was left to stand at the temperature as it is for 20 minutes. The temperature of the mixture was then elevated to 35° C. over 30 minutes followed by aging for 210 minutes. Immediately after completing the aging, solid matters were filtered out with centrifugal filtration. The solid matters were washed with water until the electric conductivity of the filtrated water became 30 μS/cm. A silver salt of fatty acid was thus obtained. The resulting solid matters were stored as a wet cake without drying.

To a wet cake corresponding to 260 kg as a dry solid content, 19.3 kg of polyvinyl alcohol (trade name, PVA-217; polymerization degree, 1,700; sapponification degree, 88 percent; manufactured by Kuraray Co., Ltd.) was added as a dispersing agent, followed by adding water to make 1,000 kg in total. The resulting mixture was formed into slurry in a blade dissolver, and then pre-dispersed in a pipeline mixer (trade name PM-10, manufactured by Mizuho Industry).

Next, a stock liquid after the preliminary dispersion was treated three times using a dispersing machine (trade name: Microfluidizer M-610, manufactured by Microfluidex International Corporation, using Z type Interaction Chamber) with the pressure controlled to be 1,150 kg/cm² to give a dispersion of the silver behenate (a dispersion of silver salt of fatty acid). For the cooling manipulation, coiled heat exchangers were equipped before and after of the interaction chamber respectively, and accordingly, the temperature for the dispersion was set to be 18° C. by regulating the temperature of the cooling medium.

Shapes of the obtained silver behenate grains were evaluated by use of an electron microscope. By approximating the shape to a rectangle, side lengths thereof were taken as a, b and c from a shorter side. Average values of obtained 100 grains are shown in Table 1.

<Preparation of Fatty Acid Silver Salt Dispersions B to E)

Similarly to the fatty acid silver salt dispersion A, with the exception that the dispersing agent PVA217 was altered as shown in Table 1, fatty acid silver salt dispersions B to E were prepared. Because dispersion proceeded differently depending on the dispersing agents, dispersion times were controlled so that the dispersion degrees of all dispersions might be same as that of the fatty acid silver salt dispersion A.

TABLE 1

| Organic Silver | Dispersing Agent | | |
|---|---|---|---|
| Salt Dispersion | | Polymerization | Saponification |
| No. | Name | Degree | Degree (%) |
| A | PVA217 | 1700 | 88% |
| B | PVA210 | 1000 | 88% |
| C | PVA205 | 500 | 88% |
| D | PVA203 | 300 | 88% |
| E | PVA105 | 500 | 99% |

3) Preparation of Reducing Agent Dispersion
<<Preparation of Reducing Agent-1 Dispersion>>

To 10 kg of a reducing agent-1 (2,2′-methylenebis-(4-ethyl-6-tert-butylphenol)) and 16 kg of a 10% by mass aqueous solution of modified polyvinyl alcohol (manufactured by Kuraray Co., Ltd., Poval MP203) was added 10 kg of water, and thoroughly mixed to give a slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 3 hours. Thereafter, 0.2 g of a benzoisothiazolinone sodium salt and water were added thereto, thereby adjusting the concentration of the reducing agent to be 25% by mass. This dispersion was subjected to heat treatment at 60° C. for 5 hours to obtain a reducing agent-1 dispersion. Particles of the reducing agent included in the resulting reducing agent dispersion had a median diameter of 0.40 μm, and a maximum particle diameter of 1.4 μm or less. The resultant reducing agent dispersion was subjected to filtration with a polypropylene filter having a pore size of 3.0 μm to remove foreign substances such as dust, and stored.

<<Preparation of Reducing Agent-2 Dispersion>>

To 10 kg of a reducing agent-2 (6,6′-di-t-butyl-4,4′-dimethyl-2,2′-butylidenediphenol) and 16 kg of a 10 mass percent aqueous solution of modified polyvinyl alcohol (trade name POVAL MP203, manufactured by Kuraray Co., Ltd.), 10 kg of water was added, followed by thoroughly mixing, thereby a slurry was obtained. Via a diaphragm pump, the slurry was fed into a horizontal sand mill (trade name UVM-2 manufactured by Imex) filled with zirconia beads having a mean diameter of 0.5 mm, followed by dispersing for 3 hours and 30 min, further followed by adding 0.2 g of benzoisothiazolinone sodium salt and water, thereby a concentration of the reducing was controlled so as to be 25 mass percent. The dispersion was then heated at 40 degrees centigrade for 1 hour, followed by further heating at 80 degrees centigrade for 1 hour, and thereby a reducing agent-2 dispersion was obtained. Thus obtained reducing agent grains contained in the reducing agent dispersion had a median diameter of 0.50 μm and a maximum grain size of 1.6 μm or less. The obtained reducing agent dispersion was filtered through a polypropylene filter having a pore size of 3.0 μm to remove foreign matters such as dust or the like, followed by storing.

4) Preparation of Hydrogen-Bonding Compound-1 Dispersion

To 10 kg of a hydrogen bonding compound-1 (tri(4-t-butylphenyl)phosphineoxide) and 16 kg of a 10% by mass aqueous solution of modified polyvinyl alcohol (manufactured by Kuraray Co., Ltd., Poval MP203) was added 10 kg of water, and thoroughly mixed to give a slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 4 hours. Thereafter, 0.2 g of a benzoisothiazolinone sodium salt and water were added thereto, thereby adjusting the concentration of the hydrogen bonding compound to be 25% by mass. This dispersion was warmed at 40° C. for one hour, followed by a subsequent heat treatment at 80° C. for one hour to obtain a hydrogen bonding compound-1 dispersion. Particles of the hydrogen bonding compound included in the resulting hydrogen bonding compound dispersion had a median diameter of 0.45 μm, and a maximum particle diameter of 1.3 μm or less. The resultant hydrogen bonding compound dispersion was subjected to filtration with a polypropylene filter having a pore size of 3.0 μm to remove foreign substances such as dust, and stored.

5) Preparation of Development Accelerator-1 Dispersion

To 10 kg of a development accelerator-1 and 20 kg of a 10% by mass aqueous solution of modified polyvinyl alcohol (manufactured by Kuraray Co., Ltd., Poval MP203) was added 10 kg of water, and thoroughly mixed to give a slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 3 hours and 30 minutes. Thereafter, 0.2 g of a benzoisothiazolinone sodium salt and water were added thereto, thereby adjusting the concentration of the development accelerating agent to be 20% by weight. Accordingly, a development accelerator-1 dispersion was obtained. Particles of the development accelerator included in the resulting development accelerator dispersion had a median diameter of 0.48 μm, and a maximum particle diameter of 1.4 μm or less. The resultant development accelerator dispersion was subjected to filtration with a polypropylene filter having a pore size of 3.0 μm to remove foreign substances such as dust, and stored.

6) Preparations of Dispersions of Development Accelerator-2 and Color-Tone-Adjusting Agent-1

Also concerning solid dispersions of a development accelerator-2 and a color-tone-adjusting agent-1, dispersion was executed in a similar manner to the development accelerator-1, and thus dispersions of 20% by mass and 15% by mass were respectively obtained.

7) Preparation of Polyhalogen Compound

<<Preparation of Organic Polyhalogen Compound-1 Dispersion>>

Ten kilograms of an organic polyhalogen compound-1 (tribromomethanesulfonyl-benzene), 10 kg of a 20 mass percent aqueous solution of modified polyvinyl alcohol (trade name POVAL MP203 manufactured by Kuraray Co., Ltd.), 0.4 kg of a 20 mass percent aqueous solution of sodium triisopropylnaphthalenesulfonate, and 14 kg of water were added and thoroughly mixed, thereby a slurry was obtained. Via a diaphragm pump, the slurry was fed into a horizontal sand mill (trade name UVM-2 manufactured by Imex) filled with zirconia beads having a mean diameter of 0.5 mm, and dispersed therein for 5 hours. Then, 0.2 g of benzoisothiazolinone sodium salt and water were added thereto so that a concentration of the organic polyhalogen compound might be 26 mass percent, and thereby an organic polyhalogen compound-1 dispersion was obtained. Thus obtained organic polyhalogen compound grains in the polyhalogen compound dispersion had a median diameter of 0.41 μm and a maximum grain size of 2.0 μm or less. The obtained organic polyhalogen compound dispersion was filtered through a polypropylene filter having a pore size of 10.0 μm to remove foreign matters such as dust and so on, and then stored.

<<Preparation of Organic Polyhalogen Compound-2 Dispersion>>

An organic polyhalogen compound-2 (N-butyl-3-tribromomethane sulfonylbenzoamide) in an amount of 10 kg, 20 kg of a 10% by weight aqueous solution of modified polyvinyl alcohol (manufactured by Kuraray Co., Ltd., Poval MP203), and 0.4 kg of a 20% by weight aqueous solution of sodium triisopropylnaphthalenesulfonate were added, and thoroughly admixed to give a slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 5 hours. Thereafter, 0.2 g of a benzoisothiazolinone sodium salt and water were added thereto, thereby adjusting the concentration of the organic polyhalogen compound to be 30% by weight. This fluid dispersion was heated at 40° C. for 5 hours to obtain an organic polyhalogen compound-2 dispersion. Particles of the organic polyhalogen compound included in the resulting organic polyhalogen compound dispersion had a median diameter of 0.40 μm, and a maximum particle diameter of 1.3 μm or less. The resultant organic polyhalogen compound dispersion was subjected to filtration with a polypropylene filter having a pore size of 3.0 μm to remove foreign substances such as dust, and stored.

8) Preparation of Phthalazine Compound-1 Solution

Modified polyvinyl alcohol MP203 in an amount of 8 kg was dissolved in 174.57 kg of water, and then thereto were added 3.15 kg of a 20% by weight aqueous solution of sodium triisopropylnaphthalenesulfonate and 14.28 kg of a 70% by mass aqueous solution of phthalazine compound-1 (6-isopropyl phthalazine) to prepare a 5% by mass phthalazine compound-1 solution.

9) Preparations of Mercapto Compound Solution

<<Preparation of Aqueous Solution of Mercapto Compound-1>>

A mercapto compound-1 (1-(3-sulfophenyl)-5-mercaptotetrazole sodium salt) in an amount of 7 g was dissolved in 993 g of water to give a 0.7% by mass aqueous solution.

<<Preparation of Aqueous Solution of Mercapto Compound-2>>

A mercapto compound-2 (1-(3-methylureidophenyl)-5-mercaptotetrazole) in an amount of 20 g was dissolved in 980 g of water to give a 2.0% by mass aqueous solution.

10) Preparation of Pigment-1 Dispersion

To 250 g of water, 64 g of C.I. Pigment Blue 60 and 6.4 g of Kao's DEMOLE N were added followed by thoroughly mixing, and thereby a slurry was obtained. Eight hundred grams of zirconia beads having a mean diameter of 0.5 mm were prepared and put into a vessel along with the slurry. The slurry in the vessel was milled by the use of a dispersion mill (trade name 1/4G Sand Grinder Mill, manufactured by Imex) for 25 hr, and water was added thereto to prepare a pigment-i dispersion having a pigment concentration of 5 mass percent. The pigment grains in the thus obtained dispersion had a mean grain size of 0.21 μm.

11) Preparation of SBR Latex Solution

SBR latex was prepared as follows.

Into a polymerization reactor of a gas monomer reaction system (trade name TAS-2J Model manufactured by Pressure Glass Industry), 287 g of distilled water, 7.73 g of surfactant (trade name PIONIN A-43-S, manufactured by Takemoto Yushi: solid content, 48.5 mass percent), 14.06 ml of NaOH (1 mol/liter), 0.15 g of tetrasodium ethylenediaminetetraacetate, 255 g of styrene, 11.25 g of acrylic acid, and 3.0 g of tert-dodecylmercaptan were put, followed by closing the reactor, further followed by stirring at 200 rpm. A vacuum pump was used to deaerate, nitrogen gas purge was repeated several times, followed by injecting 108.75 g of 1,3-butadiene, further followed by heating to an inside temperature of 60 degrees centigrade. A solution in which 1.875 g of ammonium persulfate was dissolved in 50 ml of water was added thereto, followed by stirring as such for 5 hr. Furthermore, a temperature was raised to 90 degrees centigrade followed by stirring for 3 hr, and after the reaction came to completion, the inside temperature was lowered to room temperature. Then, NaOH and NH₄OH (both 1 mol/liter) were added thereto in a molar ratio of Na⁺/NH₄⁺=1/5.3 (mol ratio) to control the pH thereof to 8.4. Thereafter, filtration was applied with a polypropylene filter having a pore size of 1.0 μm to remove foreign matters such as dust therefrom, and then stored. Thereby, 774.7 g of the SBR latex was obtained. Its halide ion content was measured by ion chromatography, and the chloride ion concentration was 3 ppm. A concentration of the chelating agent was measured by high-performance liquid chromatography and found to be 145 ppm.

The aforementioned latex had the mean particle diameter of 90 nm, Tg of 17° C., solid matter concentration of 44% by mass, the equilibrium moisture content at 25° C., 60% RH of 0.6% by mass, ionic conductance of 4.80 mS/cm (measurement of the ionic conductance performed using a conductivity meter CM-30S manufactured by Toa Electronics Ltd. for the latex stock solution (44% by mass) at 25° C.).

2. Preparation of Coating Solutions

1) Preparation of Coating Solution A1 through A3 for Image-Forming Layer

After 1000 g of the fatty acid silver salt dispersion A prepared in the above, 135 ml of water, 36 g of the pigment-1 dispersion, 25 g of the organic polyhalogen compound-1 dispersion, 39 g of the organic polyhalogen compound-2 dispersion, 171 g of the phthalazine compound-1 solution, 1060 g of the SBR latex (Tg: 17 degrees centigrade) solution, 75 g of the reducing agent-1 dispersion, 75 g of the reducing agent-2 dispersion, 55 g of the hydrogen bond-forming compound-1 dispersion, 4.8 g of the development accelerator-1 dispersion, 5.2 g of the development accelerator-2 dispersion, 2.1 g of the color toning agent-1 dispersion, 9 ml of the mercapto compound-1 aqueous solution, and 27 ml of the mercapto compound-2 aqueous solution were sequentially added, 1N sulfuric acid was added to control the pH. Coating solutions of which pH was controlled to 8.5, 7.5 and 6.0, respectively, were named A1, A2 and A3.

Just before coating it, the resulting mixture was well mixed with 140 g of the mixed silver halide emulsion A, and the thus-prepared coating solution for image-forming layer was fed as that to a coating die.

The amount of zirconium in the coating solution was 0.30 mg per one g of silver.

2) Preparation of Coating Solutions B1 through B3, C1 through C3, D1 through D3 and E1 through E3 for Image-Forming Layer

Similarly to the preparation of the coating solutions A1 through A3 for image-forming layer, by use of the fatty acid silver salt dispersions B to E, coating solutions B1 through B3, C1 through C3, D1 through D3 and E1 through E3 for image-forming layer, respectively, having the pH of 8.5, 7.5 and 6.0 were prepared.

3) Preparation of Coating Solution for Interlayer

To 1,000 g of polyvinyl alcohol PVA-205 (trade name, manufactured by Kuraray Co., Ltd.), 163 g of the pigment-1 dispersion, 33 g of a 18.5 mass percent aqueous solution of blue dye compound-1 (trade name KAYAFECT TURQUOISE RN LIQUID 150, manufactured by Japan Kayaku Co., Ltd.), 27 ml of a 5 mass percent aqueous solution of di(2-ethylhexyl) sulfosuccinate sodium salt, and 4,200 ml of a 19 mass percent solution of methyl methacrylate/styrene/butyl acrylate/hydroxyethyl methacrylate/acrylic acid copolymer (copolymerization ratio 57/8/28/5/2 by mass) latex, 27 ml of a 5 mass percent aqueous solution of AEROSOL OT (trade name, manufactured by American Cyanamid Co., Ltd.), 135 ml of a 20 mass percent aqueous solution of diammonium phthalate and water were added to make 10,000 g in total. NaOH was added thereto to control the pH to 7.5 and thereby a coating solution for interlayer was prepared. This was fed into a coating die so as to be a flow rate of 8.9 ml/m².

The viscosity of the coating solution was measured with a B-type viscometer (with No. 1 rotor and at 60 rpm) and found to be 58 [mPa·s] at 40 degrees centigrade.

4) Preparation of Coating Solution for First Surface-Protective Layer

To 840 ml of water, 100 g of inert gelatin and 10 mg of benzoisothiazolinone were dissolved, followed by adding and mixing 180 g of a 19 mass percent solution of methyl methacrylate/styrene/butyl acrylate/hydroxyethyl methacrylate/acrylic acid copolymer (copolymerization ratio 57/8/28/5/2 by mass) latex, 46 ml of a 15 mass percent methanol solution of phthalic acid, and 5.4 ml of a 5 mass percent aqueous solution of di(2-ethylhexyl) sulfosuccinate sodium salt. Just before coating it, the mixture was mixed with 40 ml of 4 mass percent chromium alum by use of a static mixer, and this was fed into a coating die so that a flow rate might be 26.1 ml/m².

The viscosity of the coating solution was measured with a B-type viscometer (with No. 1 rotor and at 60 rpm) and found to be 20 [mPa·s] at 40 degrees centigrade.

5) Preparation of Coating Solution for Second Surface-Protective Layer

To 800 ml of water, 100 g of inert gelatin and 10 mg of benzoisothiazolinone were dissolved, followed by mixing thereto 40 g of 10 mass percent emulsion of liquid paraffin, 40 g of 10 mass percent emulsion of dipentaerythrityl hexaisostearate, 180 g of a 19.0 mass percent solution of methyl methacrylate/styrene/butyl acrylate/hydroxyethyl methacrylate/acrylic acid copolymer (copolymerization ratio 57/8/28/5/2 by mass) latex, 40 ml of a 15 mass percent methanol solution of phthalic acid, 5.5 ml of a 1 mass percent aqueous solution of fluorinated surfactant (F-1), 5.5 ml of a 1 mass percent aqueous solution of fluorinated surfactant (F-2), 28 ml of a 5 mass percent aqueous solution of di(2-ethylhexyl) sulfosuccinate sodium salt, 4 g of polymethyl methacrylate particulates (average particle diameter, 0.7 μm; distribution of volume-weighted average, 30 percent), and 21 g of polymethyl methacrylate particulates (average particle diameter, 3.6 μm; distribution of volume-weighted average, 60 percent), and thereby a coating solution for surface-protective layer was prepared. This was fed into a coating die so that the flow rate thereof might be 8.3 ml/m².

The viscosity of the coating solution was measured with a B-type viscometer (with No. 1 rotor and at 60 rpm) and found to be 19 [mPa·s] at 40 degrees centigrade.

3. Preparation of Photothermographic Materials-1 through 15

Onto a surface opposite to a back surface, on a undercoat surface, an image-forming layer, an interlayer, a first surface-protective layer and a second surface-protective layer were simultaneously coated in this order according to a slide bead coating method to prepare a sample of a photothermographic material. At this time, a temperature was controlled so as to be 31 degrees centigrade for both the coating solutions for image-forming layer and for interlayer, 36 degrees centigrade for the coating solution for first surface-protective layer and 37 degrees centigrade for the coating solution for second surface-protective layer.

The coating amounts (g/m²) of the respective compounds of the image-forming layer were as follows.

An amount of coated silver was 1.4 g/m².

At this time, coating amounts (g/m²) of the respective compounds in the image-forming layer were as follows.

Fatty acid silver 5.27

Pigment (C.I. Pigment Blue 60) 0.036

Polyhalogen compound-1 0.14

Polyhalogen compound-2 0.28

Phthalazine compound-1 0.18

SBR latex 9.43

Reducing agent-1 0.38

Reducing agent-2 0.38

Hydrogen bond-forming compound-1 0.28

Development accelerator-1 0.019

Development accelerator-2 0.016

Color toning agent-1 0.006

Mercapto compound-1 0.002

Mercapto compound-2 0.012

Silver halide (as Ag) 0.13

Chemical structures of the compounds used in Examples of the invention are shown below. 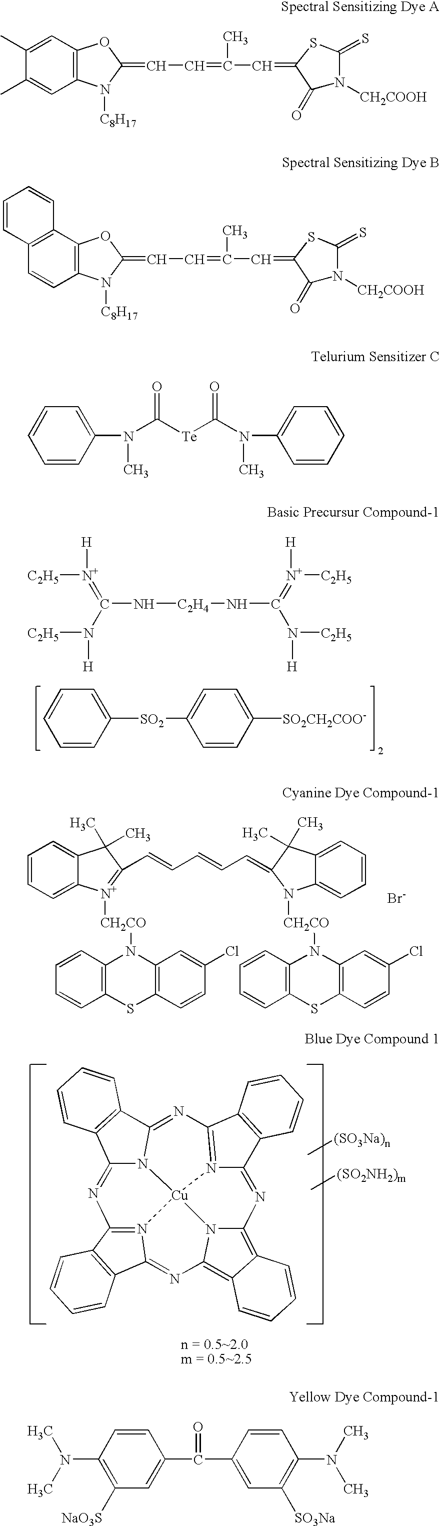 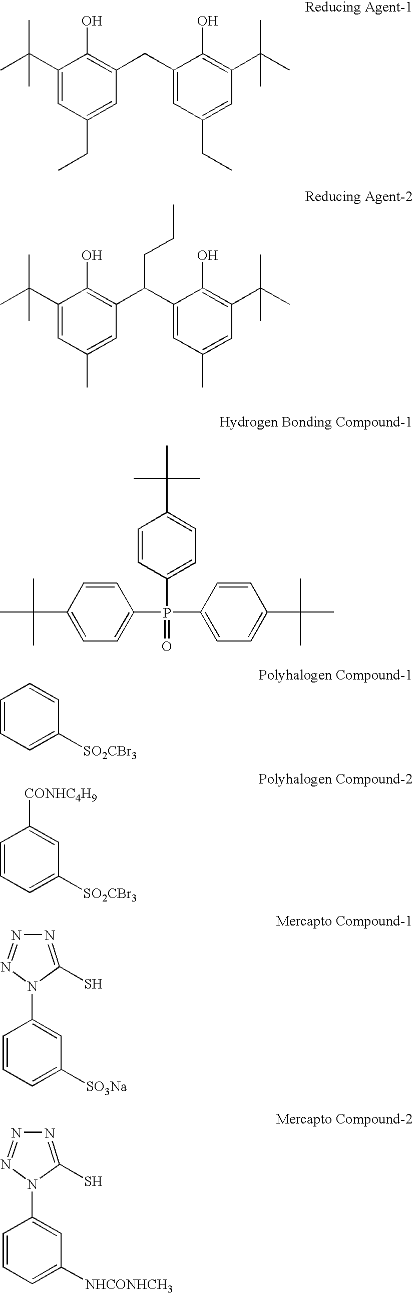 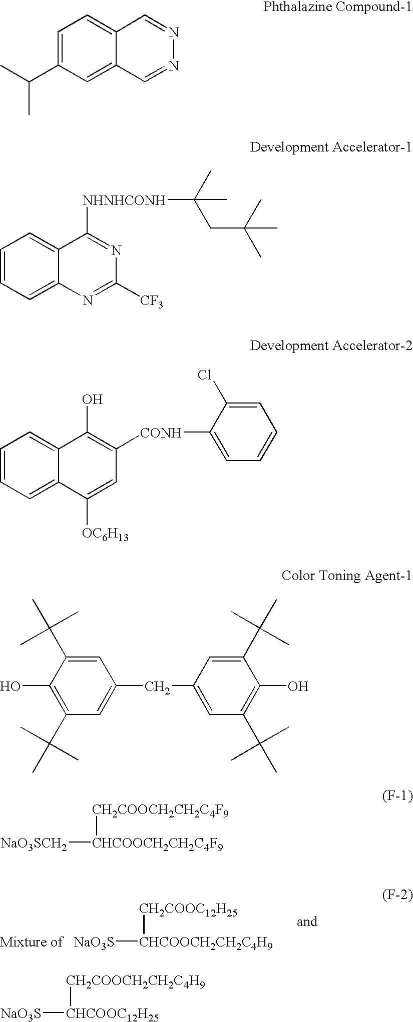
4. Evaluation of Photographic Properties
1) Preparation

The resulting sample was cut into a half-cut size (43 cm in length×35 cm in width), and was wrapped with the following packaging material under an environment of 25° C. and 50% RH, and stored for 2 weeks at an ambient temperature.

<Wrapping Material>

PET 10 μm/PE 12 μm/aluminum foil 9 μm/Ny 15 μm/polyethylene having a thickness of 50 μm and including 3 mass percent carbon;

oxygen permeability: 0.02 ml/atm·m²·25 degree centigrade·day; and

moisture permeability: 0.10 g/atm·m²·25 degree centigrade·day

2) Exposure/Development of Photosensitive Material

The respective samples were exposed by use of Fuji Medical Dry Laser Imager DRYPIX 7000 (equipped with a 660 nm semiconductor laser capable of producing a maximum output of 50 mW (IIIB)), followed by thermally developed (for a sum total of 14 sec with three panel heaters set at 107 degrees centigrade-121 degrees centigrade-121 degrees centigrade).

3) Evaluation Items

Evaluation method of state of coated surface: an actual radiograph of a lung field was exposed and thereby a thermally developed sample thereof was prepared on one hand, and on the other hand an entire surface was uniformly exposed so that the density might be 1.2 followed by thermally developing, and thereby a thermally developed sample was prepared. The obtained samples were observed by use of a viewer set at 10,000 Lux, followed by visually evaluating the state of coated surface.
◯: Excellent
Δ: At a half solid exposure, deterioration of the state of coated surface was observed; however, the deterioration was not observed in the lung field.
X: Deterioration of the state of the coated surface was observed of both the half solid exposure and the lung field.

Method of evaluating the haze: Of samples thermally developed, without exposing, by use of the Laser Imager DRYPIX 7000, by use of a NDH-2000 haze-meter manufactured by Nippon Denshoku Industries Co., Ltd., the haze was measured.

4) Results of Evaluation

Results are shown in Table 2.

From the results shown in Table 2, the photothermographic materials manufactured according to a manufacturing method of the invention are found to be excellent in the state of coated surface. Because the state of the coated surfaces was excellent, the haze could be suppressed low.

TABLE 2

| | Image Forming | Coating | State of | | |
|---|---|---|---|---|---|
| | Layer Coating | Solution | Coated | | |
| Sample No. | Solution No. | pH | Surface | Haze | Reference |
| 1 | A1 | 8.5 | Δ | 20 | Comparative |
| | | | | | Example |
| 2 | A2 | 7.5 | x | 22 | Comparative |
| | | | | | Example |
| 3 | A3 | 6 | x | 24 | Comparative |
| | | | | | Example |
| 4 | B1 | 8.5 | Δ | 21 | Comparative |
| | | | | | Example |
| 5 | B2 | 7.5 | ∘ | 19 | Example |
| 6 | B3 | 6 | ∘ | 19 | Example |
| 7 | C1 | 8.5 | Δ | 20 | Comparative |
| | | | | | Example |
| 8 | C2 | 7.5 | ∘ | 18 | Example |
| 9 | C3 | 6 | ∘ | 19 | Example |
| 10 | D1 | 8.5 | Δ | 21 | Comparative |
| | | | | | Example |
| 11 | D2 | 7.5 | ∘ | 19 | Example |
| 12 | D3 | 6 | ∘ | 19 | Example |
| 13 | E1 | 8.5 | Δ | 22 | Comparative |
| | | | | | Example |
| 14 | E2 | 7.5 | ∘ | 19 | Example |
| 15 | E3 | 6 | ∘ | 20 | Example |

### Example 2

1) Preparation of Organic Silver Salt Dispersion

Similarly to the fatty acid silver salt dispersion A according to example 1, with the exception that the dispersing agent PVA217 was altered as shown in Table 3, and an amount that is used was also altered as shown in Table 3, fatty acid silver salt dispersions W1 through W6 were prepared. Since the dispersion proceeds differently depending on the dispersing agents, the dispersion time was controlled so that all the dispersions might have the same degree of dispersion as that of the fatty acid silver salt dispersion A.

TABLE 3

| Dispersion | | |
|---|---|---|
| No. | Dispersing Agent Name | Amount |
| W1 | 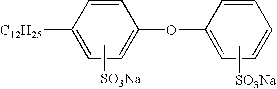 | 3.2 kg |
| W2 | Sodium Diisobutylnaphthalenesulfonate | 4.0 kg |
| W3 | C₁₃H₂₇—COONa | 22 kg |
| W4 | 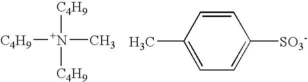 | 15 kg |
| W5 | 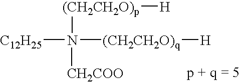 | 30 kg |
| W6 | Polyethylene Glycol (Molecular Weight: 1000) | 20 kg |

2) Preparation of Coated Sample

Except that the fatty acid silver salt dispersions W1 through W6 were used as the organic silver salt, similarly to example 1, photothermographic materials 21 through 30 were prepared as shown in Table 4.

TABLE 4

| | Organic Silver | Coating | Status of | | |
|---|---|---|---|---|---|
| | Salt Dispersion | Solution | Coating | | |
| Sample No. | No. | pH | Surface | Haze | Reference |
| 21 | W1 | 8.5 | x | 24 | Comparative |
| | | | | | Example |
| 22 | W1 | 7.5 | ∘ | 18 | Example |
| 23 | W1 | 6 | ∘ | 20 | Example |
| 24 | W2 | 8.5 | x | 23 | Comparative |
| | | | | | Example |
| 25 | W2 | 7.5 | ∘ | 19 | Example |
| 26 | W2 | 6 | ∘ | 20 | Example |
| 27 | W3 | 7.5 | ∘ | 19 | Example |
| 28 | W4 | 7.5 | ∘ | 20 | Example |
| 29 | W5 | 7.5 | ∘ | 20 | Example |
| 30 | W6 | 7.5 | ∘ | 20 | Example |

3) Evaluation of Performance

The evaluation was carried out similarly to example 1. Results of evaluation are shown in Table 4.

As a result thereof, the photothermographic materials manufactured according to a manufacturing method of the invention are found to be excellent in the state of coated surface. Because the state of the coated surfaces was excellent, the haze could be suppressed low.

### Example 3

1) Preparation of Organic Silver Salt Dispersion

Similarly to the fatty acid silver salt dispersion A according to example 1, with the exception that the dispersing agent PVA217 was altered to acid-processed gelatin AP200 manufactured by Nippi Gelatin Industries, Ltd. or alkali-processed gelatin E1 manufactured by Nippi Gelatin Industries, Ltd., fatty acid silver salt dispersions X1 and X2, respectively, were prepared. An amount of the dispersing agent used was 22 kg.

Since the dispersion proceeded differently depending on the dispersing agents, the dispersion time was controlled so that all the dispersions might have the same degree of dispersion as that of the fatty acid silver salt dispersion A.

2) Preparation of Coated Sample

Except that the fatty acid silver salt dispersions X1 and X2 were used as the organic silver salt, similarly to example 1, photothermographic materials 41 through 46 were prepared.

3) Evaluation of Performance

The evaluation was carried out similarly to example 1. Results of evaluation are shown in Table 5.

As a result thereof, the photothermographic materials manufactured according to a manufacturing method of the invention are found to be excellent in the state of coated surface. Because the state of the coated surfaces was excellent, the haze could be suppressed low.

TABLE 5

| | Organic Silver | Coating | Status of | | |
|---|---|---|---|---|---|
| | Salt Dispersion | Solution | Coating | | |
| Sample No. | No. | pH | Surface | Haze | Reference |
| 41 | X1 | 8.5 | x | 22 | Comparative |
| | | | | | Example |
| 42 | X1 | 7.5 | ∘ | 18 | Example |
| 43 | X1 | 6 | ∘ | 19 | Example |
| 44 | X2 | 8.5 | x | 22 | Comparative |
| | | | | | Example |
| 45 | X2 | 7.5 | ∘ | 20 | Example |
| 46 | X2 | 6 | ∘ | 20 | Example |

1. A method of manufacturing a photothermographic material that has on at least one surface of a support an image-forming layer that includes at least a photosensitive silver halide, a non-photosensitive organic silver salt, a reducing agent and a binder, wherein:
the non-photosensitive organic silver salt is dispersed with at least one dispersing agent selected from polyvinyl alcohol having an average polymerization degree of 1,500 or less, a surfactant, and gelatin; and
the pH of a coating solution of the image-forming layer is 4 or more and 8.2 or less.

2. The method of manufacturing a photothermographic material according to claim 1, wherein the surfactant is a nonionic surfactant.

3. The method of manufacturing a photothermographic material according to claim 1, wherein the surfactant is an anionic surfactant.

4. The method of manufacturing a photothermographic material according to claim 1, wherein the surfactant is a cationic surfactant.

5. The method of manufacturing a photothermographic material according to claim 1, wherein the surfactant is an amphoteric surfactant.

6. The method of manufacturing a photothermographic material according to claim 1, wherein the pH of the coating solution of the image forming layer is 4 or more and 8 or less.

7. The method of manufacturing a photothermographic material according to claim 1, wherein the gelatin is acid-processed gelatin.

8. The method of manufacturing a photothermographic material according to claim 1, wherein an aqueous solvent is used to coat the image forming layer.

9. The method of manufacturing a photothermographic material according to claim 1, wherein 50 mass percent or more of the binder is polymer latex.

10. The method of manufacturing a photothermographic material according to claim 9, wherein the polymer latex includes a monomer component having an acid group in an amount of 1 mass percent or more and 20 mass percent or less.

11. The method of manufacturing a photothermographic material according to claim 9, wherein the glass transition point (Tg) of the polymer latex is −10 degrees centigrade or more and 70 degrees centigrade or less.

12. The method of manufacturing a photothermographic material according to claim 1, wherein the pH of the coating solution is 6 or more and 8 or less.

13. The method of manufacturing a photothermographic material according to claim 1, wherein an amount of coated silver is 0.5 g/m² or more and 1.6 g/m² or less.

14. The method of manufacturing a photothermographic material according to claim 1, wherein the non-photosensitive organic silver salt is a needle crystal.

15. The method of manufacturing a photothermographic material according to claim 14, wherein, when a needle-shaped grain of the non-photosensitive organic silver salt is approximated to a rectangle and side lengths thereof are defined as a, b and c from a shortest side to a longest side, a ratio of c/b is 10 or more and 500 or less.

16. The method of manufacturing a photothermographic material according to claim 1, wherein a behenate content of the non-photosensitive organic silver salt is 90 mol percent or more and 99 mol percent or less.

17. The method of manufacturing a photothermographic material according to claim 1, wherein the saponification degree of the polyvinyl alcohol is in the range of 80 to 92 percent.

18. A photothermographic material manufactured according to a manufacturing method of a photothermographic material of claim 1, that has on at least one surface of a support an image-forming layer that includes at least a photosensitive silver halide, a non-photosensitive organic silver salt, a reducing agent and a binder, wherein:
the non-photosensitive organic silver salt is dispersed with at least one dispersing agent selected from polyvinyl alcohol having an average polymerization degree of 1,500 or less, a surfactant, and gelatin, and
the pH of a coating solution of the image-forming layer is 4 or more and 8.2 or less.

19. The photothermographic material according to claim 18, further comprising a development accelerator.

20. The photothermographic material according to claim 18, further comprising a hydrogen-bonding compound.
